(19) United States
(12) Patent Application Publication
(10) Pub. No.: US 2025/0307926 A1
(43) Pub. Date: Oct. 2, 2025

(54) CUSTOM PRIVATE LEDGER FOR MULTIPLE ENTITIES, MULTIPLE COIN TYPES

(71) Applicant: Twism, Inc., Santa Barbara, CA (US)

(72) Inventors: Raja Jindal, Santa Barbara, CA (US); Gustavo Piltcher, Santa Barbara, CA (US); Paulo Faulstich, Santa Barbara, CA (US)

(21) Appl. No.: 19/094,432

(22) Filed: Mar. 28, 2025

Related U.S. Application Data
(60) Provisional application No. 63/571,342, filed on Mar. 28, 2024.

(51) Int. Cl. G06Q 40/04; G06Q 20/38; H04L 9/32

(52) U.S. Cl. CPC G06Q 40/04; G06Q 20/3825; H04L 9/3247

(57) ABSTRACT

A method and system for a single ledger architecture that supports multiple entities and multiple coin types is disclosed. In some embodiments, the method includes determining a plurality of addresses for a first user, each of the plurality of addresses associated with an amount of coins of a coin type and a coin subtype. The method also includes performing a transaction associated with the coins of a given coin type and one or more coin subtypes using one or more addresses of the plurality of addresses. The method further includes recording the transaction in a ledger by creating a new state for the transaction and obsoleting data originated the new state; and creating a chain of transactions based on recording the transaction.

### CROSS REFERENCE TO RELATED APPLICATION

This application claims the benefit of and priority to U.S. Provisional Patent Application No. 63/571,342, filed Mar. 28, 2024, the entire content of which is incorporated by reference herein.

### TECHNICAL FIELD

This disclosure relates to a single ledger architecture that provides solutions and features for multiple entities and multiple coin types.

### BACKGROUND

When a massive amount of digital data and computer and network resources are managed and operated by independent and diverse entities from different regions, data operations (e.g., transferring, sharing, storing) become extremely complex because of data fragmentation, traceability challenges, inconsistency, and security risks, audit problems, etc. An integration framework that can link together diverse entities and secure complex data operations (e.g., by facilitating data aggregation, dissemination, tracking, recording, etc.) is desirable.

### SUMMARY

To address the aforementioned shortcomings, a single ledger architecture that supports multiple entities and multiple coin types is disclosed. In some embodiments, the method includes determining a plurality of addresses for a first user, each of the plurality of addresses associated with an amount of coins of a coin type and a coin subtype; performing a transaction associated with the coins of a given coin type and one or more coin subtypes using one or more addresses of the plurality of addresses; recording the transaction in a ledger by creating a new state for the transaction and obsoleting data originated the new state; and creating a chain of transactions based on recording the transaction.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1A illustrates an exemplary diagram of a cryptocurrency-featured network environment implemented without a ledger.

FIG. 1B illustrates an exemplary diagram of a cryptocurrency-featured network environment implemented using a ledger.

FIG. 1C illustrates an exemplary diagram of various types of ledger solution candidates.

FIG. 1D illustrates an exemplary diagram of a custom private ledger as proposed in the present disclosure, according to some embodiments.

FIGS. 2A and 2B illustrate components of the custom-designed architecture shown in FIG. 1D, according to some embodiments.

FIG. 3A illustrates a simplified view of an exemplary transaction using a transaction model, according to some embodiments.

FIG. 3B illustrates a detailed view of an exemplary transaction using a transaction model, according to some embodiments.

FIG. 4A illustrates a diagram of a fingerprint example, according to some embodiments.

FIG. 4B illustrates exemplary fingerprint pseudo-code, according to some embodiments.

FIG. 4C illustrates an exemplary diagram for coin freezing, according to some embodiments.

FIG. 4D illustrates a block diagram of an example freeze chain on fraud, according to some embodiments.

FIG. 4E illustrates a block diagram of blacklisting examples, according to some embodiments.

FIG. 4F illustrates a block diagram of an example period of enforcement, according to some embodiments.

FIG. 5A illustrates exemplary types and subtypes associated with an address in the present ledger system, according to some embodiments.

FIG. 5B illustrates an exemplary amount representation used in the present ledger system, according to some embodiments.

FIG. 5C illustrates exemplary issuing data used in the present ledger system, according to some embodiments.

FIG. 5D illustrates exemplary backing data used in the present ledger system, according to some embodiments.

FIG. 5E illustrates an exemplary diagram of lifecycle control and state flows in the present ledger system, according to some embodiments.

FIG. 6 illustrates an exemplary diagram of an overview of ledger architecture, according to some embodiments.

FIGS. 7A-7C illustrate exemplary operational rules and actions established for specific operations, according to some embodiments.

FIGS. 8A-8D illustrate exemplary attributes and models of a coin structural sample, according to some embodiments.

FIGS. 9A and 9B illustrate an exemplary use case of a minting process, according to some embodiments.

FIGS. 10A-10G illustrate an exemplary use case of transfer operation, according to some embodiments.

FIGS. 11A-11G illustrate an exemplary use case of transfer and transform operations, according to some embodiments.

FIGS. 12A-12F illustrate an exemplary use case of burn operation, according to some embodiments.

FIGS. 13A-13F illustrate an exemplary use case of freeze operation, according to some embodiments.

FIGS. 14A-14F illustrate an exemplary use case of unfreeze operation, according to some embodiments.

FIGS. 15A-15E illustrate an exemplary diagram of some other operations, according to some embodiments.

FIGS. 16A-16P illustrate exemplary diagrams associated with ledger integration, according to some embodiments.

FIG. 17 illustrates a block diagram of an example computer system that may be used in implementing the technology described herein, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Platform Overview

### Existing Platforms

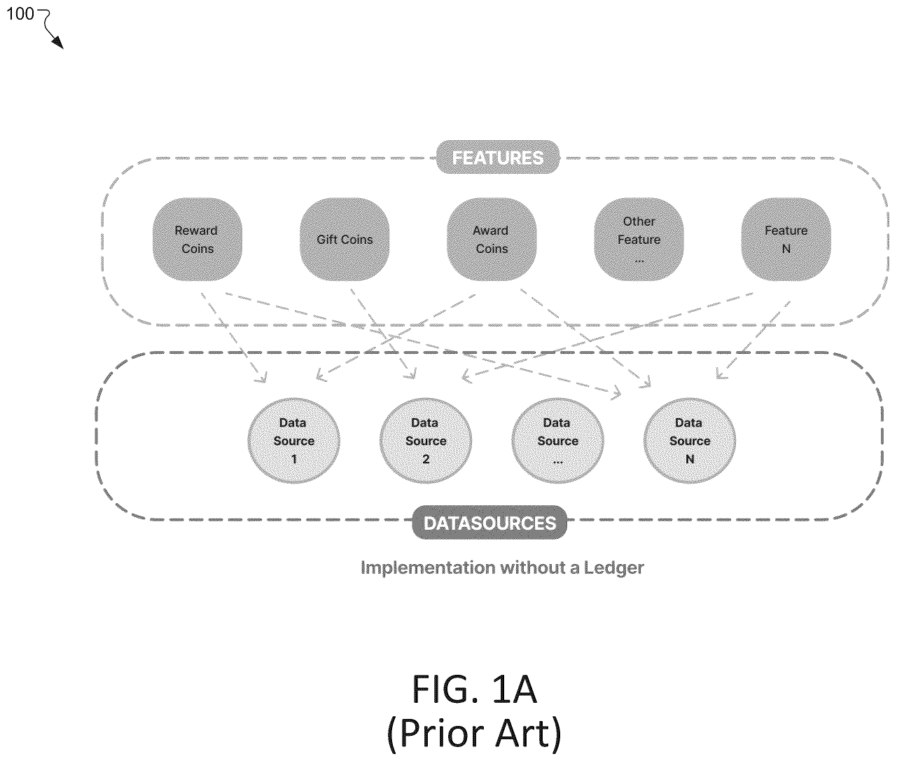

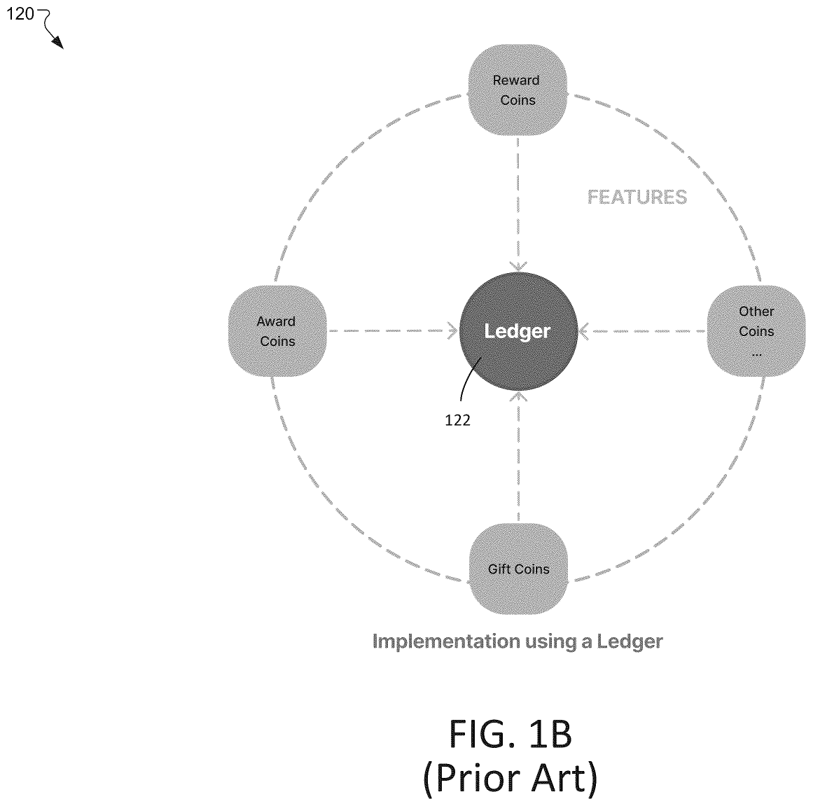

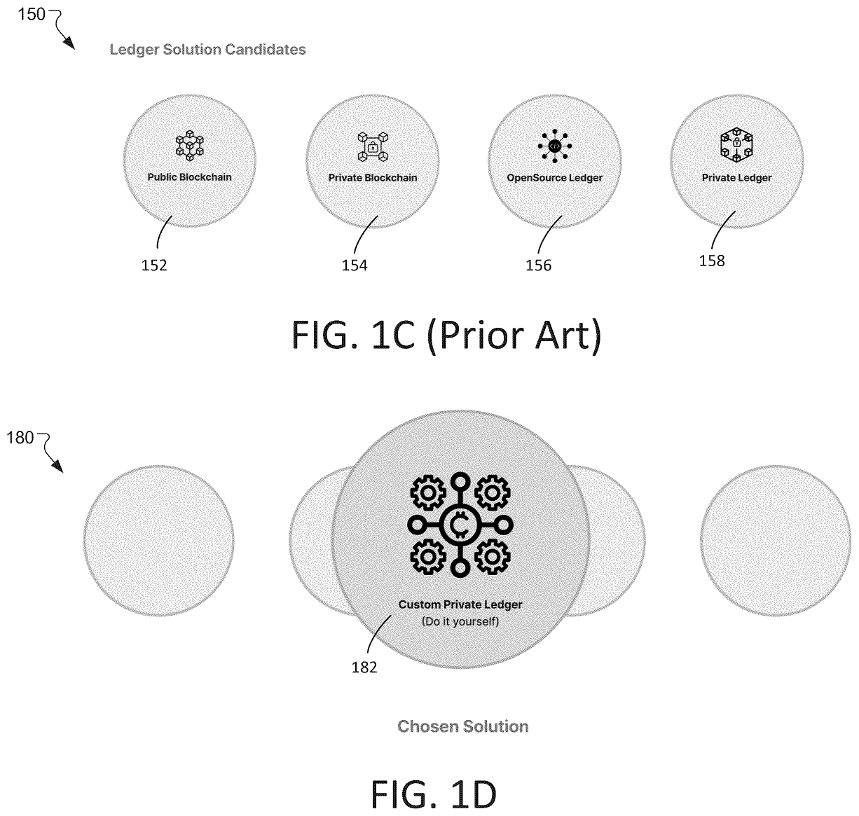

A ledger is an account book (e.g., a database) for recording transactions. A current technological trend is to use a distributed database or ledger (e.g., blockchain) to enable the secure sharing of information, for example, to maintain a secure and decentralized record of transactions in cryptocurrency systems. FIGS. 1A and 1B illustrate exemplary diagrams of a cryptocurrency-featured network environment, implemented either without a ledger or using a ledger, respectively. A cryptocurrency or cryptographically encrypted currency (e.g., Bitcoin, Ethereum, etc.,) is a type of digital or virtual money used to secure transactions, control the creation of new units, and verify asset transfers.

While the distributed database or ledger plays an important role in cryptocurrency systems and is described in the context of this disclosure, the proposed ledger herein is not limited to the cryptocurrency uses. For example, the proposed database may be applied in a peer-to-peer distributed file system that enables decentralized data storage and retrieval (e.g., web hosting, content sharing, etc.). In another example, the database or ledger described herein may provide immutable network traffic logs for cybersecurity purposes, preventing tampering with data and enabling real-time forensic analysis. Other examples include, but are not limited to, using the proposed distributed ledger to secure login authentication and verify identities without relying on centralized authorities (e.g., passwordless authentication systems), or recording and managing network configurations (e.g., in software-defined networking) to ensure consistency and prevent unauthorized changes, etc.

The example diagram in FIG. 1A shows a platform 100 implemented without a ledger, which faces many challenges in data fragmentation, historical data gap, traceability, inconsistency and security risk, coin type complexity, ambiguity in monetary value, audit complexity, etc. Without a ledger, platform 100 features operating independently, for example, reward coins and gift coins may be managed and operated by two standalone departments. This would cause data fragmentation, that is, data is scattered across various data sources. The lack of centralized tracking of platform 100 may also cause gaps in historical data, rendering audits and analysis difficult. As to traceability challenges, platform 100 is incapable of tracing operations to their origins, which hinders transparency and accountability. Further, the independent data handling in platform 100 may raise the risk of data inconsistencies, causing conflict records and security breaches.

The cryptocurrency may be referred to as coins (e.g., Bitcoin, Litecoin, Ethereum) in the context of the distributed database or ledger. When a ledger is not used in FIG. 1A, platform 100 would be absent clear coin types and control over the coins. Such coin-type complexity may make coin-related operations complicated. In addition, without a ledger, platform 100 is uncertain about whether coins were created with money or other assets, and thus is ambiguous about the monetary value of the coins and cannot guarantee continued clarity on the backing of coins. For example, this ambiguity would extend to identifying the origination of the coins (e.g., generated using money or alternate assets). The setup in platform 100 also poses challenges for conducting comprehensive and reliable audits.

As compared to FIG. 1A, FIG. 1B illustrates platform 120 implemented using a ledger, which contains some improved features and requirements in a centralized source of truth, historical data integrity, traceability and accountability, data consistency and security risk, coin types management, monetary value clarity, and simplified auditing. As depicted in FIG. 1B, a single, unified source of truth (e.g., ledger 122) is created to consolidate and track all operations and data in platform 120. Platform 120 ensures historical data integrity with complete historical data availability for comprehensive analysis, reporting, and auditing. Platform 120 also enables seamless tracking of every operation to its origin, enhancing transparency and accountability. In platform 120, data inconsistency is minimized through centralized data management and validation mechanisms, thereby reducing security risks.

For coin types management, platform 120 can introduce clear coin types with controlled operations and self-contained data, streamlining coin-related processes. Using ledger 122, platform 120 also establishes a definitive record of whether coins were initially issued using money or alternative assets, and maintains a transparent, ongoing verification of their backing, thereby ensuring monetary value clarity. Moreover, platform 120 can simplify and facilitate audits by providing a well-structured, easily accessible ledger (e.g., ledger 122) for accurate and efficient assessment.

Based on the above comparison in FIGS. 1A and 1B, the present disclosure describes a ledger-based platform. A ledger may have different types. In some embodiments, a ledger can be a public blockchain 152, a private blockchain 154, an open-source ledger 156, or a private ledger 158 as illustrated in exemplary diagram 150 of FIG. 1C.

A public blockchain is accessible to all users while a private blockchain is only accessible to a limited number of users. A public blockchain is a fully decentralized, secure, and immutable ledger system, where transactions are anonymous yet transparent to every user. In contrast, a private blockchain may offer faster performance and enhanced privacy by similifying data handling, though it lacks full transparency.

An open-source ledger is a type of ledger where source code is publicly available, allowing users to share, modify, or inspect it. Most ledgers in the current crypto market are built to be open source. However, implementation challenges arise with open-source ledgers, as the public nature of transactions may conflict with users' need for transactions and control over their cryptocurrencies. In such scenarios, private ledger implementations may better meet these requirements.

In the present disclosure, various specific features and implementation considerations are evaluated when choosing and designing an optimal ledger option.

When evaluating the implementation of public blockchain option 152, the present platform design considers the following factors:
Preference for Ethereum virtual machine (EVM) compatibility
   The present platform design explores public blockchain options aligned with the preference for EVM compatibility. For example, two prominent second-layer Ethereum blockchain solutions, Polkadot and Polygon, are researched.
User Experience Priority
   The present platform design prioritizes user experience. For example, transaction processing speed is prioritized, and public blockchain solutions that take more than two or three seconds to process transactions are deemed less suitable.
Public Network Constraints
   Even with fast transaction speeds, certain implementation challenges in public blockchain networks may impact the user experience. Potential network congestion, over which the platform has limited control, may cause delay and performance issues.
Security Concerns
   The implementation of public blockchain option 152 may also be exposed to security risks. Since contracts are accessible to any users on a public blockchain, user-related issues could potentially harm the platform's performance.

Since the implementation of public blockchain option 152 poses some risks (e.g., transaction confirmation delays and security vulnerabilities), the present platform design moves to check a private solution by adopting a learning phase/period to validate all the integrations and addressing user experience concerns and security issues with contracts.

When evaluating the implementation of private blockchain option 154, the present platform design considers the following factors:
Transaction Speed Benefits
   Private blockchain 154 offers the potential for significantly reduced transaction times. Example private blockchain options include Quorum, Hyperledger, and Corda.
Language Challenges
   Implementing private blockchain 154 may present challenges due to team familiarity with programming language such as Solidity, Vyper, and Katlin. Addressing these challenges may require specialized personnel.
Configuration Challenges
   Private blockchain 154 setting-up requires configuration of on-premise instances and complex server and validation node, which again needs dedicated personnel.
Scalability Concerns
   Private blockchain 154 aims to be inherently scalable; however, achieving optimal scalability can be highly complex, requiring the proper system setup and configuration mentioned above.
Regulatory Uncertainties
   Implementing private blockchain solution 154 may also encounter regulatory challenges in an evolving landscape. For example, terms such as coins and blockchain may raise red flags when private blockchain 154 is adopted in a financial institution environment (e.g., banks).

Based on the above implementation factors, especially regulatory restrictions, implementing public or private related blockchain may not be optimal from the perspective of platform design.

The next option is open-source ledger option 156, where factors such as implementation fit, digital wallet features, domain-specific language (DSL) complexity, and stability are considered in platform design as shown below:
Implementation Fit
   Although open-source ledger projects primarily cater to accounting and financial flow needs, implementing open source ledgers to fully meet the present platform's requirements for digital wallet functionality (e.g., supporting multiple entities and multiple coin types) presents challenges. Some open-source ledger options (e.g., Google® Trillian) are not designed for financial applications but may be adaptable for custom implementation.
Limited Digital Wallet Features
   Open-source ledger option 156 provides limited support for creating custom digital wallets and custom assets, resulting in fewer digital wallet features. Among existing open-source ledger options, Formance® ledger offers some digital wallet features, making it a potential choice. However, implementing Formance ledger requires a significant level of adaptation, which can complicate an integration process.
Unique DSL Language
   Formance utilizes a DSL language for transaction definitions and execution, adding complexity to the implementation process. Developing a software development kit (SDK) is needed to translate service calls for seamless integration of the platform's modules and features.
Stability
   There are stability concerns with implementing Formance, as relying on an emerging solution for a core component of the present platform introduces unnecessary risk.

Consequently, implementing open-source ledger option 156 may not be an optimal choice, due to the need for tailored features and the complexity associated with integrating advanced options like Formance.

Private ledger option 158 is examined based on the following implementation considerations:
Implementation Fit
   While some private ledgers 158 support multiple types of digital assets, they typically lack native support for managing multi-entity and multi-type of digital assets within a single system. For example, existing private ledges lack the ability to manage various merchant-specific currencies, differentiated by asset types and subtypes. The absence of built-in permissions and role-based access makes it difficult for multiple entities to use the same infrastructure securely.
Features, Application Programming Interfaces (APIs), and Documentation
   The implementation of private ledgers often requires paid plans. While most private ledgers as service solutions offer customizable storage for credit and debit operations across various accounts/ledgers, the availability of robust APIs and comprehensive documentation remains inconsistent. Only a few private ledgers, such as Twisp, provide sufficient documentation to support meaningful evaluation.
Stability
   Similar to Formance, Twisp also raises stability concerns. The present platform tends to avoid implementation of a nascent solution and associated potential risks.
Specialized Ledger Solutions
   Specialized ledger solutions, such as Amazon® web service (AWS) quantum ledger database (QLDB) and Azure confidential ledger focus on providing foundational infrastructure for maintaining tamper-proof logs, similar to Google® Trillian. While these ledger solutions offer value for traceability, they do not fulfill the specific financial requirements of the present platform.

Due to the above implementation challenges, private ledger option 158 does not fully meet the specific needs of the present system, making it a sub-optimal ledger solution.

### Proposed Platforms

FIG. 1D illustrates an exemplary diagram 180 of a custom private ledger 182 as proposed in the present disclosure. As depicted, custom private ledger 182 is strategically developed based on features of both private blockchain 154 and open-source ledger 156 (e.g., minimizing risks associated with public exposure of contracts and potential vulnerabilities). Custom private ledger 182 provides at least the below advanced implementation features.
Data Structure Flexibility
   Building a new custom private ledger 182, the present platform is flexible in choosing a data structure model for representing transactions. This allows the present platform to draw inspiration from structures employed by existing blockchains, ensuring simplified resource traceability back to their origins, facilitating audit processes, and providing flexibility for future migration to a blockchain if considered appropriate.
Enhanced Control Mechanisms
   Custom private ledger 182 enables advanced control and security mechanisms. For example, customer private ledger 182 may allow certain operations (e.g., freezing coins) and bring in new operations (e.g., introducing fingerprinting for tamperproof and immutable records).
High Availability and Scalability Standards
   Custom private ledger 182 seamlessly integrates the same high availability and scalability standards utilized by other components of the present platform. This ensures consistency across the entire architecture and further streamlines operations.
Tailored Structure for Special Needs
   The custom-designed architecture (e.g., custom private ledger 182) caters to the unique representation needs of coins within the present platform. This structure can differentiate the cryptocurrencies by type and subtype, incorporate capabilities to indicate whether a coin is backed by an asset or generated from a different source, include proof capabilities and/or use numerical representations to identify owners and issuers of the coins, maintain privacy and security, etc. With the present structure, these operations can be easily extended and adapted.
Fortified Cloud Security
   The present platform can run custom private ledger 182 in an AWS cloud, isolated in a virtual private cloud (VPC), layered with security measures, and restricted communication with other services for better data control and platform integrity.

In contrast to existing ledger systems, the present system is able to manage various entity-specific currencies, differentiated by asset types and subtypes, with robust controls over collateral backing and issuance. The present system allows for conversions between different currencies within a single ledger. For example, a coin minted by a merchant for a first entity can later be burned to mint a new coin from that merchant for a second entity. This capability to handle multiple asset types and maintain strong controls over issuance and collateral backing is an important feature of the present system. It is noted that in this disclosure, an “entity” can refer to a merchant, a customer, or other entities across a wide range of applications utilizing the present system.

The present system offers technical advantages in various aspects. First, the application of the present system can reduce computing resource usage. As discussed above, the present system employs a flexible data model for transactions, ensuring efficient storage and traceability without excessive computational overhead. The present system also allows fine-grained control over operations, reducing unnecessary computations. By leveraging scalable cloud infrastructure (e.g., running with VPC), the present system enhances resource efficiency.

The present system can improve the processing speed. The high availability and scalability of the present system can ensure rapid transaction processing with minimal downtime. The parallel processing capabilities of the present system allow multiple operations to be processed simultaneously and thus reduce delays. The custom ledger architecture described herein avoids the overhead of traditional blockchain consensus, enabling faster validation and execution of operations.

The present system enhances data management and traceability. The unified ledger system described herein eliminates data fragmentation, ensuring consistency and efficient historical data retrieval. The structured ledger format simplifies auditing by maintaining a clear, immutable history of transactions. Advanced control mechanisms such as freezing operations and fingerprinting for tamper-proof records improve security while maintaining efficiency.

Additionally or alternatively, the present system differentiates transaction types efficiently, allowing future adaptability without major architectural overhauls. The integration with cloud security standards ensures scalability while maintaining strict security protocols. The present system enables efficient data representation by using a structured approach to manage digital assets, reducing processing load compared to traditional ledgers.

### Overall Implementation

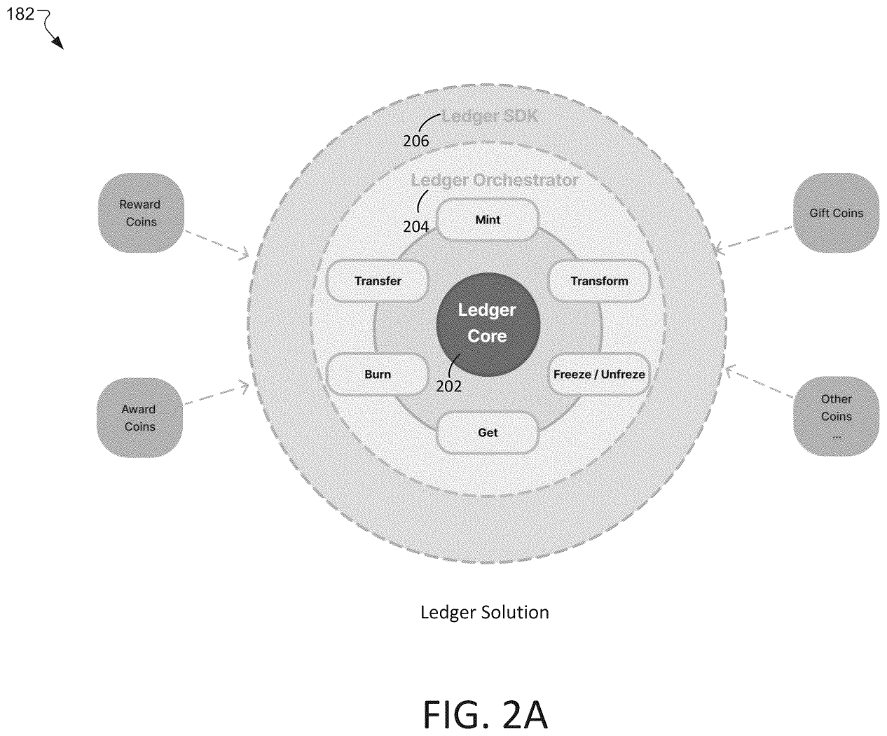

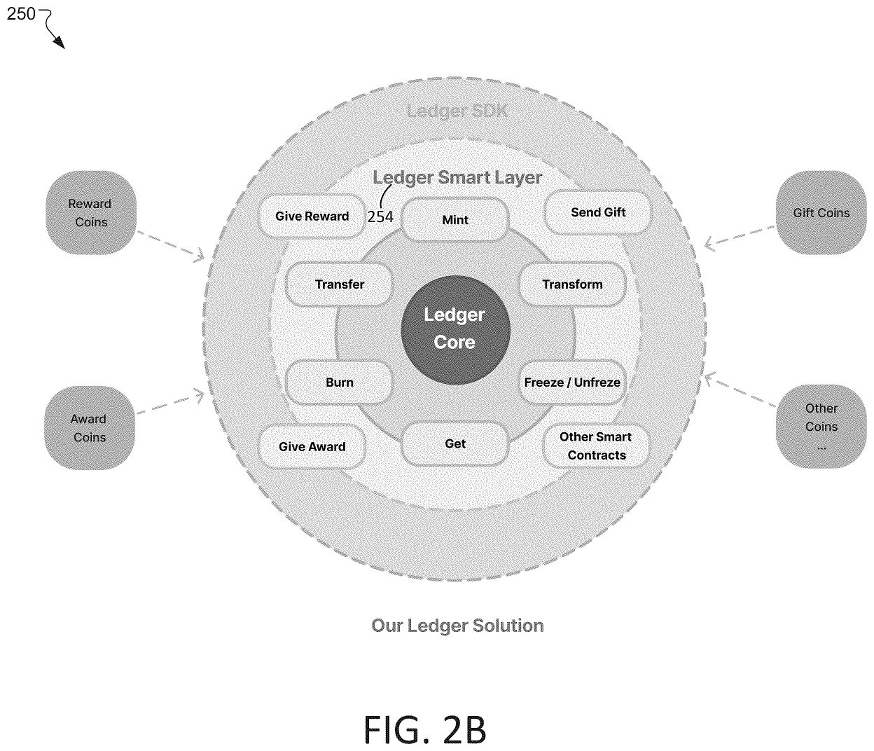

FIGS. 2A and 2B illustrate components of a custom-designed architecture (e.g., custom private ledger 182 in FIG. 1D) respectively in representations 200 and 250. In the illustrated embodiment of FIG. 2A, custom private ledger 182 may include a ledger core 202, a ledger orchestrator 204, and a ledger SDK 206.

At the core of custom private ledger 182 lies a foundational layer known as ledger core 202. This layer is meticulously shielded from external access, with even backend services denied entry. Within this secure enclave, fundamental operational rules are established. In some embodiments, these rules may encompass a spectrum of key operations, including Mint, Transfer, Transform, Freeze, Unfreeze, Burn, and Get. It is ledger core 202 in which the essence of custom private ledger's transactional capabilities takes shape.

The second layer, i.e., ledger orchestrator 204, is a bridge to operations. Ledger orchestrator 204 operates as an important communication nexus between ledger core 202 and other backend services. The strategic position of the second layer 204 facilitates smooth information exchange while remaining secluded behind a protective firewall that is isolated from the wider Internet. One of the key roles of ledger orchestrator 204 is to ensure robust communication availability. In the event of ledger core's 202 downtime, ledger orchestrator 204 efficiently manages queues, ensuring postponed transactions are executed once ledger core 202 is back online. Moreover, ledger orchestrator 204 serves as the central interaction point for various platform services, ensuring unified and consistent communication.

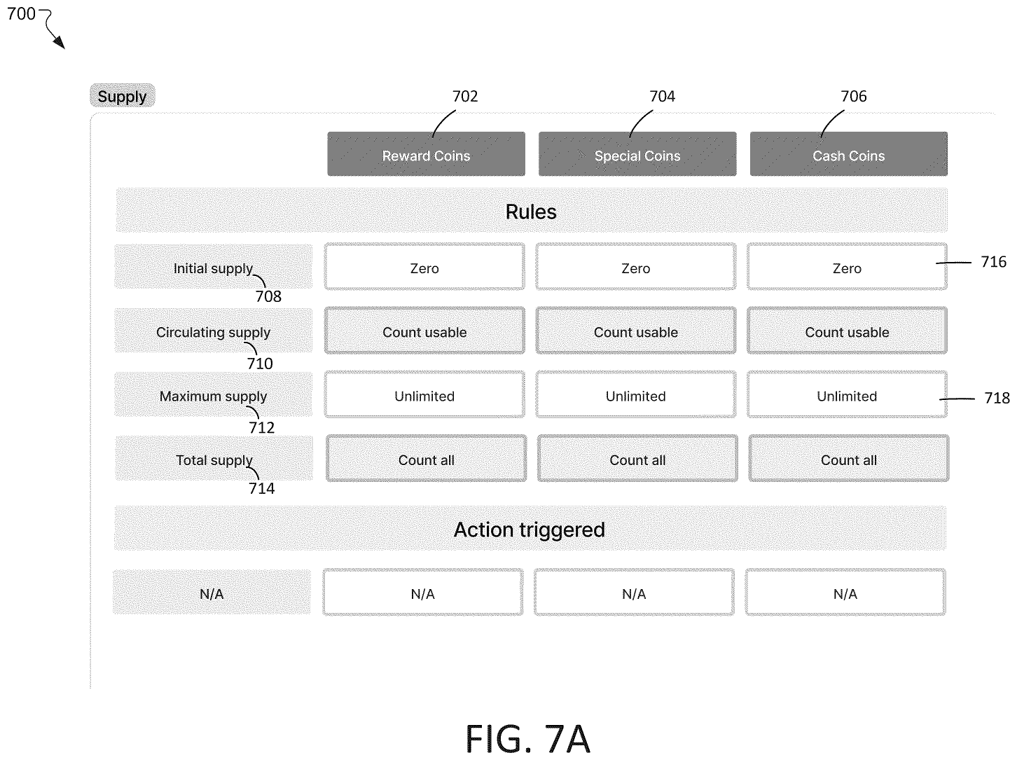

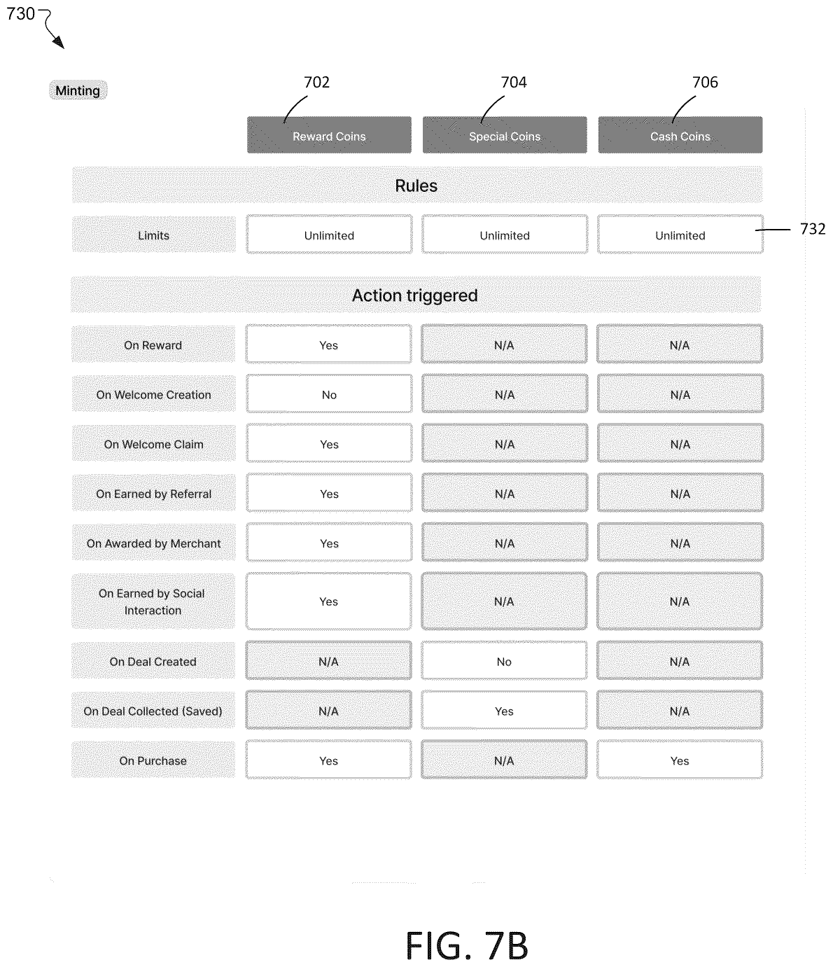

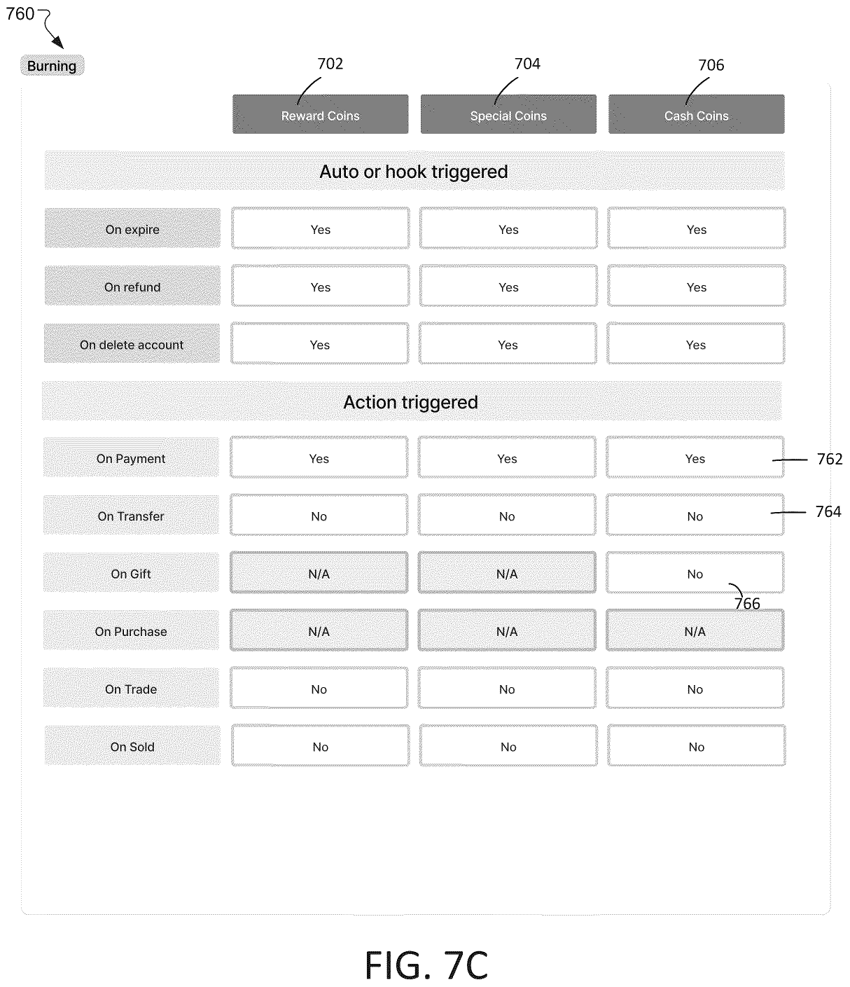

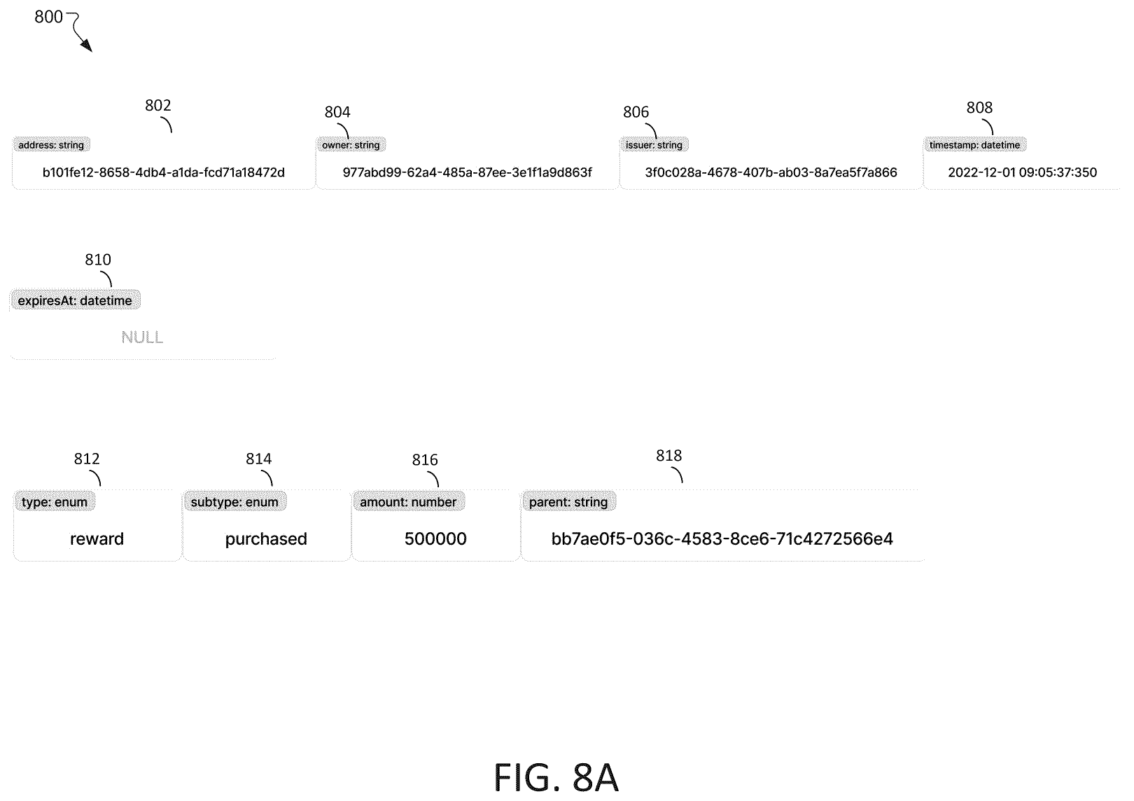

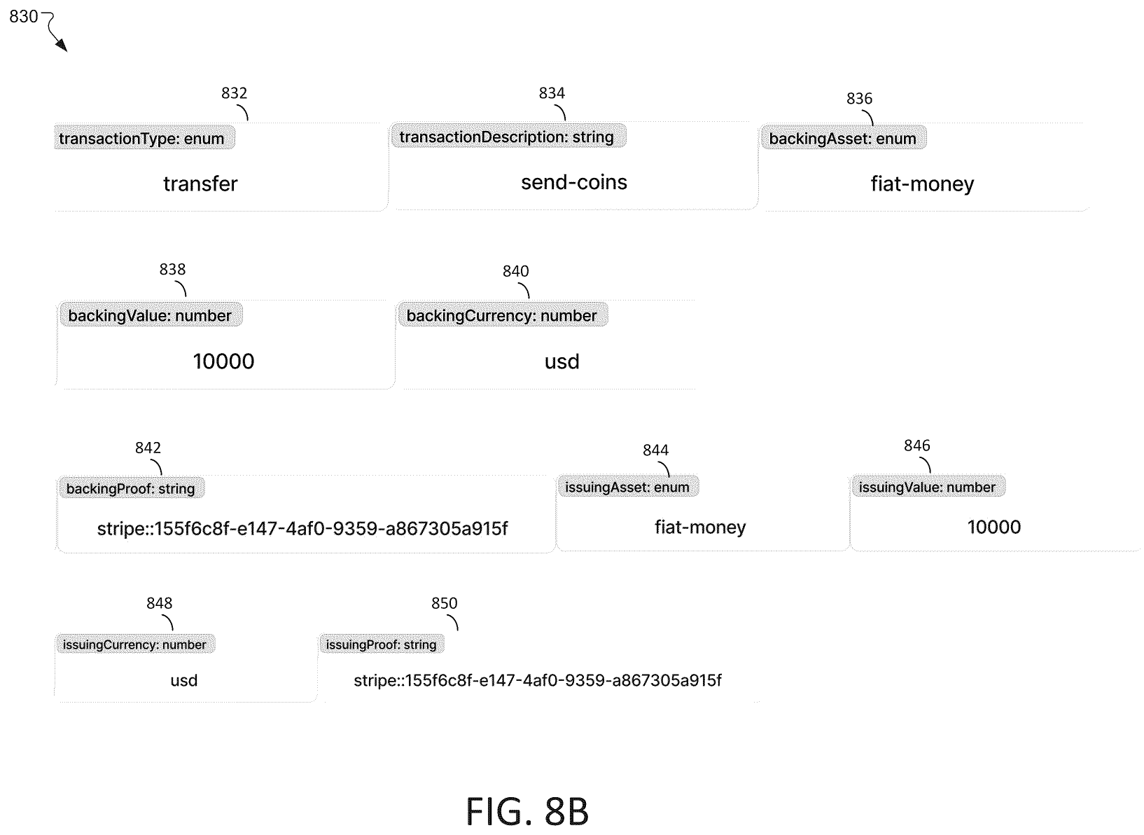

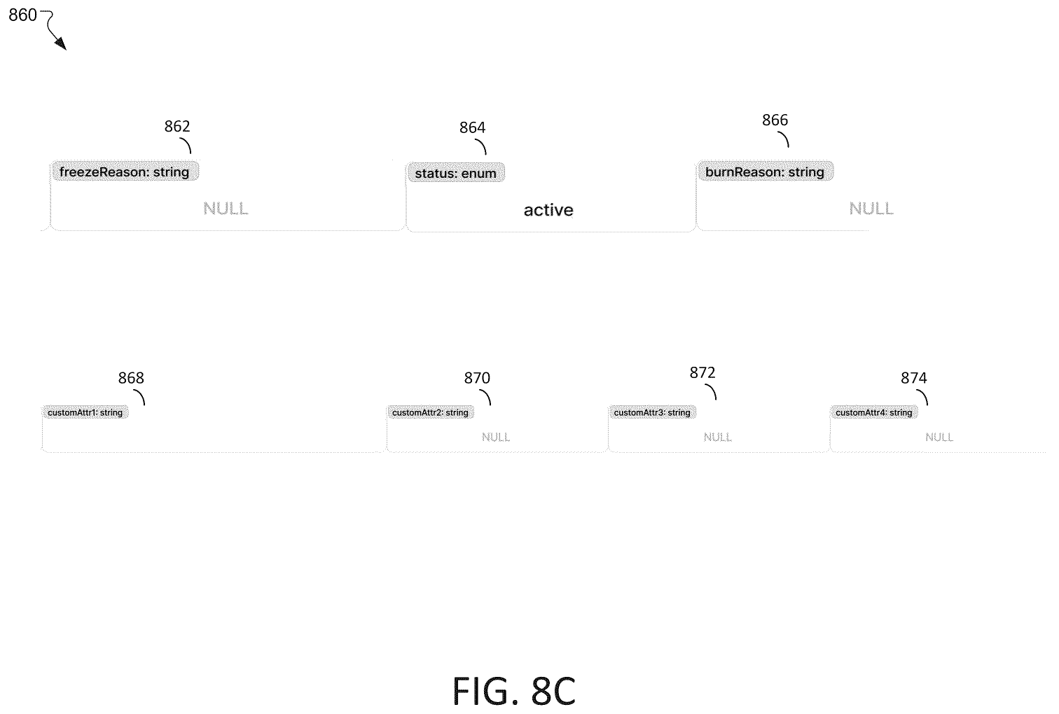

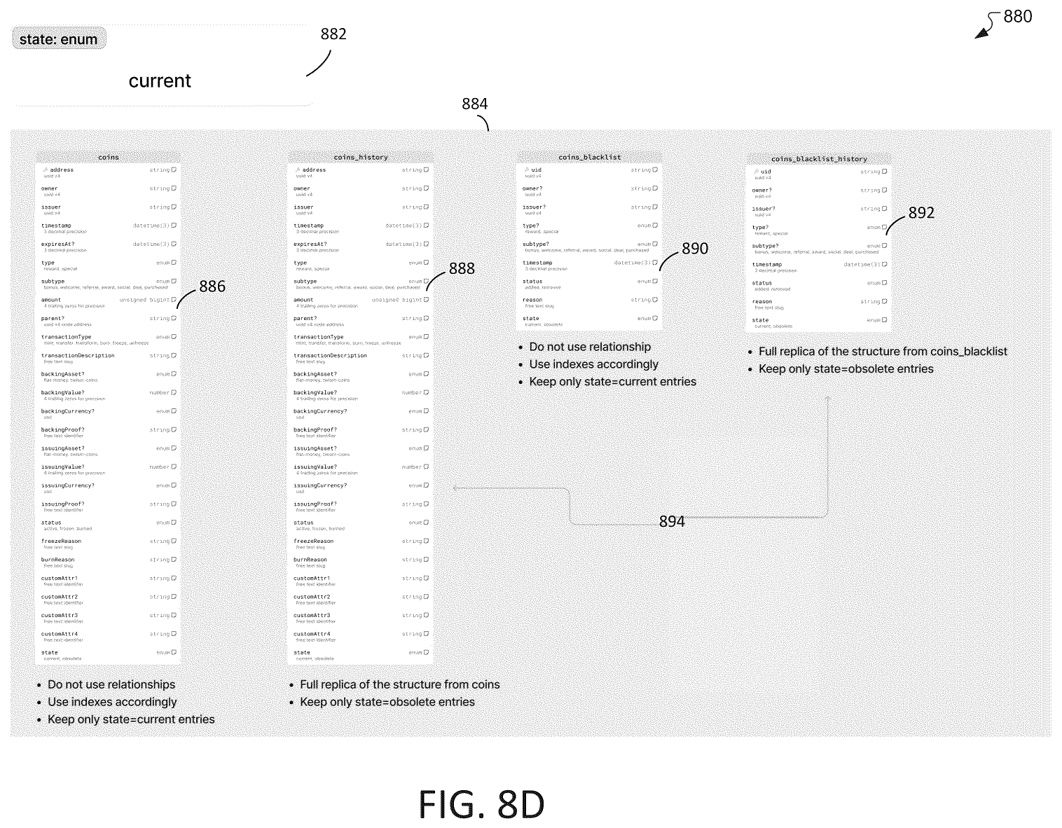

Ledger SDK 206 is an integration facilitator. Ledger SDK 206, constituting the third layer, plays a crucial role in streamlining interactions with custom private ledger 182. This software development kit functions as a bridge between diverse modules such as award coins, gift coins, reward coins, as well as ledger orchestrator 204. The award coins, gift coins, and reward coins will be described below with reference to FIGS. 7A-7C and 8A-8C. Acting as a versatile library, ledger SDK 206 simplifies communication and harmonizes interaction mechanisms. The presence of ledger SDK 206 empowers different services and features to seamlessly integrate and effectively utilize ledger core 202 for required operations.

In other embodiments, custom private ledger 182 may include components as shown in representation 250 of FIG. 2B. As depicted, ledger orchestrator 204 in FIG. 2A may be enriched through an additional layer, e.g., smart layer 254. Inspired by blockchain concepts, smart layer 254 can be configured to hold the mantle of smart contracts based on encapsulating intricate transaction rules and logic (e.g., multi-step approvals, material authentication, etc). This addition may facilitate the gradual migration of existing platform rules to smart layer 254, leading to enhanced isolation, control, and security. By aligning the custom-designed architecture with these forward-thinking principles, the present platform may secure the adaptability and efficiency of custom private ledger 182, and provide flexibility for future migration to a blockchain if considered appropriate.

The custom private ledger presented herein supports various operations (e.g., mint, transfer, transform, burn, etc.) involving multiple entities and multiple coin types. For example, in a network detection system, the present ledger may be applied to manage different types of digital assets (e.g., coins) representing various security events, threat levels, or system resources. The management of multiple types of coins among multiple entities ensures granular control, auditability, and real-time security enforcement in a decentralized manner. Considering an event-based coin transfer scenario, multiple entities and multiple types of coins may be involved. A threat detection node (TDN) in the network may detect and report security threats. A security processing node (SPN) may process detections and assign risk-based rewards or penalties. A security operator node (SON) may include an individual or automated agent that responds to threats. The coins can be threat score coins (TSC), mitigation reward coins (MRC), false positive penalty coins (FPC), reputation coins (RC), etc. A TSC is assigned to a detected threat based on severity (e.g., low, medium, high). An MRC is awarded to a SON that successfully mitigates a threat. An FPC is deducted from a node that reports a false threat to discourage unnecessary alerts. An RC reflects the credibility of detection nodes over time.

A TDN may detect a potential cyber threat (e.g., distributed denial-of-service (DDoS) attack, malware intrusion) and reports the threat to the present ledger, which records the event and assigns threat score coins (TSC) based on the severity. A SPN may validate the detection. If confirmed as a real threat, at least a partial of the TSC may be transferred to a SON as mitigation reward coins (MRC) for handling the response. However, if the detection is false, the responsible node may lose positive penalty coins (FPC). The present ledger automatically records coin transfers in real time, and updates the reputation coins (RC) associated with the TDN (and/or SPN) to reflect the accuracy of the threat. The present ledger may also prevent double spending by ensuring that coins are uniquely assigned per event, and moving expired or revoked coins (e.g., invalidated threats) to a historical record (e.g., coin_history) to prevent coin reuse.

The advanced distributed ledger system described herein offers significant technical advantages over traditional systems by enabling seamless multi-party, multi-asset transactions with high scalability, security, and efficiency. Unlike the traditional ledgers that support only single asset types, the present system facilitates native multi-currency support, atomic swaps, and programmable smart contracts for complex asset interactions. For example, no separate ledger implementations are needed for various types of assets, and no intermediary is required for multi-currency transactions. Optimized sharding, partitioning, and layer 2 scaling improve transaction throughput while reducing computational costs. For example, millions of coins may be processed across multiple entities in real time. Fine-grained access controls ensure secure multi-party collaboration, and real-time fraud detection prevents malicious activities. For example, when a false alarm of a network threat or a fraudulent transaction is detected, the present system may freeze affected assets before they can be transferred further. Built-in cross-chain interoperability eliminates the need for third-party bridges, while automated compliance mechanisms enable granular tracking and real-time reporting and enhance regulatory adherence. For example, unlike traditional systems using manual reconciliation, the present ledger automatically generates real-time audit logs. In contrast to the traditional system that executes transactions between two parties using smart contracts, the present system supports multi-party contract execution, allowing complex multi-asset processing. For example, a decentralized data storage and retrieval system can hold multiple retrieval results (e.g., responsive to multiple queries from multiple users) and return the results based on predefined conditions. By integrating efficient storage, low-energy consensus mechanisms, and artificial intelligence (AI)-driven risk management, the present system may achieve greater performance, lower costs, and enhanced security.

### Transaction Models

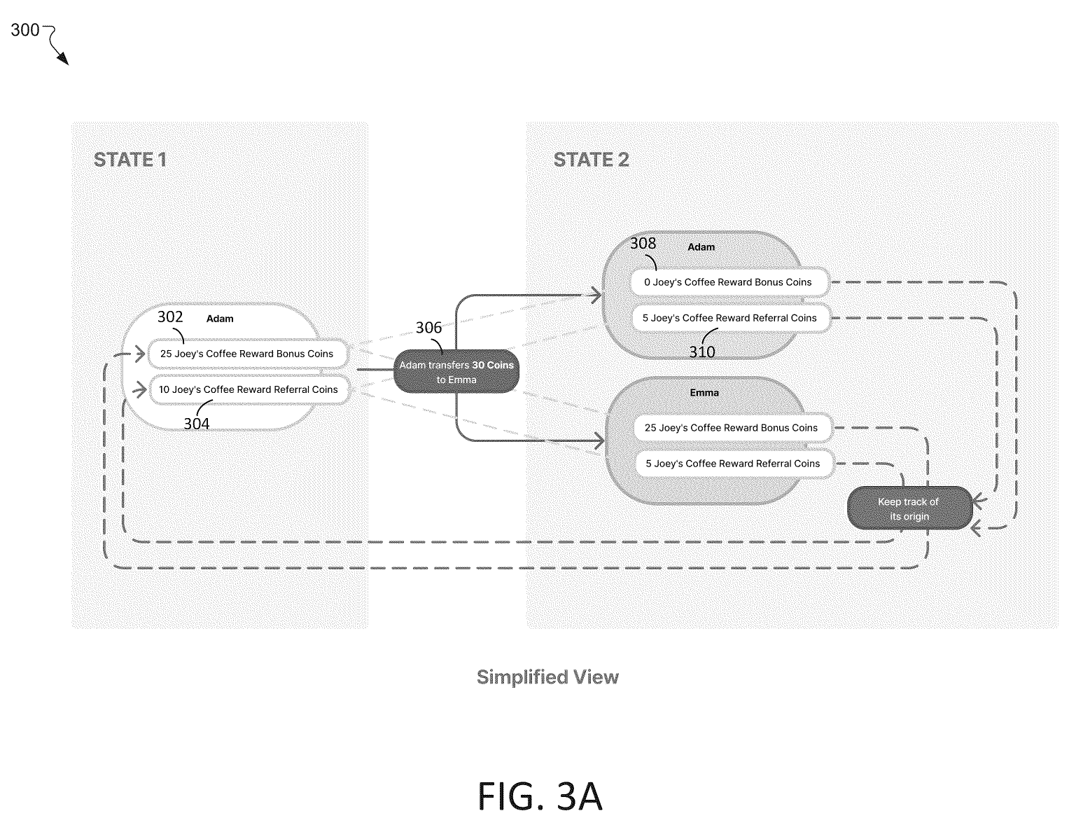

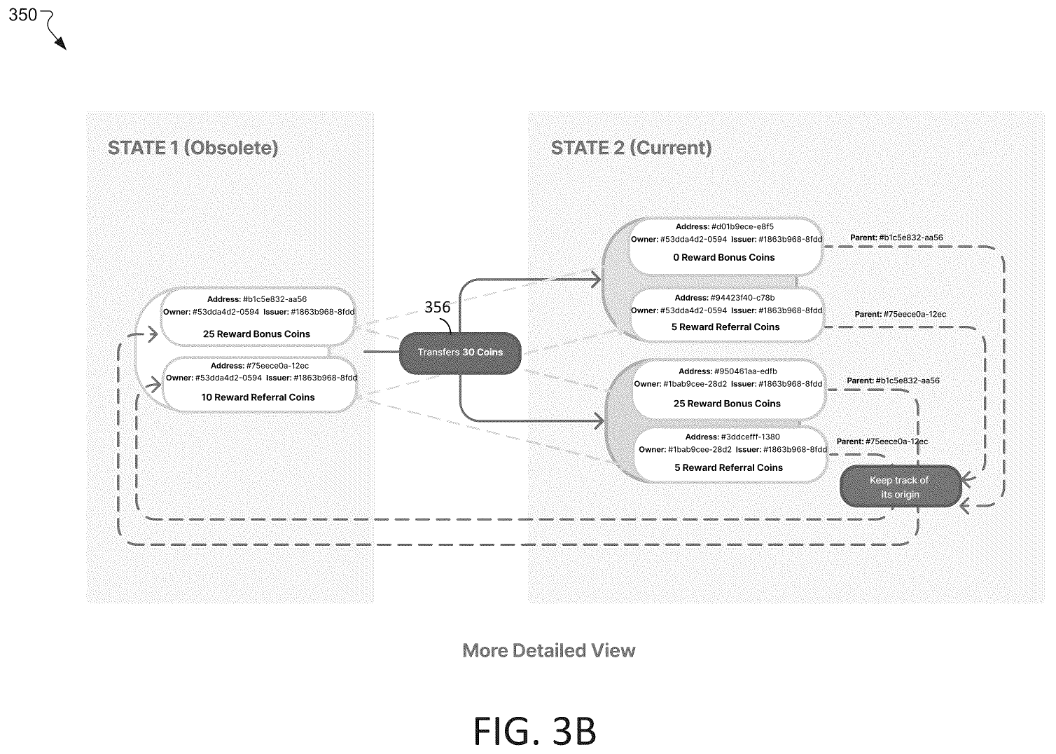

FIG. 3A illustrates a simplified view of an exemplary transaction 300 using a transaction model. Using this transaction model, historical data integrity, auditing and compliance, and state snapshot and coin type management are enhanced. In contrast to a conventional account-based model, the present transaction model draws inspiration from an unspent transaction output (UTXO) model embraced by Bitcoin and other blockchains. Instead of having a user account, the present transaction model uses multiple addresses associated with an owner. An owner can be any person or entity. In some embodiments, each address may safeguard a distinct amount of coins, marked by a combination of coin type and coin subtype, for example, “Reward Bonus Coins” and “Reward Referral Coins.” The architecture of transaction model 400 may create chains of transactions for various coin types and keep all ledger records without deletions or updates. As a result, an intricate tree is formed, steadfast consistency is achieved, and audits and security measures are simplified.

In the paradigm of FIG. 3A, all ledger entries are configured to persist indefinitely, forming an immutable record of chains of transactions. Each record is also referred to as a state, and each state may be obsolete or current. When a transaction creates a new “current” state, this turns the previous data that originated the new state “obsolete.” This design therefore eliminates data modifications and deletions, promoting data integrity.

As to enhanced auditing and compliance, the detailed transaction tree (e.g., in FIG. 3B) may improve the model's ability to track the flow of assets with precision. This supports audit trails and compliance efforts, which is important for operations in regulated industries.

Referring to FIG. 3A, a simplified view of state snapshot and coin type management can be seen. In the depicted example, State 1 shows Adam's possession of 35 reward coins from “Joey's Coffee.” The 35 reward coins include 25 bonus coins in 302 and 10 referral coins in 304. Responding to Adam transferring 30 reward coins (e.g., from 35 reward coins) to Emma in 306, the subsequent State 2 shows the updated distribution, turning State 1 obsolete. While Adam's bonus coins are depleted (e.g., 0 coins in 308), his referral coins persist (e.g., 5 coins in 310), indicating the unique ability of the present transaction model for granular control over different coin types.

FIG. 3B illustrates a unique security feature, providing a more detailed version of the same transaction example shown in FIG. 3A. This security or safeguard feature is particularly useful in 1) data anonymization for enhanced security and 2) protection against double spend and replay attacks.

In contrast to the transaction 300 of FIG. 3A, which uses names such as “Adam,” “Emma,” and “Joey's Coffee,” purely numeric representations for identifying the “owner” and “issuer” associated with a specific address are employed in transaction 350 of FIG. 3B. An owner is represented by a numerical identifier assigned to an individual or entity that has control over the coins within that address. An issuer is represented by a numerical identifier assigned to an entity that initially minted the coins. Minting is the process of validating information, creating a new block, and recording the information into a ledger. In transaction 350, “transfers 30 Coins” in 356 of FIG. 3B replaces the descriptive action “Adam transfers 30 Coins to Emma” in 306 of FIG. 3A.

The use of numeric representations is distinctively flexible, which enables the present platform to assign “ownership” and “issuing” attributes to any individual or entity as needed without actually identifying them. This approach empowers the present platform to share the comprehensive history of the ledger (e.g., custom private ledger 182) with auditors without compromising sensitive information. The numeric identification or data anonymization safeguards the privacy of involved parties, allowing for rigorous auditing and resource traceability using numeric proofs. This added security layer of custom private ledger 182 ensures that an individual's identity remains unrevealed. Beyond such audit benefits, this data anonymization security strategy also serves as a protective measure in the event of data breaches.

As mentioned in FIG. 3A, the ledger or transaction model is designed to incorporate a mechanism that flags previous nodes within a transaction chain as obsolete. A node or block is a device or participant that maintains a copy of the ledger and independently stores, processes, and validates transactions according to system rules. This process establishes an additional layer of defense against various attacks, such as double spending or replay attacks. Double spending means the expenditure of the same digital currency twice or more to avail of multiple services, which is a technical flaw that allows users to duplicate money. A replay attack happens when a hacker records and replays secure communication between two legitimate sources.

In the present platform described herein, even if an adversary attempts to replicate a valid request (e.g., employing identical certificates and signatures), the attack will fail because the attempt being made on an outdated state, effectively halting any manipulation attempts. By preventing the generation of new entries (even in consecutive requests) within the same millisecond, the present transaction model can ensure robust protection against double-spend attacks without relying on a pessimistic locking mechanism. This allows the integrity of transactions and safeguards against malicious activities, enhancing overall security measures.

The fine-grained control and security feature presented herein can also be applied in other fields. Suppose a decentralized identity ledger manages internet of things (IoT) devices with access granted using cryptographic tokens. A smart door lock holds multiple access tokens issued by a security system. When an authorized user enters, one access token is consumed and logged. The present ledger system may separately track different access token types (e.g., temporary guest token, permanent token, etc.,) and record the transition state in real-time (e.g., when a token type is changed, when a token is transferred to another user, etc.), ensuring fine-grained permission management. Each user is anonymized, and each valid access and/or transition is dated to avoid duplication.

### Safeguard Features

### Fingerprint

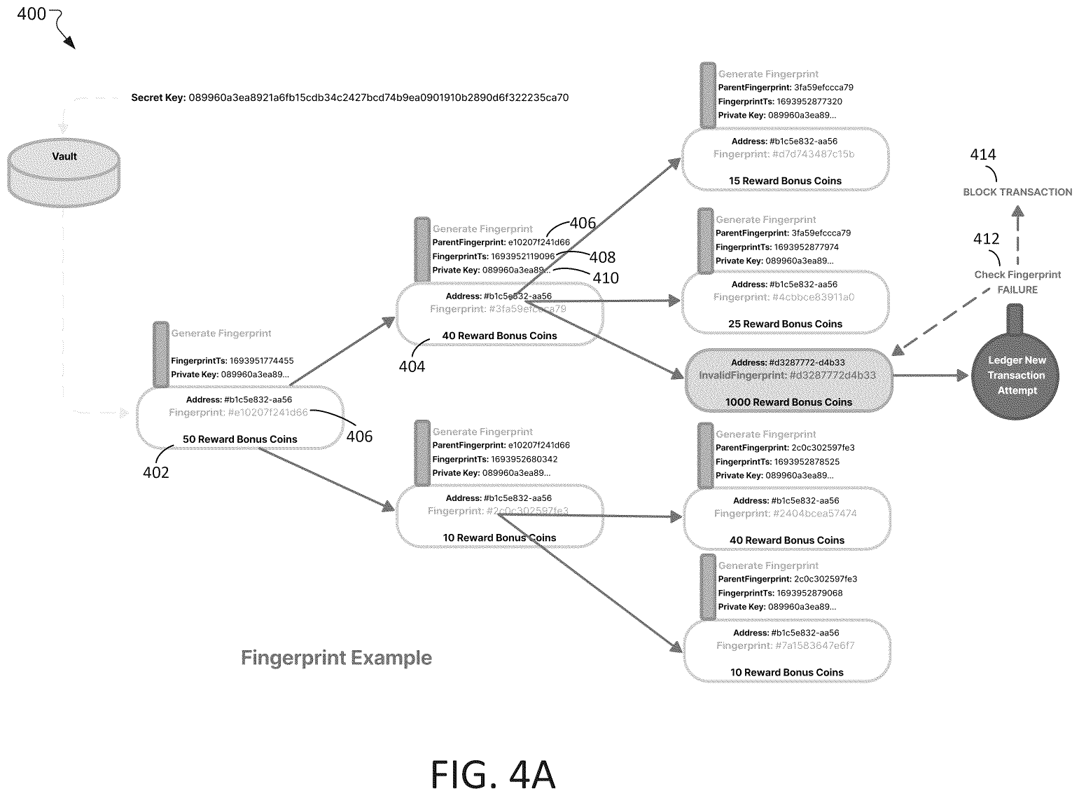

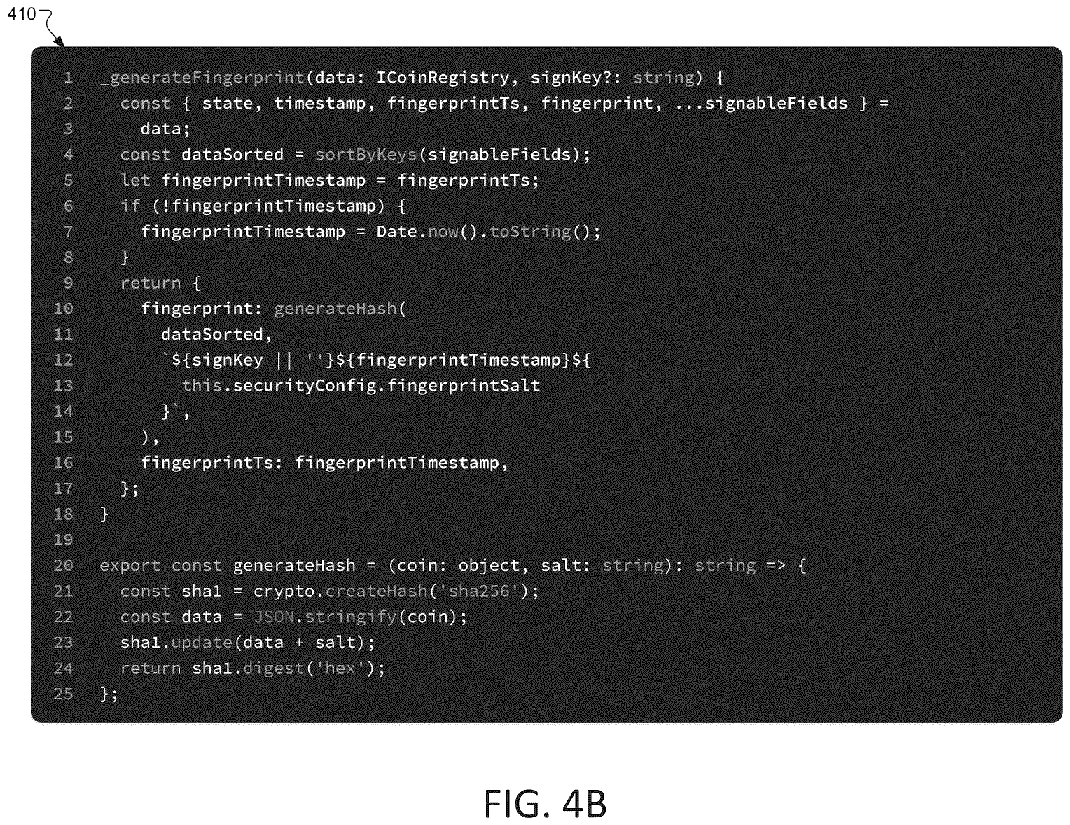

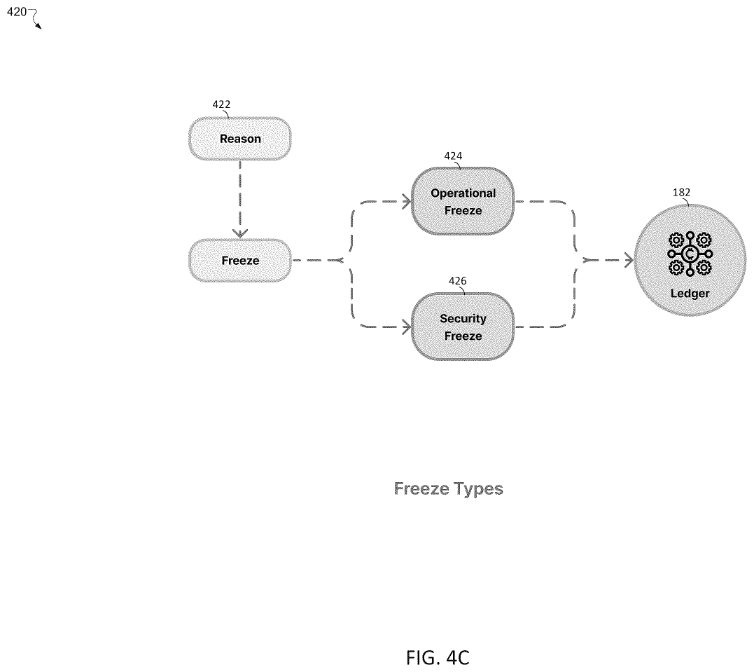

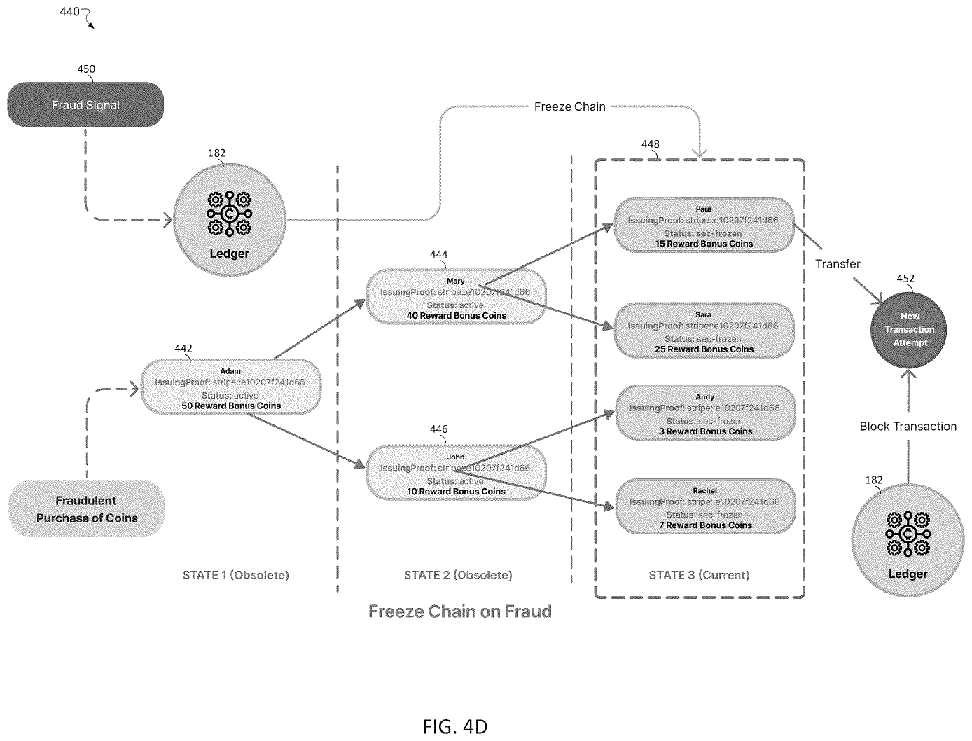

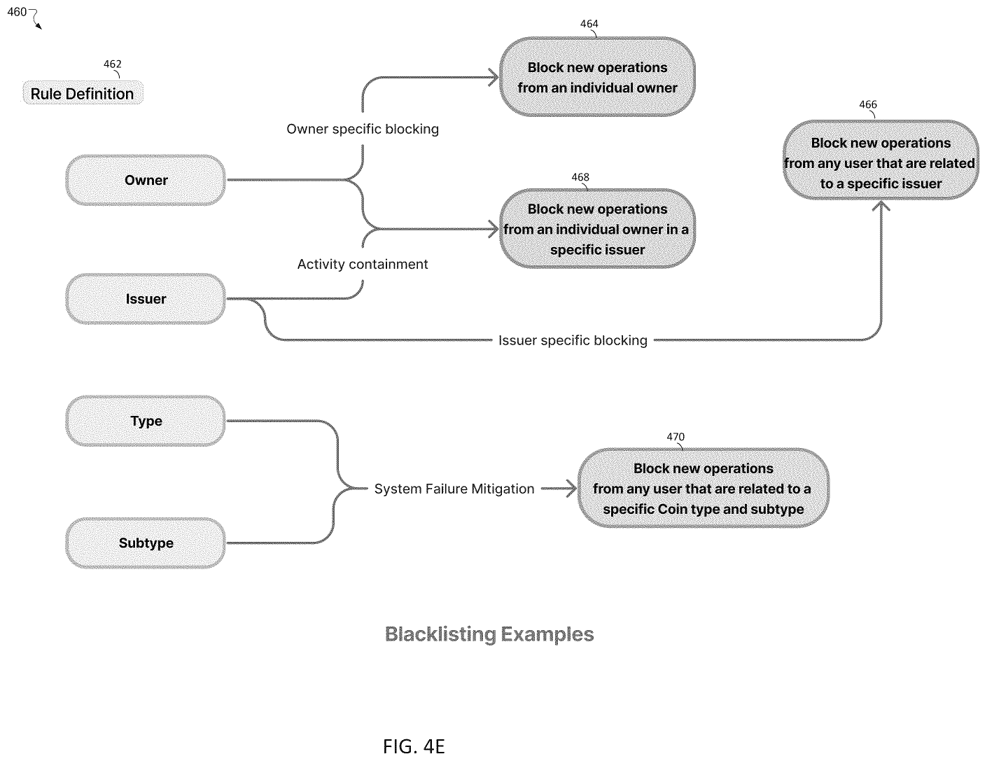

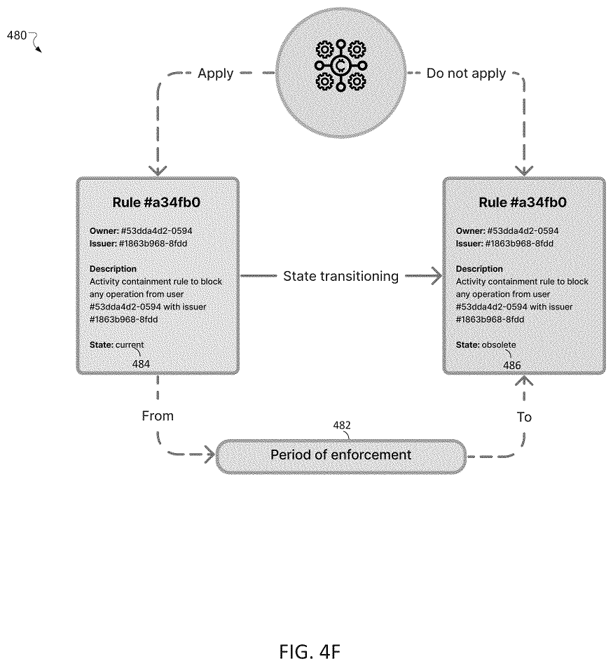

FIG. 4A illustrates an exemplary fingerprinting diagram 400. In this example, fingerprint mechanism, fingerprint chain, fingerprint inconsistency validation, and fingerprint enhanced security are described. Using the ledger proposed in this disclosure (e.g., custom private ledger 182 in FIG. 1D), each entry is fortified through a unique fingerprinting mechanism. Upon the creation of a ledger entry (e.g., transaction), a secure hash algorithm (e.g., SHA256) signature may be generated, encompassing all ordered attributes within the node to be signed. In some embodiments, this signature is salted with a timestamp and a secret key.

Responsive to the generation of a salt signature, any new transaction originating from existing entries may append the fingerprint (e.g., hash) of the parent node to the salt signature. In FIG. 4A, node 402 is the parent of node 404, where the fingerprint stored on node 404 is generated based on parent fingerprint 406, timestamp 408, and private key 410. This process establishes a resilient chain of nodes signing each other (i.e., a fingerprint chain). Each chain bears its distinctive fingerprint. Before any transaction is executed, the fingerprint chain can be used to verify the data consistency of the current ledger entry (e.g., in 412).

When performing fingerprint inconsistency validation, in case of any fingerprint inconsistency, the operation is instantaneously blocked (e.g., in 414), thereby safeguarding the integrity of the present ledger against potential tampering.

The fingerprint design enhances security in that it thwarts unauthorized alterations. For alterations, not only does an attacker require knowledge of the private key for signing, but they also need to modify the fingerprints across the entire transaction chain. This fortified approach maximizes the tamper resistance of the ledger entries and underscores the integrity and authenticity of transactions conducted in the present ledger-based platform. The fingerprint serves as a digital signature that underpins the veracity of data while safeguarding against unauthorized modifications and internal fraud. FIG. 4B illustrates exemplary fingerprint pseudo-code 410, which is executed to enhance the security of the present platform as discussed above.

### Coin Freezing

FIG. 4C illustrates an exemplary diagram 420 for coin freezing. Coin freezing is one of the security features performed by the present ledger (e.g., custom private ledger 182 in FIG. 1D). By coin freezing, no new operations are allowed in the present ledger once an address is frozen. In some embodiments, an operation such as freeze and unfreeze requires a mandatory reason 422 to describe why this operation happened, making it easier to understand what happened during an audit. This feature is useful for certain integrations and adds an extra layer of proactive defense against fraudulent activities.

In some embodiments, the freeze operation can be an operational freeze 424. This freeze is applied for operational reasons, such as holding funds during a transaction process or for other temporary purposes. These operational freezes are not part of the security scope and may be reversible by an initiator or an authorized entity within an organization following standard operational procedures.

In some embodiments, the freeze operation can also be a security freeze 426. This freeze is applied in response to security concerns, such as disputes, potential, fraud, unauthorized access, regulatory compliance issues, etc. The security freeze typically requires a high level of authorization to apply and remove, reflecting the seriousness of the circumstances that trigger the security freeze operation.

### Freeze on Fraud

FIG. 4D illustrates a block diagram 440 of an example freeze chain on fraud. In this example fraud scenario, it is identified that user Adam conducted a fraudulent transaction, purchasing 50 coins at 442 with a compromised credit card. To obscure his fraudulent activities, user Adam distributed the 50 coins to users Mary and John at 444 and 446, and Mary and John sent the coins to other users at 448. In such a scenario, the present ledger allows swift freezing of the assets involved for risk containment. In this way, the present ledger can prevent further dissemination of the fraudulently acquired coins, thereby containing the situation and safeguarding the platform's integrity. This immediate action not only halts the fraudulent activity in its tracks but also facilitates a thorough investigation by preserving the status quo of the assets and accounts involved.

The freezing mechanism may freeze a chain of transactions, which is particularly evident for the scenarios involving transactions initiated from compromised sources, such as fraudulent credit card purchases. In the example of FIG. 4D, once fraud signal 450 is detected, the present ledger 182 may freeze the chain of transactions at 448 to block any new transaction attempt 452 involving the fraudulently acquired 50 coins by user Adam. Leveraging the present ledger model therefore may promptly freeze the entire cascade of transactions linked to the fraudulent transaction once the dispute signal is received, offering a remarkable efficacy as compared to existing account-based models.

### Ledger Blacklist

Blacklisting is a flexible mechanism for tailored security enforcement to meet various security needs and challenges, from blocking individual users to restricting actions at specific entities (e.g., issuers, merchants). FIG. 4E illustrates a block diagram 460 of blacklisting examples. As depicted, blacklist rules may be defined based on factors related to owners, issuers, types, and subtypes at 462. The permutation of these factors allows the creation of a certain number (e.g., up to 24) of distinct and precise control rules. By leveraging these combinations, the present ledger system can create fine-grained security rules.

In some embodiments, blacklist or blocking rules can be configured based on owners or issuers as shown in 464 and 466. This allows for the precise blocking of specific owners (e.g., users, customers) or issuers (e.g., network administrators, merchants) from conducting any transactions within the present ledger system. For example, the blocking rules may block a specific computer user (e.g., hacker) as shown in 464 and/or exclude all users associated with a specific domain as shown in 466. These users may be identified by specific addresses, user registration, or other metadata.

In some embodiments, blacklist or blocking rules can be configured in view of activity containment as shown in 468 to effectively reduce suspicious or fraudulent activity at specific issuers. Additionally, by creating rules that target both the owner and the issuer, all transactions, operations, or changes involving questionable behavior may be swiftly blocked, preventing further harm (e.g., spread of fraudulent actions, unauthorized access) to the integrity of the ledger platform. For example, rule 468 may be applied to block any operations of a specific cyber-attacker from a specific network domain.

In some embodiments, blacklist or blocking rules can be employed to indicate system failure mitigation as shown in 470. This offers a proactive approach to addressing systemic failures within the platform. By blocking operations related to specific coin types and subtypes, potential issues stemming from faulty functionalities or vulnerabilities may be mitigated, ensuring the overall stability and reliability of the present ledger system. For example, rule 470 may be applied to block any operations related to the type of “Welcome Coins.”

### Blacklist Immutability

Similar to ledger entries, the above-discussed blacklist may adopt a model where entries are never deleted, but rather become obsolete over time. Advantageously, this no-deleting feature allows perpetual record keeping, facilitates historical tracking and recovery, improves integration with ledge events, and tracks and manages periods of enforcement.

By retaining all entries, the blacklist mechanism applied in the present ledger system is able to maintain a perpetual record of all created rules. This ensures a complete history of applied restrictions over time, facilitating auditing and retrospective analysis.

The immutability model of the blacklist presented herein also allows obsolete, old rules to be retrieved at any time, enabling rule evaluation analysis (e.g., how restrictions have changed over time, how the changes have impacted ledger behavior, etc.). This is important for understanding the context behind certain security decisions and investigating potential breaches and ledger-tracked operations.

In the present ledger system, blacklist entries may be cross-referenced with ledger events, providing a comprehensive view of how blocking rules impact actual transactions. This enables accurate assessment of the impact of restrictions on platform security and integrity, as well as providing valuable insights for future system improvements.

A period of enforcement is the duration during which a rule in a blacklist was actively applied. In some embodiments, it is indicated by the rule state “current” in the ledger system. This period begins when a rule is created and activated and ends when the rule becomes obsolete. The rule can be manually created or automatically triggered by specific conditions. The rule can become obsolete due to changes in system requirements, policy updates, or other factors. Tracking the period of enforcement may provide valuable insights into the effectiveness and relevance of each rule over time. FIG. 4F illustrates a block diagram 480 of an example period of enforcement. This period 482 associated with the rule “#a34fb0” is indicated by the rule state transition from “current” 484 to “obsolete” 486.

### Data Architecture

The ledger system described herein has some unique features in data architecture, especially in address composition. Addresses in the present ledger system serve as containers for sets of coins. In some embodiments, each address may be identified by a unique combination of type and subtype. These addresses can efficiently organize and manage various types of coins within the ledger. These addresses serve as both wallet addresses and contract addresses since each address not only holds coins and represents an entity that conducts transactions using the coins but also executes logic to manage the coins with programmed rules.

In some embodiments, each address is associated with a specific owner and/or issuer, providing clear referencing to the entities responsible for the coins contained within. This enhances transparency and accountability in coin transactions within the present ledger system.

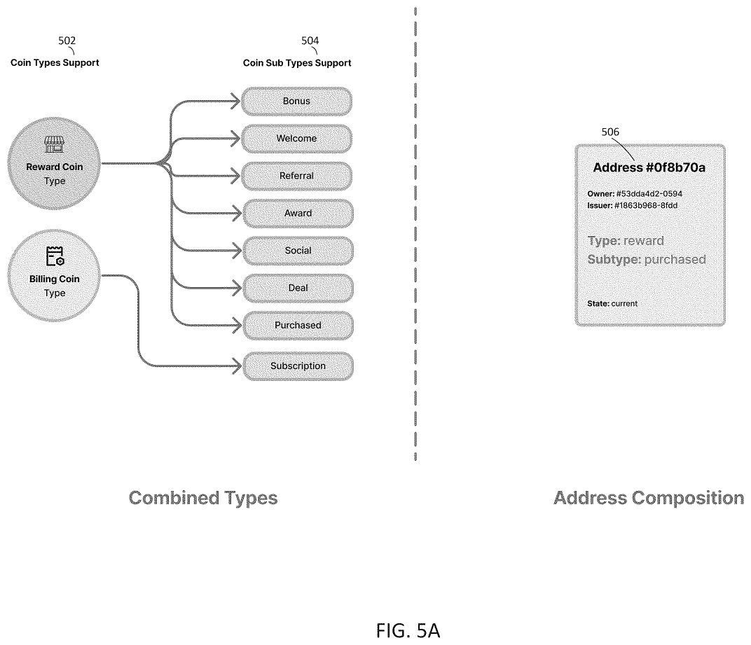

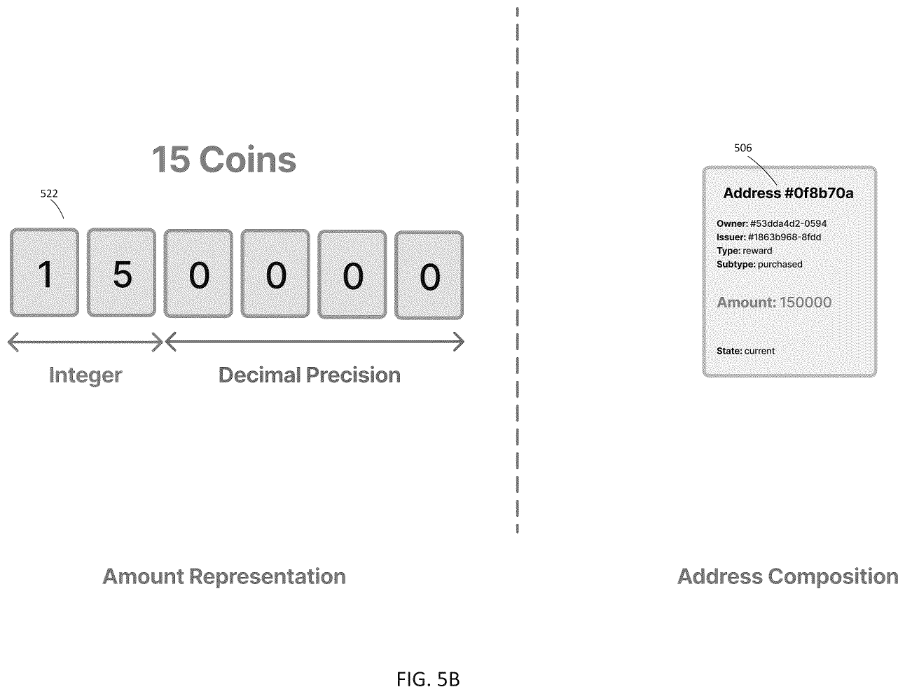

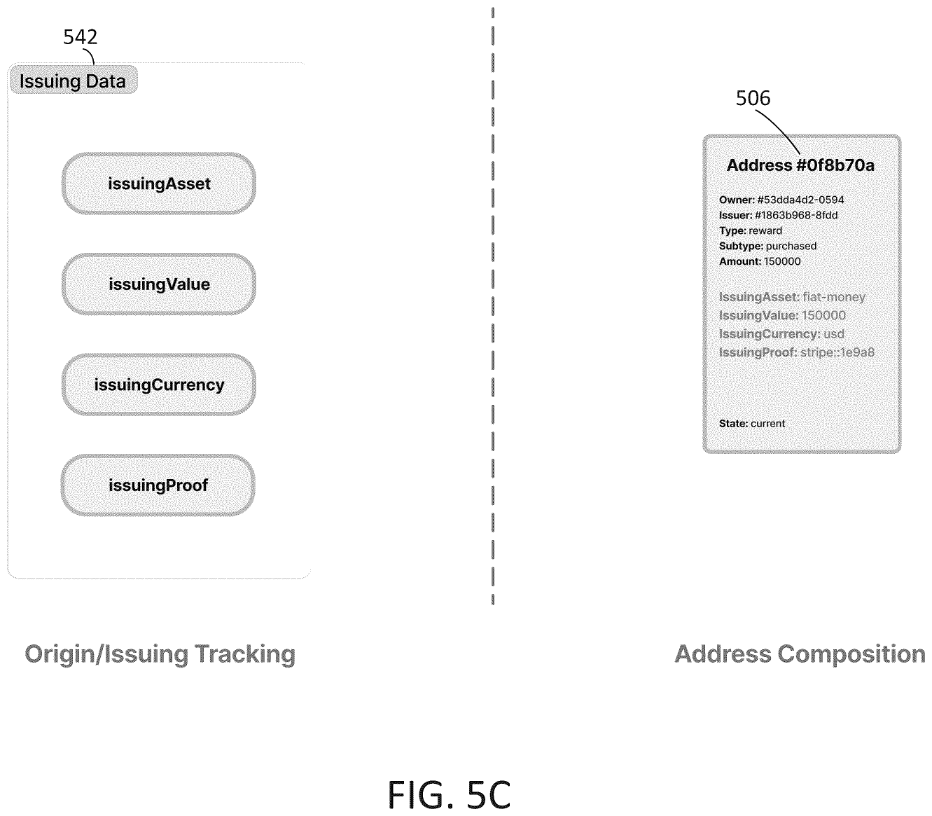

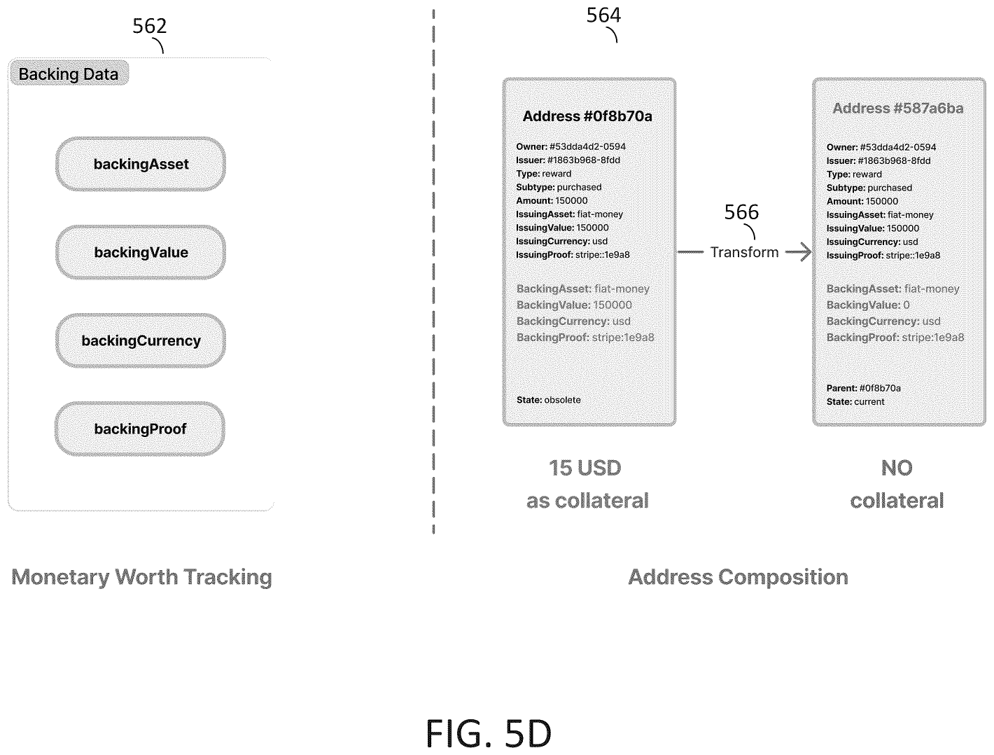

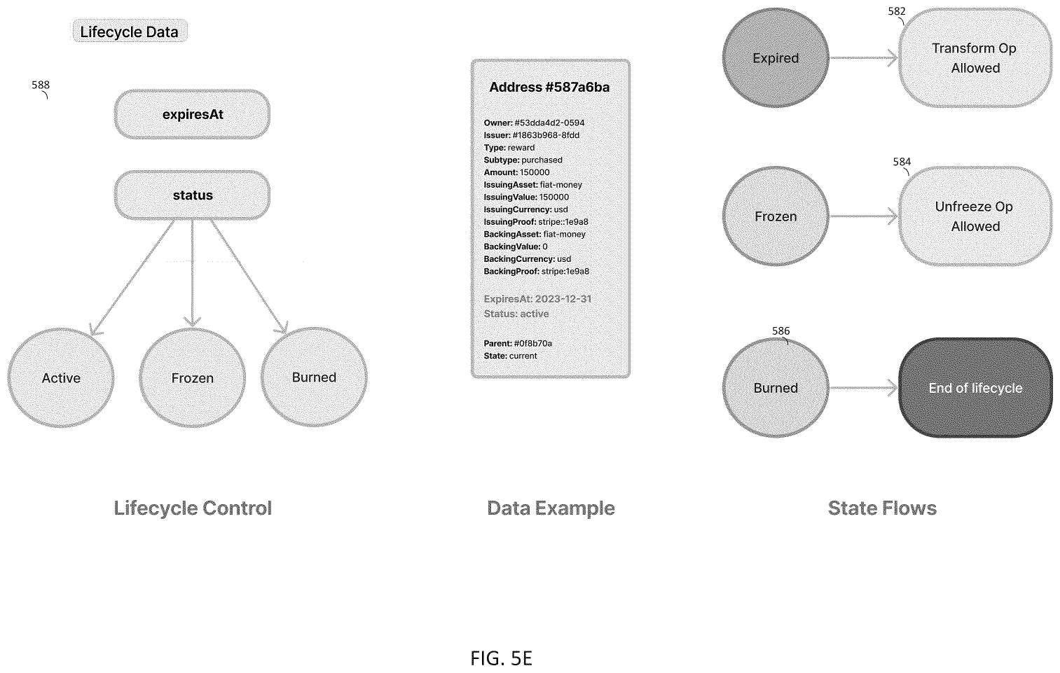

FIG. 5A illustrates exemplary types and subtypes associated with an address in the present system. The ledger may categorize addresses into distinct types 502, e.g., “Reward” and “Billing.” The ledger may further refine the types with specific subtypes 504, e.g., “Bonus,” “Welcome,” “Social,” “Purchased,” “Referral,” “Deal,” “Award,” “Invite,” and “Subscription.” This hierarchical structure allows for precise identification and classification of different coin varieties, e.g., reward bonus coins, reward welcome coins, billing subscription coins, etc. In some embodiments, the ledge system may associate only one coin type (e.g., “reward”) and one subtype (e.g., “purchased”) with an address 506.

This extensible coin type and subtype representation is flexible and scalable. For example, new coin types and subtypes can be effortlessly incorporated into the ledger system by introducing new acceptable values. This ensures the present ledger system to easily accommodate evolving practical needs, allowing for the addition of custom nomenclatures and representations as required by the core platform.

### Amount Representation

Generally, each address described herein (e.g., address 506) may include an amount field to hold an amount of a coin, e.g., an integer numerical representation of the amount of coins of a given type and subtype. FIG. 5B illustrates an exemplary amount representation 522 used in the present ledger system. In this example, the last four digits in an address are used as the decimal precision of a coin value. That is, the numerical representation 150000 is construed as 15 coins since the last four digits “0000” denote the decimal precision. It is noted that different numbers of digits in a coin address may be used as the decimal precision.

Integer representation, i.e., employing integers in ledger calculations, is advantageous. As depicted in FIG. 5B, with the last four digits reserved for fractional values, this representation ensures precision while simplifying arithmetic operations. By eliminating the need for floating-point calculations and rounding errors, integer-based calculations enhance accuracy and computational efficiency. Moreover, this approach may improve processing speeds and scalability.

Given a certain number of digits being used for decimal precision, a maximum amount limit and a minimum amount limit for a coin can be determined. In some embodiments, the present ledger system uses an unsigned large integer type with a maximum value of 2⁶⁴−1, which is 18,446,744,073,709,551,615. However, due to language limitations, a safe maximum value would be 2⁵³−1, or 9,007,199,254,740,991. In the example notation shown in FIG. 5B, where the last four digits represent the decimal part, this translates to a maximum quantity of coins in a single address of 900,719,925,474.0991, i.e., about 900 billion coins.

A minimum amount limit refers to the smallest non-zero fraction that can be represented within the ledger system described herein. While zero is the lowest value that can be stored, the minimal non-zero fraction is determined by the precision of the data type used to represent amounts in the ledger. In the present ledger, the precision is defined by the number of decimal places allowed in the amount field. As depicted in FIG. 5B, the precision is set to four decimal places, and thus the minimal non-zero fraction would be 0.0001.

### Issuing Data

FIG. 5C illustrates exemplary issuing data used in the present ledger system. In some embodiments, an address (e.g., address 506) can be configured to store and track issuing data 542, which includes an issuing asset, an issuing value, an issuing currency, an issuing proof, etc.

An issuing asset refers to the asset utilized in exchange for generating or issuing a group of coins or the asset originally emitted. This field is useful for tracing the origin of coins within the present ledger system. For example, fiat money or billing coins can serve as issuing assets, depending on the context of issuance.

An issuing value indicates the number of units of the backing asset tied to the issuance of coins. The backing asset provides insight into the amount of issuing support associated with a particular group of coins, contributing to the overall monetary worth support within the present ledger system.

An issuing currency denotes the currency of the issuing asset. For example, if fiat money is the issuing asset, the issuing currency could be USD (i.e., US dollars). This field may provide clarity regarding the currency denomination of the asset used in an issuance process.

An issuing proof serves as a reference to any evidence regarding the issuance of the asset. This may include unique identifiers or references from the present core platform or third-party services, ensuring transparency and traceability regarding the origin of the issuing asset within the present ledger system.

### Backing Data

FIG. 5D illustrates exemplary backing data used in the present ledger system. In some embodiments, backing data 562 includes a backing asset, a backing value, a backing currency, a backing proof, etc.

A backing asset represents the collateral present in an address, indicating the support that a group of coins still possesses. The backing asset provides collateral or value support for another asset (e.g., issuing asset). For example, gold backs a digital token. If an entity fails to meet its obligation in a transaction, the collateral can be used to cover potential losses. The field of backing asset is important for understanding the monetary worth support behind coins within the present ledger system.

A backing value denotes the total amount of the backing asset tied to the collateral of coins. The backing value provides insight into the quantity of collateral associated with a particular group of coins, contributing to the overall monetary worth support within the present ledger.

A backing currency represents the currency denomination of the backing asset. For example, if the backing asset is fiat money, the backing currency could be USD. This field clarifies the currency denomination of the collateral associated with coins.

A backing proof serves as evidence regarding the existence of collateral for the asset. This descriptor typically includes unique identifiers or references from the present core platform or third-party services, ensuring transparency and traceability regarding the presence of collateral within the present ledger system.

A withdrawal scenario is shown in 564 of FIG. 5D. When the collateral is withdrawn from the platform, e.g., when an entity (e.g., merchant) withdraws funds, all coins in the ledger associated with this collateral must undergo a “transform” ledger operation 566. This operation updates the ledger to reflect the removal of the backing asset and backing amount previously linked to it, indicating the removal from the platform. With this operation, the ledger no longer records the previously existing quantity of backing asset, since it should have been deducted from the total withdrawn by the entity.

As discussed above in FIGS. 5C and 5D, the present ledger system supports a traceable issuance mechanism and collateralized backing mechanism. The traceable issuance mechanism ensures transparency and accountability by tracking the origin of each coin within the present ledger system. For example, through fields such as issuing asset and issuing proof, the present system may establish a clear lineage for coins, facilitating auditing processes and reinforcing trust in the digital currency ecosystem. The collateralized backing framework provides robust support for the value of coins within the present ledger. For example, fields like backing asset and backing value represent the collateral present in each address, guaranteeing the stability and reliability of specific digital assets. This mechanism enhances confidence among users and stakeholders, fostering a secure financial environment.

The integration of traceable issuance and collateralized backing underpins the stability and reliability of the present ledger system. By enabling each coin to be backed by real-world assets or currencies, the present system instills confidence in the integrity of transactions and the overall financial ecosystem.

### Lifecycle Control

The present ledger allows for an optional expiration date for each address, indicating when a set of coins becomes invalid. Subsequent operations, e.g., transfers, freezes, or unfreezes, are prevented if the expiration date has been reached. FIG. 5E illustrates an exemplary diagram of lifecycle control and state flows in the present ledger system.

In some embodiments, upon expiration, coins in the associated address become unusable for further operations, except for a transform operation at 582. The transform operation allows properties to be modified, enabling scenarios such as extending the validity period of coins if required by the platform.

In some embodiments, when coins are frozen, the coins are temporarily restricted from any actions although they remain within their lifecycle. The present ledger system allows the coins to be unfrozen and utilized without issues at 584, which will restore access to the coins, allowing transactions and operations to resume. This unfreeze operation indicates that the coins have not yet reached the end of their lifecycle.

A burn operation at 586 is irreversible, as it permanently removes coins from circulation. Once burned, coins cannot be restored, marking the end of their lifecycle within the ledger system.

Expiration dates enable the automatic handling of outdated coins. For example, lifecycle data 588 includes an expiration date and a status (e.g., active, frozen, burned). This reduces the risk of unauthorized or obsolete transactions. Lifecycle control and management, including freezing, expiration, and burn operations, provides flexibility and robustness to the present ledger platform, thereby allowing for efficient handling of coins throughout their lifecycles from creation to disposal.

### Ledger Architecture Overview

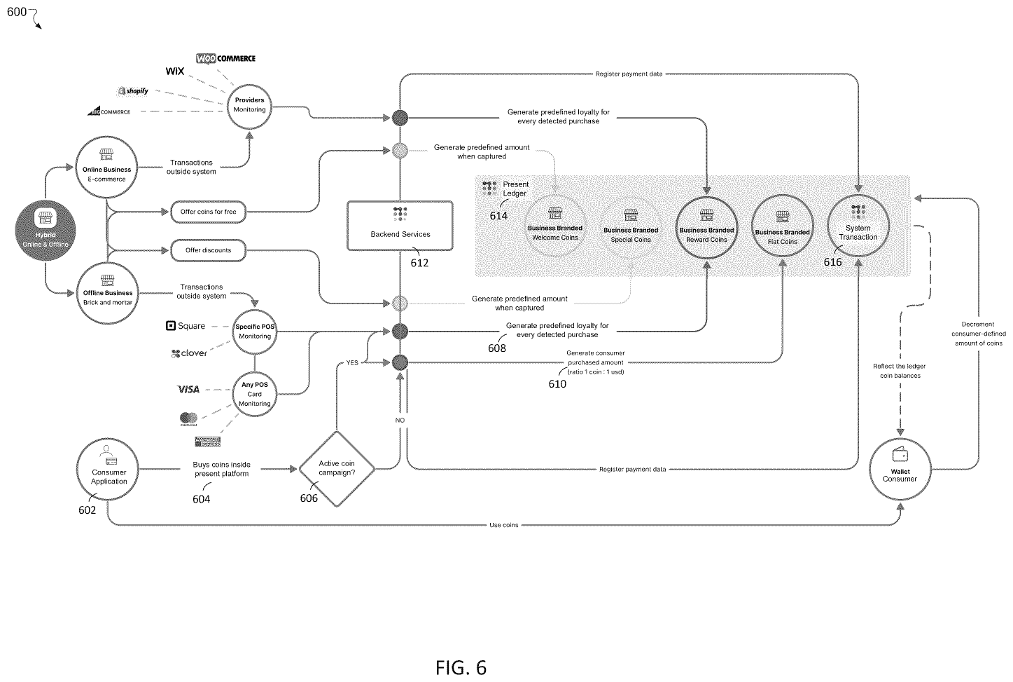

FIG. 6 illustrates an exemplary diagram 600 of an overview of ledger architecture. The diagram shows how multiple parties involved in communication can perform different transactions without third-party intervention, and how verification and validation are carried out to secure the transactions. For example, a consumer/party/entity may install 602 a particular software application on a user device (e.g., a mobile device, a computer, etc.). Once the consumer is connected to the present platform via the installed application, the consumer can buy 604 coins inside the present platform (e.g., using a credit or debit card). In the context of a network detection environment, each entity can be a threat detection node (TDN), a security processing node (SPN), or a security operator node (SON), etc., which is communicatively coupled with each other to implement network and computer security protection based on granular control through the management of different types/subtypes of digital assets (e.g., coins) representing various security events, threat levels, or system resources.

The present platform then determines 606 whether there is a tokenized incentive program (e.g., an active coin campaign). If such a coin campaign exists, the present platform generates 608 predefined loyalty for every detected purchase (e.g., associated with the specific merchant). Otherwise, the present platform generates 610 a consumer purchased amount. This transaction (e.g., purchasing coins) is implemented through communications among different parties based on the backend services 612 and robust ledger structure 614. The transaction can be recorded in the ledger (e.g., in 616), and also associated with one or more types of coins (e.g., reward coins, fiat coins, etc.) in the ledger. In some embodiments, a spectrum of operations, including Mint, Transfer, Transform, Freeze, Unfreeze, Burn, and Get, may be performed based on corresponding operational rules. In the example of network detection, these coin operations are performed between the nodes as security events are detected and evaluated.

FIGS. 7A-7C illustrate exemplary operational rules and actions established for specific operations/processes. The fundamental operational rules 700 for a supply process are shown in FIG. 7A. A coin is a unit of an asset in a ledger. As depicted, the present ledger (e.g., ledger 614 in FIG. 6, custom private ledger 182 in FIG. 1D) supports different types of coins such as reward coins 702, special coins 704, and cash coins 706.

Since unavailable coins cannot be analyzed, coin supply is the first precursor of coin processing. Coin supply appears in different forms such as initial supply 702, circulating supply 704, maximum supply 706, and total supply 708. An initial supply is the total amount of coins on creation. A circulating supply is the number of coins available in the ledger at a particular time. The circulating supply does not include vested, reserved, or burned coins. A maximum supply refers to the amount of coins that can be minted. A total supply is the total amount of coins a protocol created, whether or not they are in circulation.

The rules regarding different types of supplies for different types of coins are shown to meet specific requirements of the present ledger in FIG. 7A. For example, there are a zero initial supply rule and an unlimited maximum supply rule. The present ledger determines that coins will not be minted on creation, leading to the zero initial supply rule as shown in row 716. By setting initial supply 708 to be zero for different types of coins 702, 704, and 706, these coins would not be considered as circulating supply 710 because these coins do not yet exist. Using this rule, the present ledger can avoid creating coins and assigning the ownership to an issuer (e.g., a merchant), which would require a transfer operation instead of minting. Minting the coins is possible after the creation of coins.

With the unlimited maximum supply rule, no maximum supply will be defined as shown in row 718. This rule benefits because the supply of some of the coins 702, 704, and 706 may depend on specific campaigns or settings, where a maximum supply 712 cannot be applied in such a dynamic environment.

FIG. 7B shows operational rules 730 for a minting process. Minting is a process of creating new coins on a ledger. For various types of coins 702, 704, and 706, the present ledger (e.g., ledger 614 in FIG. 6, custom private ledger 182 in FIG. 1D) sets up an “unlimited” rule in row 732. With this rule, the present ledger does not impose any limitations or validations at a ledger logic layer (e.g., smart contract). This means that the present ledger has full and unlimited control over minting for all issuers (e.g., merchants) and/or participants (e.g., customers).

In some embodiments, rules such as “100 welcome coins limitation” will be defined by certain components of the present platform but not by the ledger (e.g., ledger 614 in FIG. 6, custom private ledger 182 in FIG. 1D). This kind of rules would require the evaluation of other and more complex implementations of the smart contract, for example, having metadata on interplanetary file system (IPFS) or using Oracle® databases to obtain dynamical information.

Minting (not transfer) may be applicable in different situations but under the premise of having no initial supply. This indicates that coins will be minted later, rather than being transferred initially. For example, when controlling access to IoT devices using cryptographic tokens (coins), no token is minted until a smart door needs to be accessed by a user. In another example, a deal created by a merchant will not mint any tokens/coins, even if they are limited to a specific amount of units (e.g., 100 units). However, if a customer collects or redeems that deal, then the tokens/coins will be minted at that moment.

FIG. 7C shows operational rules 760 for a burning process. Burning is to send some coins to an address that no one can access, i.e., forever ejecting these coins out of circulation. Once a coin is out of the circulation supply, it cannot be reused. Burning may increase coin values because they become scarce. As depicted, by burning on payment (e.g., row 762), a coin will end its lifecycle and its ownership will not be transferred to an issuer/creator (e.g., a merchant). When not burning on transfer or gift (e.g., row 764 and entry 766), the ownership of a coin can be changed but all attributes will persist.

### Structural Capabilities

The present ledger (e.g., ledger 614 in FIG. 6, custom private ledger 182 in FIG. 1D) has many distinct structural capabilities and features, which will be described below with reference to coin structural samples shown in FIGS. 8A-8D. In these figures, the exemplary sets (e.g., 800, 830, and 860) of attributes/states and model(s) are illustrated.

The present ledger does not include any personal or sensitive information about the owner of an account or transaction in coins. For example, the present ledger keeps only user identifier (UID) hashes as shown in the coin samples 804 and 806 of FIG. 8A. The present ledger may identify the account holder in the “owner” 804, which can be a customer identifier or a merchant identifier. The present ledger may also identify the issuer of a group of coins in the “issuer” 806, which can be a merchant identifier.

The present ledger can issue different coin types for each brand (e.g., issuer), such as reward coins, special coins, etc. The present ledger identifies the subtype(s) of each coin. In some embodiments, a reward coin may have subtypes including bonus, welcome, referral, award, social, and purchased. A bonus coin is given to the owner when an online or in-store purchase is made. A welcome coin is given as a welcome incentive. A referral coin is given when an owner makes a referral to friends. An award coin is given by an issuer (e.g., a merchant). A social coin is earned from social interactions. A purchased coin is given when a customer pays for it. On the other hand, a special coin can have a deal subtype and a welcome subtype, where the deal coin is given when a deal is collected, and a welcome coin is for a welcome incentive.

As shown in FIG. 8A, the present ledger may generate a coin represented by an address 802 (e.g., automatically generated address) with an owner 804 and an issuer 806. The creation time and expiration time of this coin are respectively shown in timestamp 808 and expireAt 810. The coin is of type 812 with a subtype 814. The use of timestamp 808 is to avoid misunderstanding the concept of creating or minting. The purpose is to identify when a transaction happened, regardless of the nature of an operation. In some embodiments, a custom field can be used to define an expiration date 810 for a group of coins. In the example of FIG. 8A, “NULL” in expireAt 810 indicates that the ledger would not take any action (e.g., freeze or burn) if a coin expires.

The present ledger may be configured to handle coin amounts up to a certain precision (e.g., four decimal precision). The amount 816 represents the quantity of coins associated with the transaction. With four decimal precision, the four leading zeros in 816 are used as precision, and the amount value of 500000 in 816 is equivalent to 50.0000, i.e., 50 coins.

In some embodiments, the present ledger can trace current coins up to their genesis (e.g., minting, creation) even after transfers, transformations, etc. The present ledger always keeps a reference to the old or parent entry that resulted in one or more new entries, as shown in parent 818. If an entry is not the first entry (on minting), then the present ledger indicates the parent entry address of this new entry in parent 818.

Referring now to FIG. 8B, transactionType 832 represents the action type of the ledger function that was initially called, which led to the creation of this entry. The present ledger is able to identify the specific operation that resulted in a new entry in the ledger. For example, transactionDescription 834 is a custom description provided as an input to the ledger function, which then triggers a transaction and results in the creation of a new entry.

The present ledger can identify coins that are backed by fiat money or other assets. A backingAsset 836 reflects the asset that backs the group of coins or the originally minted group. A backing Value 838 shows the number of units of the backing asset. In the example of FIG. 8B, there are 50 reward coins (e.g., purchased), but these coins are backed by 100 USD, because the backing attribute remains unchanged even in new entries derived from a previous one. Considering the operation descriptor is “send-coins,” this means that a user can send 50 coins that were originally backed (e.g., full or partially by 100 USD). Since the present ledger allows divisible fractions of the original backing to be applied to subsequent coins, this eliminates the need for complex backtracking from parent to parent to trace the origin of the backing. The backingCurrency 840 shows the currency of the backing asset, for example, in fiat money.

The present ledger can identify coins that were paid for (generated by money or other assets) and keep the proof of payment. In some embodiments, the ledger can perform a minting process (e.g., creating new coins). In other embodiments, the ledger may also perform other operations such as transfer (e.g., selling coins), transform (e.g., extending the expiration of a coin), etc. A backingProof 842 or issuingProof 850 is a reference to any type of proof indicating that the asset is backed. The present ledger allows this descriptor to be in a free-text format. In some embodiments, it is recommended to prepend an origin or provider descriptor followed by the relevant identifier.

In some embodiments, the present ledger can identify coins generated by fiat money or other assets. An issuingAsset 844 reflects the asset that was used in exchange to issue the group of coins or the originally minted group. An issuingValue 846 is comparable to backing Value 838, and issuingCurrency 848 is comparable to backingCurrency 840, but issuing parameters 844 and 846 are associated with the asset being issued, while 838 and 84

Continuing to FIG. 8C, more attributes of coins are discussed. The present ledger enables the display of the reason why coins were frozen or unfrozen. In some embodiments, a freezeReason 862 may be used to reflect the freeze or unfreeze reason. In the example of FIG. 8C, since the status is active (e.g., in 864), a freeze reason would be needed. The status 864 represents various classifications of a coin's current state. The present ledger also allows the reason why coins were burned to be presented, as shown in burnReason 866. A burning reason would be needed when the status in 864 is active.

The custom-related attributes are shown in 868, 870, 872, and 874. The present ledger is configured to identify different initiatives and/or campaigns by supporting custom aggregation and/or discrimination attributes. For example, any of custom attributes 868 through 874 can serve as a free text custom field, to aggregate or discriminate a group of coins. For example, the value of custom attribute 868 can be set to a hypothetical “Send Coins campaign.” This would be useful to group or classify coins and transactions motivated by that specific campaign, or even help audit minting or burning activities. It should be noted that the present ledger is unlikely to require more than four aggregators or discriminators before taking action to add extra custom attributes. The configuration of this number typically relies on its intended purpose.

FIG. 8D shows a current state 882 and a model 884. As depicted, model 884 may include a coins model 886, a coins_history model 888, a coins_blacklist model 890, and a coins_blacklist_historiy model 892. The present ledger can adopt optimizations for performance (e.g., sharing, partitioning). State 882 reflects the current state of the entry, which can be used in combination with coins_history model 888, for example, when a specific smart contract does not function optimally with partitioning. Aurora is implemented as a smart contract on certain blockchains. The present ledger also allows restrictions at a coin transaction level, or even at an account/owner level.

In this example, each of coins_history model 888 and coins_blacklist_historiy model 892 has a full replica of another model, as indicated by arrow 894. However, it should be noted, in some embodiments, this type of replication may not be needed based on explicitly using MySQL partitioning capability by one or more fields (e.g., “state”) if such an operation is fully compliant with other components (e.g., Aurora).

### Ledger Operations

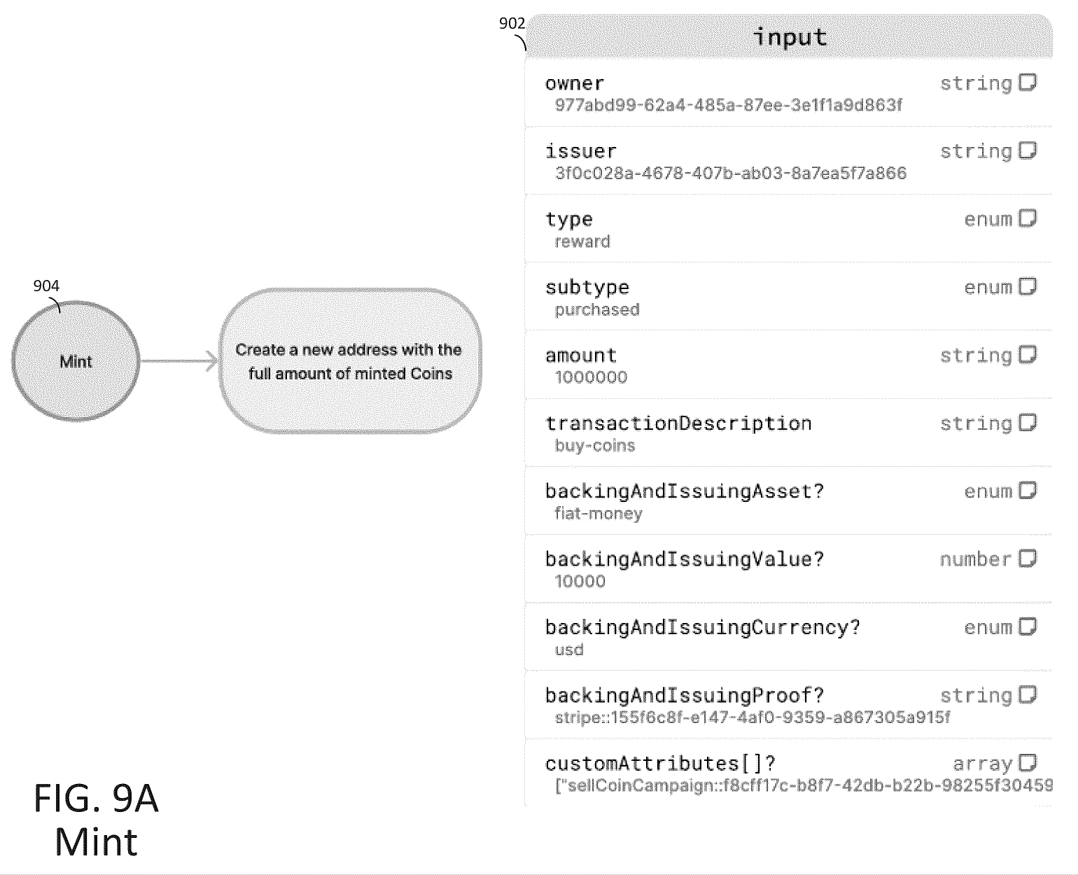

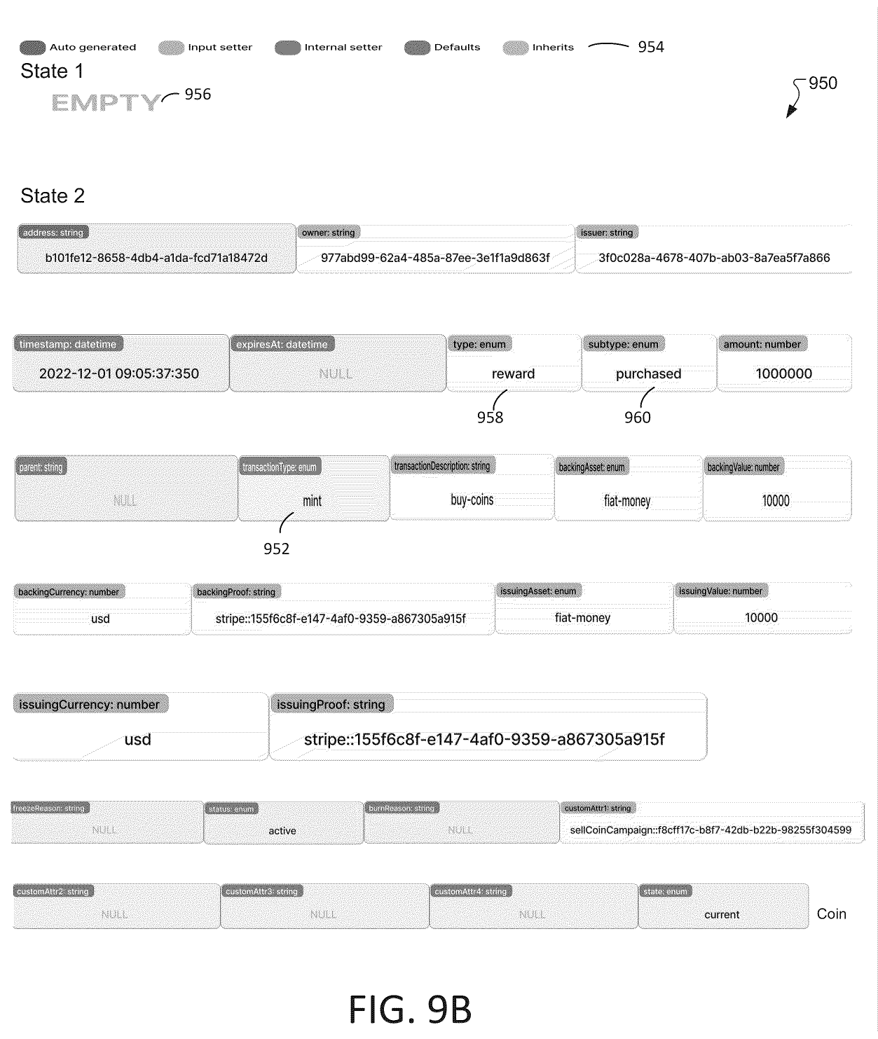

FIGS. 9A and 9B illustrate an exemplary use case of a minting process/operation. Minting is a process where new blocks are created through the authentication of information, and then the new blocks are recorded on a ledger. In some embodiments, a mint operation includes creating new coins within the present ledger, typically in response to specific events (e.g., purchases or rewards earned). In the example case of FIGS. 9A and 9B, through a minting operation, “Reward Coins” from “Ultimate Coffee Shop” are issued to “John P.” for his $100 coin purchase. In another example, “Reward Coins” from a security monitoring agent/node (e.g., firewall) can be issued to a detection node (e.g., an AI-based intrusion detection system) when it successfully identifies a security threat, where the amount of coins is determined based on the severity and accuracy of detection. The present ledger is designed to mint new coins without any amount limitation.

FIG. 9A shows input parameters 902 associated with a minting process/operation 904. When performing a mint operation, certain mandatory attributes must be provided to ensure the accurate representation of a newly created coin. In the illustrated embodiment, the input parameters 902 may include owner, issuer, type, subtype, amount, transactionDescription, backingAndIssuingAsset, backingAndIssuing Value, backingAndIssuingCurrency, and backingAndIssuingProof, and optional custom attributes.

An owner attribute is a unique identifier assigned to the owner of the newly created coins. An issuer attribute is a unique identifier assigned to the entity responsible for issuing the coins. A type attribute specifies the category or type of the coins being minted (e.g., reward). A subtype attribute further categorizes the coins based on their specific characteristics (e.g., purchased). An amount attribute indicates the quantity or amount of coins being minted. A transactionDescription attribute provides a description or identifier for the transaction associated with the mint operation (e.g., buy-coins). A backingAndIssuingAsset attribute identifies the asset used for backing and issuing the new coins (e.g., fiat money). A backingAndIssuing Value attribute specifies the value or amount of the backing asset associated with the minted coins. A backingAndIssuingCurrency attribute denotes the currency of the backing and issuing asset (e.g., USD). A backingAndIssuingProof attribute offers proof or verification of the backing and issuing process, often in the form of concatenated information (e.g., concatenating “stripe::” with the stripe transaction identifier).

In addition to the mandatory attributes, the mint operation may also include optional attributes to provide further details or customization, i.e., custom attributes, which allows for the inclusion of additional attributes or metadata for future aggregation or specific purposes.

FIG. 9B shows state samples 950. For example, transactionType 952 shows this is minting. However, as described above, purely numeric representations (e.g., addresses) instead of names are used to protect privacy and security. A new address may have some attributes defined according to samples, for example, auto-generated, input setter, internal setter, defaults, and inherits, as shown in row 954 of FIG. 9B.

To meet the requirements of the present platform, e.g., digital wallet functionality of supporting multiple entities (e.g., merchants) and multiple coin types, the ledger is designed to have neither an initial supply of coins nor a maximum supply for each coin. For example, initially state 1 is empty in 956 with no coin creation. Once coins are created, the updated state 2 includes some key attributes, e.g., the created coins are reward and purchased coins as shown in 958 and 960. The present ledger allows restrictions at the coin transaction level or on the account/owner level. The ledger may also differentiate the actions performed to lead to a new entry. For example, during a transform operation, if an expiration date is modified, the present ledge will include an action discriminator such as “extended-expiration.” In some embodiments, the minting process conducts validation by examining if there is a match on a “coins_blacklist” based on mapping attributes/fields (e.g., owner, issuer, etc.).

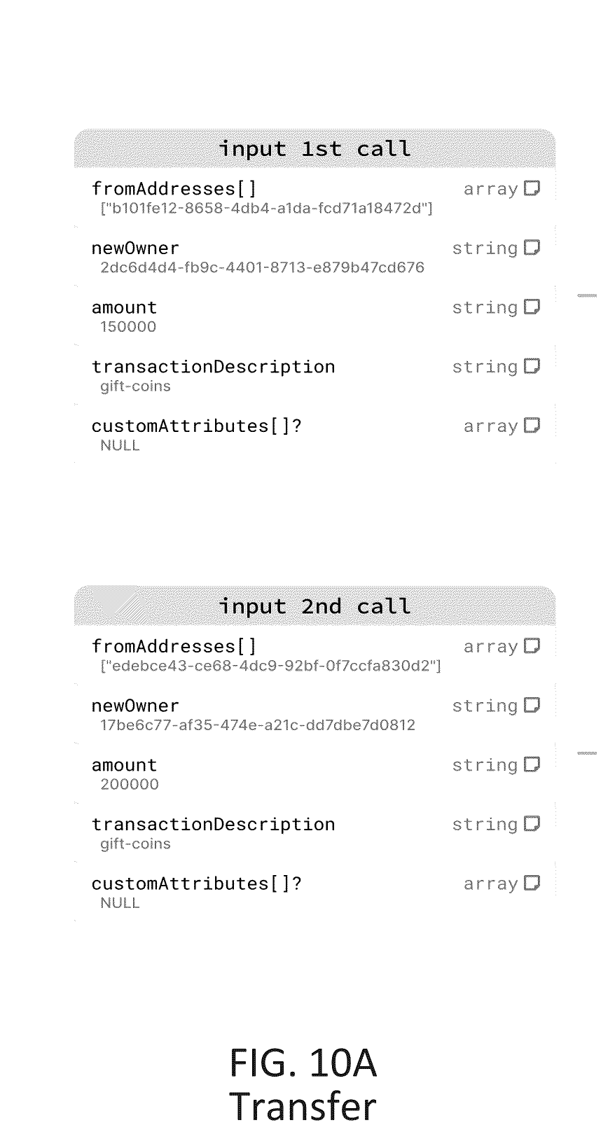

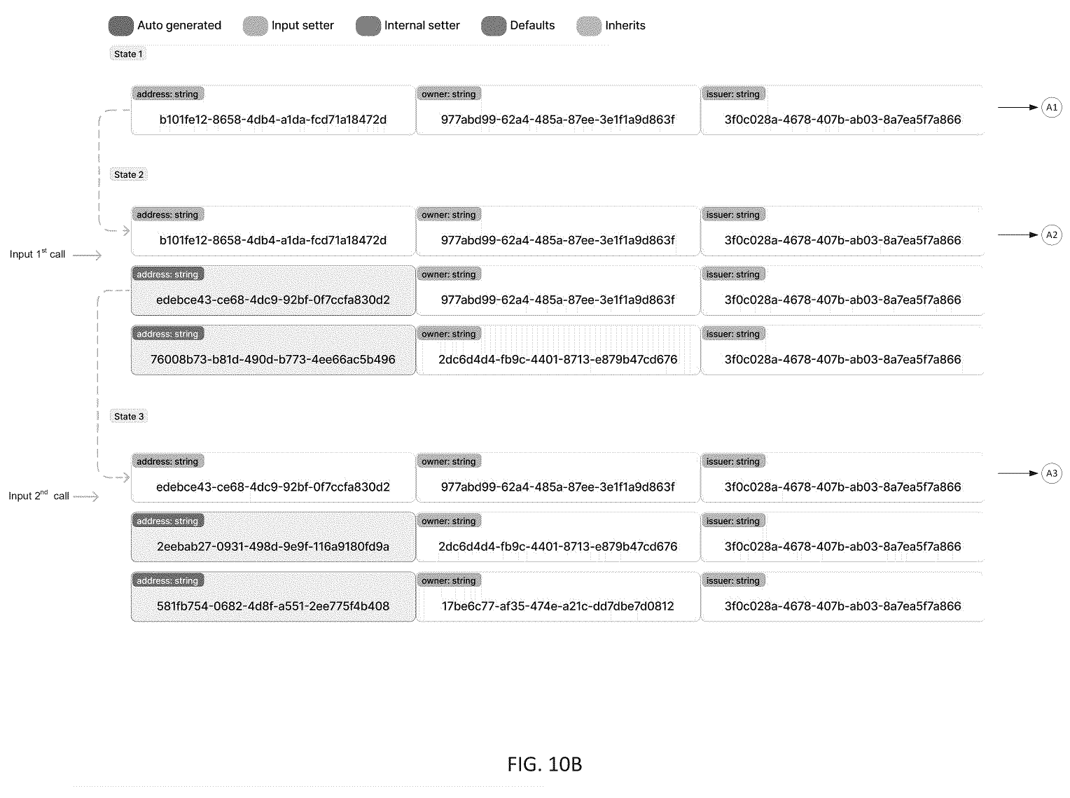

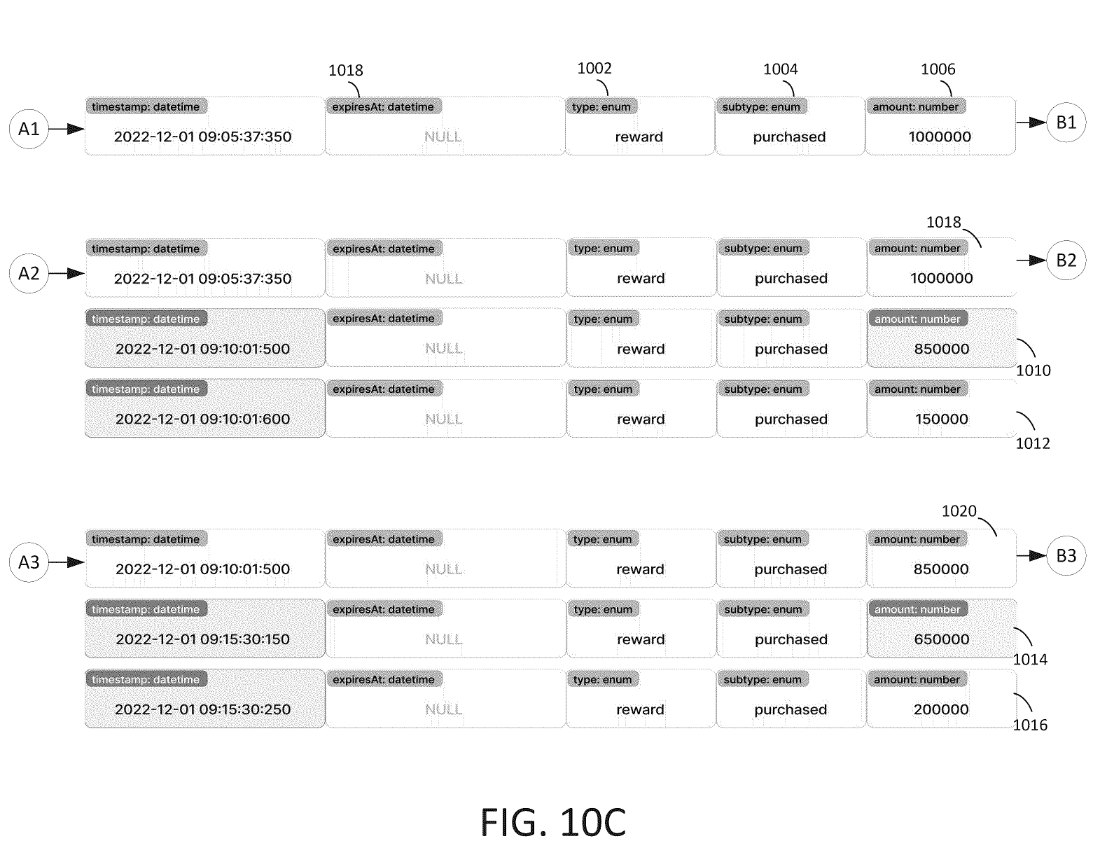

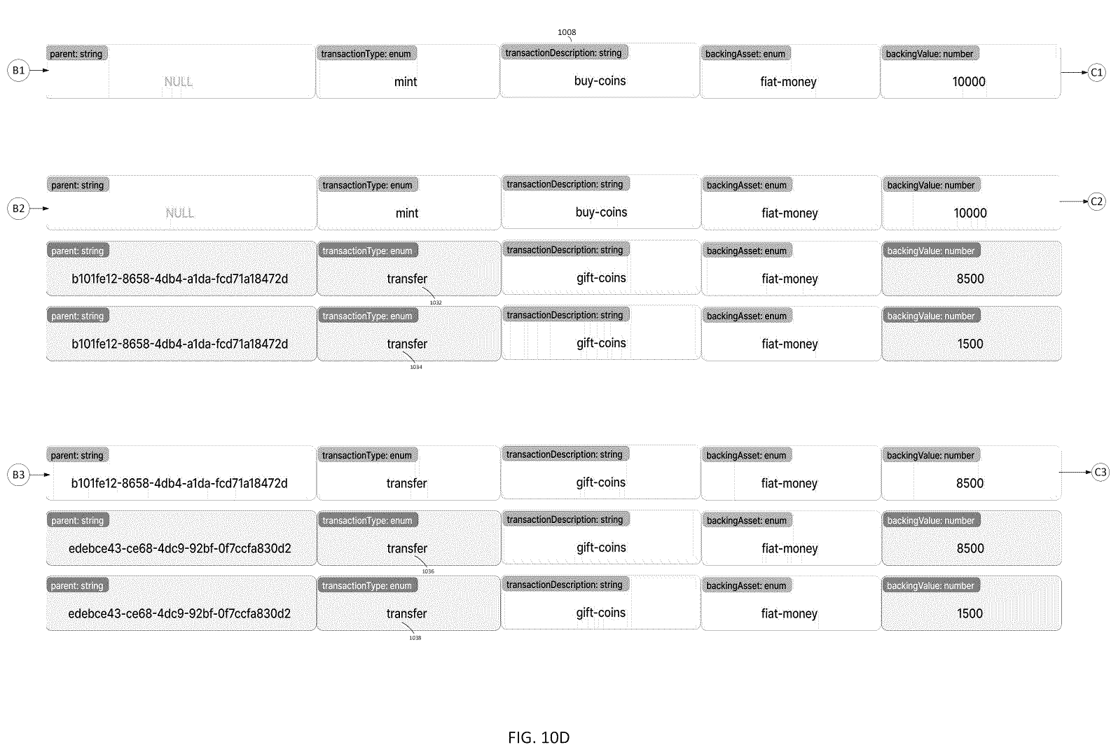

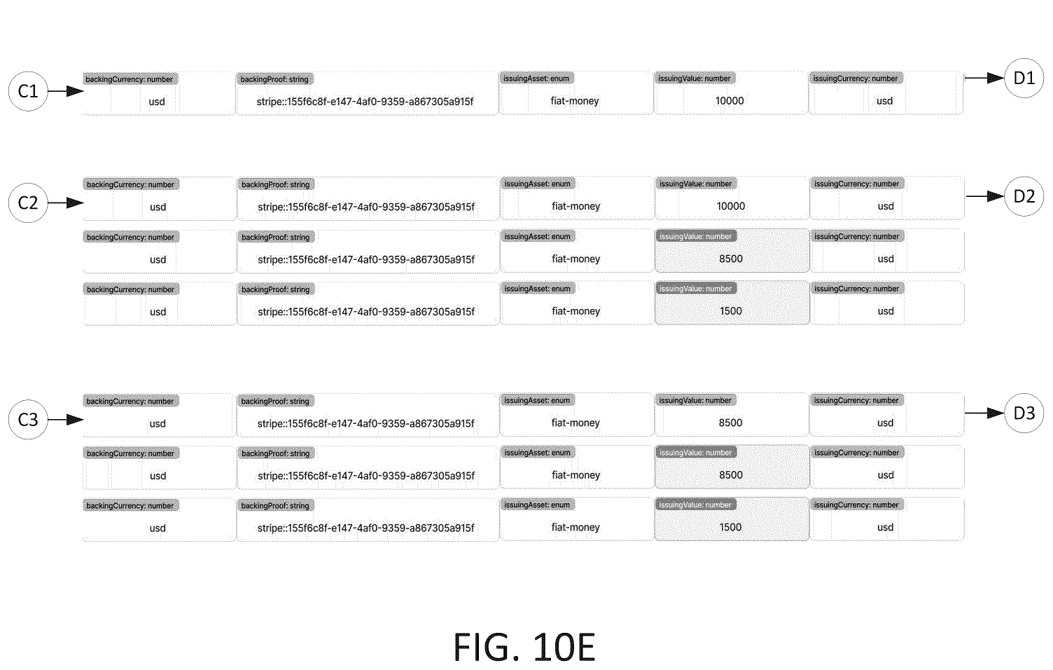

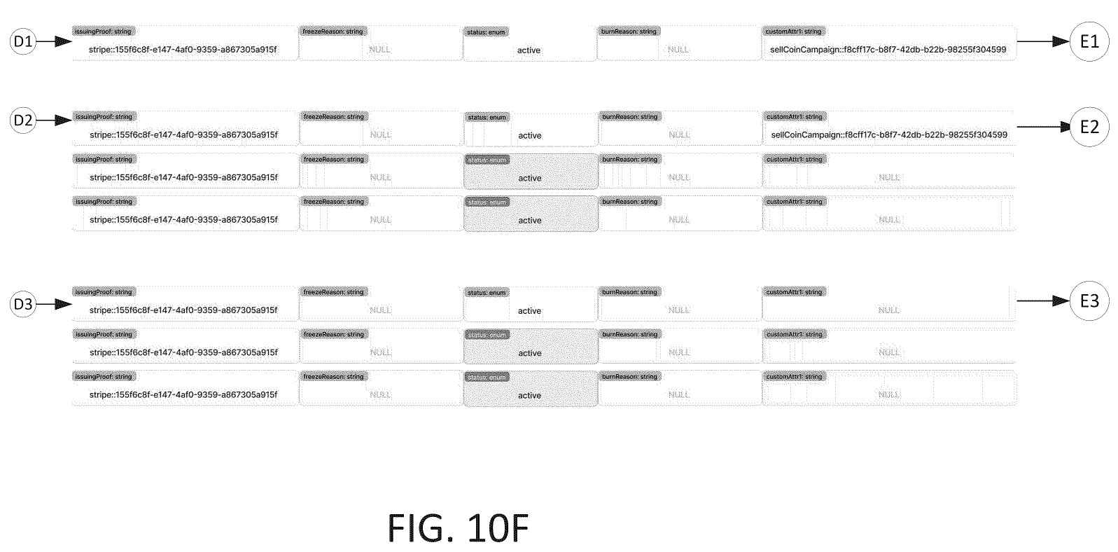

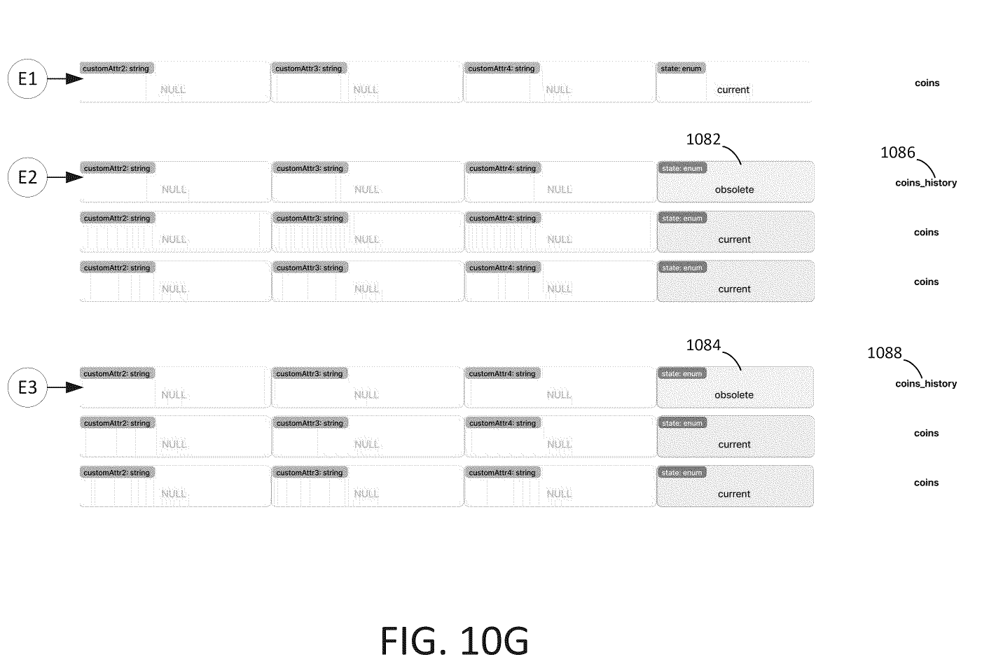

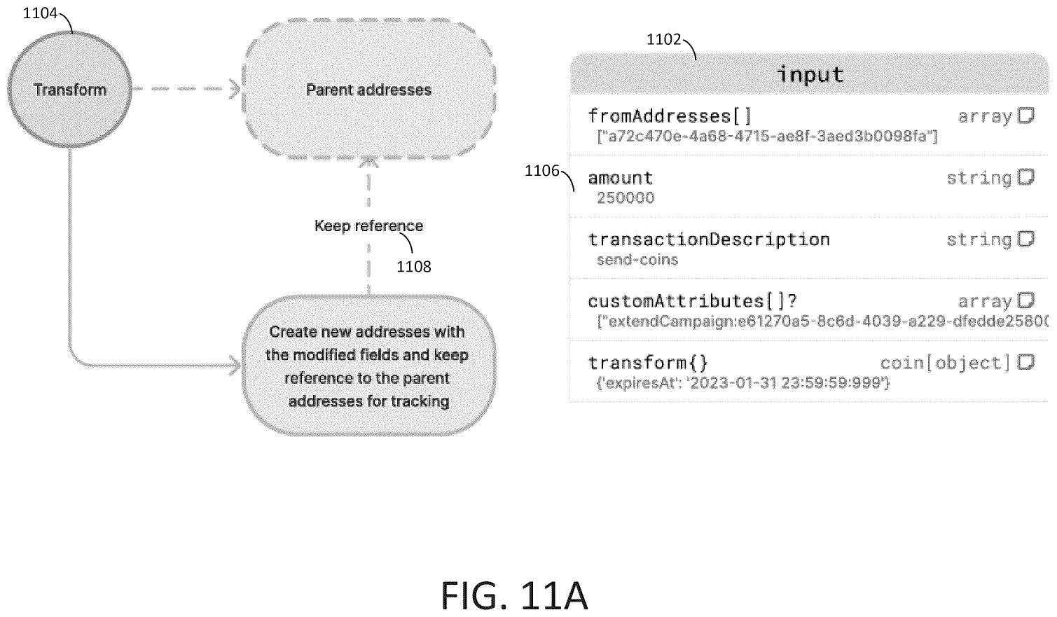

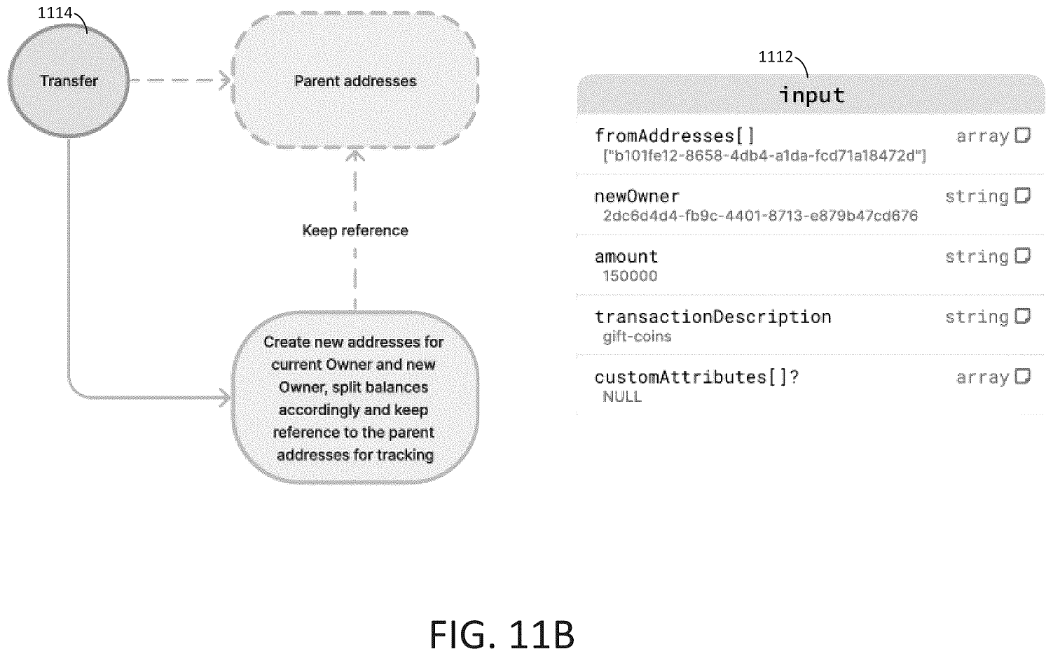

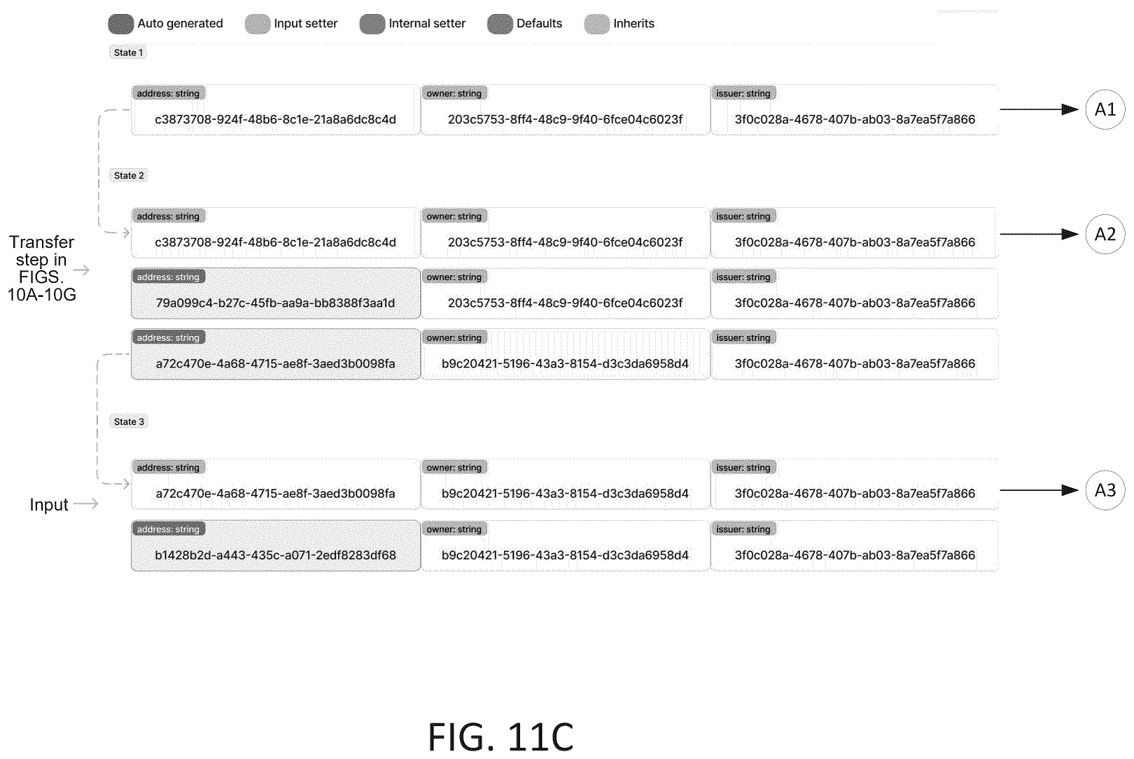

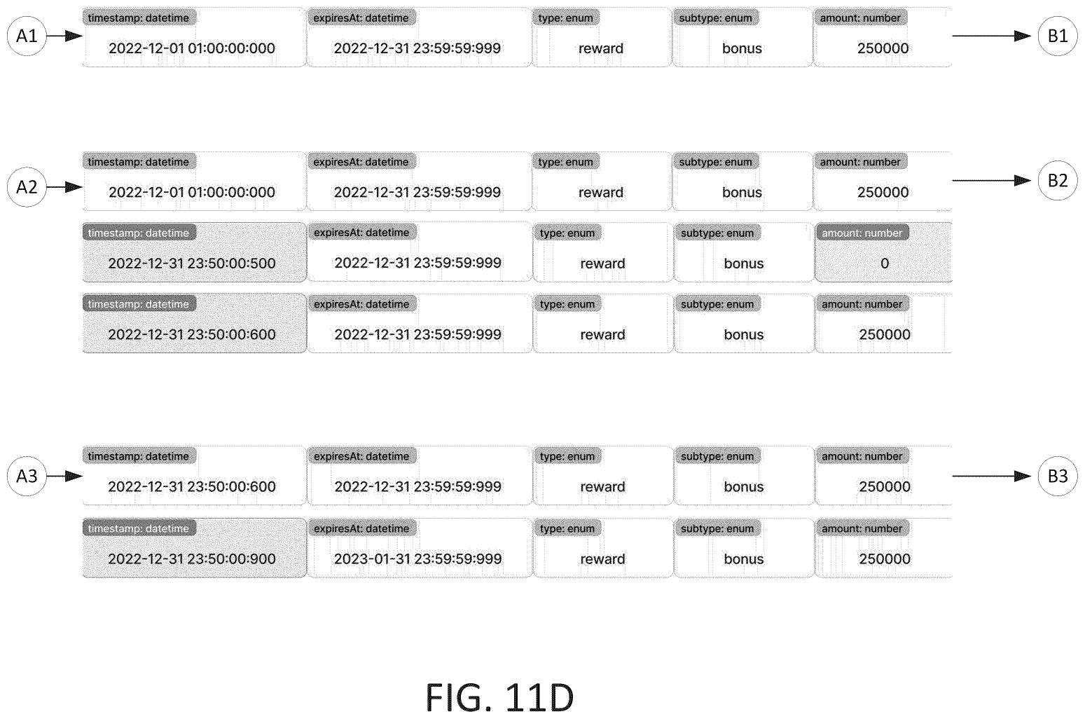

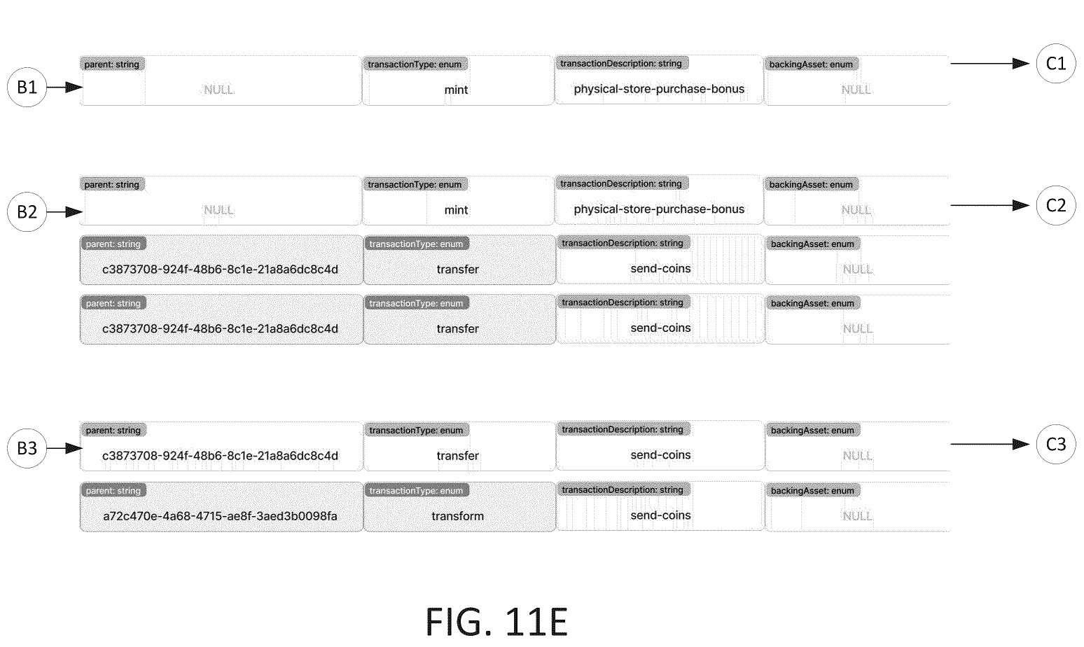

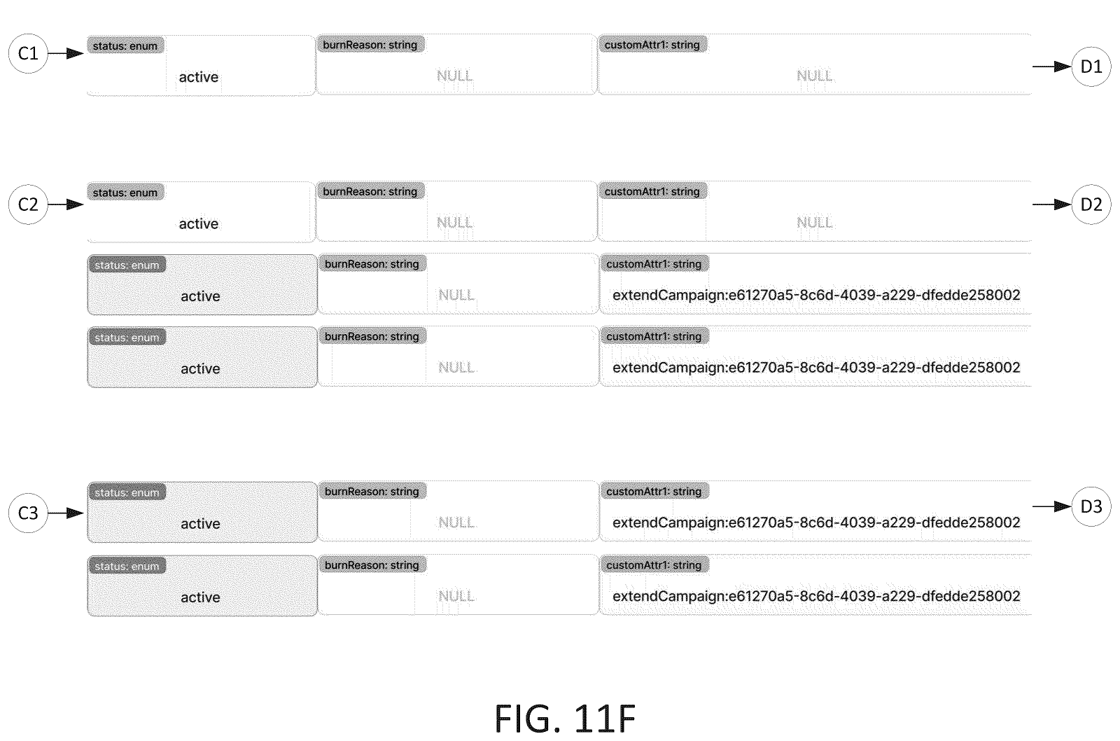

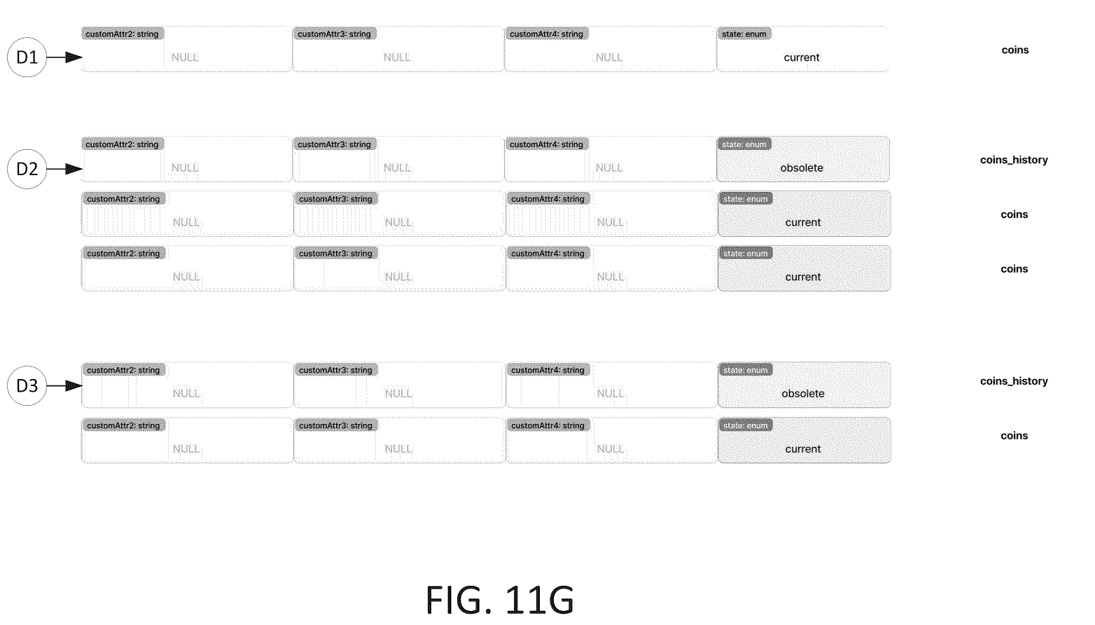

FIGS. 10A-10G illustrate an exemplary use case of transfer operation. In this example, through a transfer process, “John P.” bought 100 “Reward Coins” from “Ultimate Coffee Shop” and gifted his two friends with the coins, at separate moments. The first friend “David S.” receives 15 coins, and the second friend “Katrina G.” receives 20 coins. FIG. 10A shows two inputs to the two transfer calls, where the first input in the first call facilitates the transfer of 15 coins to the first friend, and the second input in the second call is for transferring 20 coins to the second friend. The present ledger is configured to change the ownership of the coins based on the full or partial transfer. More details about transfer operations will be discussed below in FIGS. 11B-11G.

The state changes during the transfer operation are shown in the state samples of FIGS. 10B-10G. As depicted in FIG. 10B, responsive to receiving the first input, 15 coins are transferred to the first friend as indicated by state changes from state 1 to state 2. Responsive to receiving the second input, 20 coins are transferred to the second friend as indicated by state changes from state 2 to state 3. Here, state 1 shows the attributes of 100 reward coins bought by John. P, for example, as shown below in “reward” type 1002, “purchased” subtype 1004, “1000000” amount 1006 of FIG. 10C, and “buy-coins” transactionDescription 1008 of FIG. 10D. Using the four decimal precision, the amount value 1000000 is equivalent to 100.0000, i.e., 100 coins. State 2 indicates that 15 coins are transferred out because, for example, the amount of coins is separated to 850000 (i.e., 85 coins) in 1010 and 150000 (i.e., 15 coins) in 1012 upon the first input for transferring 15 coins to the first friend, as shown in FIG. 10C. State 3 indicates that 20 coins are transferred out because, for example, the amount of the remaining 850000 is separated to 650000 (i.e., 65 coins) in 1014 and 200000 (i.e., 20 coins) in 1016 upon the second input for transferring 20 coins to the second friend, as shown in FIG. 10C.

As to other functional and related capabilities, the present ledger allows restrictions at both a coin transaction level and an account/owner level. The ledger is designed to maintain auditability by preventing the deletion or direct modification of entries. In some embodiments, instead of updating an existing entry, the ledger may generate one or more new entries reflecting the result of a coin operation result. For example, in FIG. 10C, new entries corresponding to 1010 and 1012 result from the transfer operation of 100 coins in 1006 (also referred to as 1018), while new entries corresponding to 1014 and 1016 result from the transfer operation of 85 coins in 1010 (also referred to as 1020). FIG. 10D specifically shows these new entries corresponding are resulted from “transfer” operations 1032, 1034, 1036, and 1038. FIGS. 10D, 10E, and 10F further include parameters of backing asset, issuing asset, and other statuses associated with the coin transfer operations. For example, there is no reason for freezing or burning the coins as shown in FIG. 10F, indicating that the coins can be transferred.

The ledger may adopt optimizations such as sharding or partitioning to enhance performance. On state change, the ledger may remove obsolete entries from “coins” and add them to “coins_history.” However, in the case where Aurora with partitioning capability is applied, this action may not be necessary (as discussed above in FIG. 8D). Continuing with the above example, given the 100 coins in 1018 and 85 coins in 1020 in FIG. 10C are transferred out, in FIG. 10G, the corresponding entries in 1082 and 1084 are marked as obsolete, and these entries are moved to “coin_history” as shown in 1086 and 1088. The ledger may also discriminate the actions performed that lead to a new entry. For example, if an expiration date is modified during a transformation operation, the ledge will record an action discriminator like “extended-expiration.” Furthermore, the ledger can keep all coin's attributes unchanged after any operation unless explicitly configured by a transform, for example, an expiration date will not change without an explicit setting.

For validation in a transfer operation, the ledger may examine if there is a match on a “coins_blacklist.” A match may be based on mapping attributes/fields including the owner, issuer, type, subtype, etc. The precedence order is taken based on the specificity of a match. The more the fields are matched, the larger the probability there is a match. The ledger also determines if there is enough balance amount to make a transfer. For example, the ledger may check the sum amount of “fromAddresses.” These addresses should not be in an “obsolete” state or a non-active state.

The ledger creates a new address for each address from which an amount is decremented. In some embodiments, the precedence order is based on the array order of the “fromAddresses” input. As shown in FIG. 10B, a new address might have some attributes of the parent entry modified, following on samples. For example, these attributes can be auto-generated cases, input setter cases, internal setter cases, default cases, and inherit cases. Additionally, the present ledger verifies if “expiresAt” (e.g., 1018 in FIG. 10C) from a current address is not null and is older than the current date. In some embodiments, the ledger only asserts if the expiration date is modified by the transformation. The ledger further does not allow actions on burned coins or frozen coins, except in cases where a burned coin is being frozen.

FIGS. 11A-11G illustrate an exemplary use case of transfer and transform operations. In this example, “Steve O.” has received 25 “Reward Coins” as a bonus from “Ultimate Coffee Shop.” The coins are about to expire. Steve opted to send all the coins to his coworker “Natasha C.” because there is a “hypothetical campaign” statement: “Send your expiring coins to friends and let them have up to one month to redeem.” Steve's transaction can be accomplished through transfer and transform operations. For example, the amount 250000 in 1106 of FIG. 11A is the coin amount (e.g., 25 coins in four decimal precision) to be handled. The present ledger can update attributes on coins by transforming the old entry to a new entry (e.g., full or partial). In other words, the transform operation can change the nature of some attributes of the coins.

FIG. 11A shows input parameters 1102 associated with a transform operation 1104. A transform operation 1104 within the present ledger is important for making modifications to existing records without directly updating their records. The transform operation 1104 adheres to the principle of immutable ledger entries, ensuring that entries (once registered) remain unchanged indefinitely. This operation is utilized when alterations to address properties are required, providing a mechanism for seamless transformation while preserving the integrity of historical data.

In some embodiments, transform operation 1104 uses a set of input parameters 1102 including one or more of attributes fromAddresses, amount, transactionDescription, customAttributes, transform object, etc. A fromAddressses attribute specifies an array of addresses to be transformed, indicating the entities whose properties will be modified. Each address in the array represents a unique entity within the ledger. An amount attribute may determine the quantity of coins to be transformed. This attribute defines the volume of coins subject to modification within the specified addresses. A transactionDescription attribute represents an identifier associated with the transform operation, providing context for the modification (e.g. business-withdraw). Similar to the mint operation, the present system also provides custom attributes to augment transformation operation 1104. These attributes offer additional metadata for tracking and auditing purposes. Input parameters 1102 of transform operation 1104 further include a transform object, which introduces an additional input property that receives an object containing properties identical to those of an address. Within this object, new values are assigned to each attribute of the address object, facilitating targeted modifications, such as removing backing assets associated with coins.

In some embodiments, the transform operation (e.g., 1104) may employ a whitelist mechanism to restrict modifications to specific fields within an address. Certain attributes (e.g., owner, issuer, fingerprints) are protected from transformation for security reasons. In other words, a transform operation may alter the state of an entry such as expiration date or withdrawal but may not represent ownership or control changes, which is shown below in a transfer operation of FIG. 11B.

In a withdrawal scenario, a transform operation may uphold the ledger's immutability principle by creating new addresses with updated data instead of directly updating existing records. For example, if an entity withdraws backing assets from a specific address, the transform operation may create new addresses without the backing assets while retaining references (e.g., 1108) to the original, unmodified data. This approach ensures data integrity and traceability over time, aligning with the immutable nature of ledger entries.

FIG. 11B shows input parameters 1112 associated with a transform operation 1114. A transfer operation 1114 within the present ledger orchestrates the transition of coin ownership while maintaining a comprehensive record of transactions. This operation embodies the shift in ownership of coins from one entity to another within the ledger.

In some embodiments, transfer operation 1114 uses a set of input parameters 1112 including one or more of attributes fromAddresses, newOwner, amount, transactionDescription, and customAttributes. A fromAddresses attribute specifies an array of addresses representing the entities transferring the coins. Each address within the array corresponds to a unique entity in the ledger. A newOwner attribute identifies the unique identifier of the entity becoming the new owner of the coins within the specified addresses. An amount attribute indicates the quantity of coins being transferred. The sum of coins across all provided addresses must match this specified amount. Any surplus coins in the fromAddresses remain under the previous owner's ownership. A transactionDescription attribute provides a unique descriptor associated with the transfer operation, facilitating tracking and auditability. CustomAttributes allow for the inclusion of additional metadata, aiding in future aggregation and specific identification purposes.

Transfer operation 1114 plays a pivotal role in the present ledger ecosystem. It not only facilitates ownership changes but also ensures the continuity and traceability of transactions. By generating new ledger entries and referencing parent addresses, transfer operation 1114 maintains an immutable record of ownership transitions. This robust tracking mechanism enables accurate auditing and historical analysis, bolstering transparency and accountability within the present ledger infrastructure.

In an example scenario (e.g., gift coins scenario), coins are transferred to a new owner after being purchased. This transfer operation 1114 ensures a seamless transition of ownership, with the ledger recording the transaction details for traceability and accountability.

The state changes during the transfer and transform operations are shown in the state samples of FIGS. 11C-11G. Since the transfer step has been discussed above in FIGS. 10A-10G, the description will not be repeated here. Also, since some attributes such as backing Value, backingCurrency, backingProof, etc., are not relevant in these operations (e.g., the values are “NULL”), these attributes are not included in FIGS. 11C-11G for clarification and simplification. To perform a transform operation, the present ledger needs to have a blacklist of transform input attributes such as an address, timestamp, parent, transactionType, status, state, amount, etc. These attributes should not be transformed.

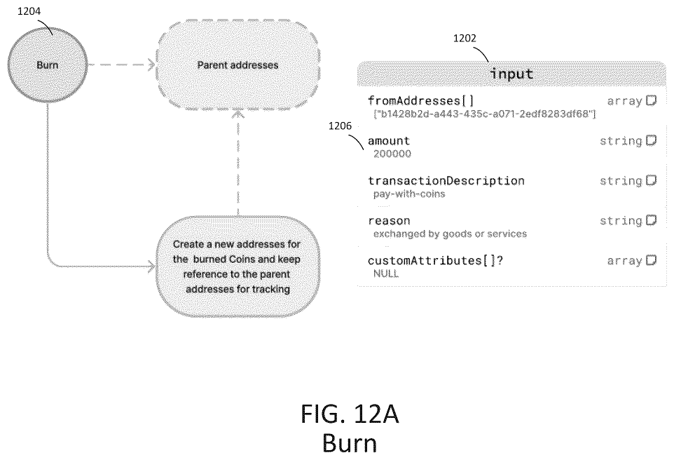

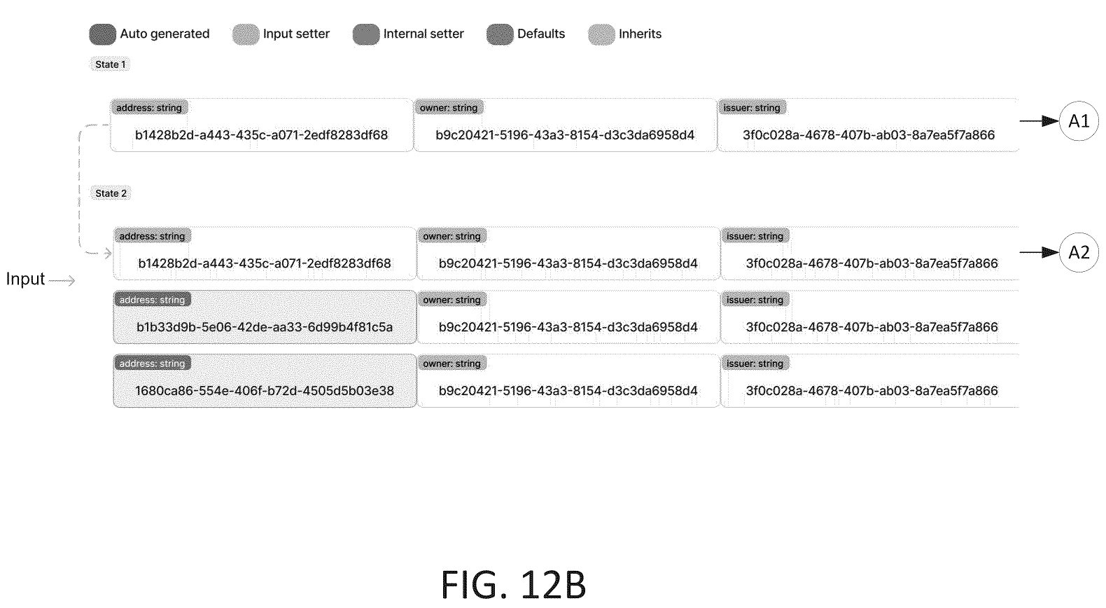

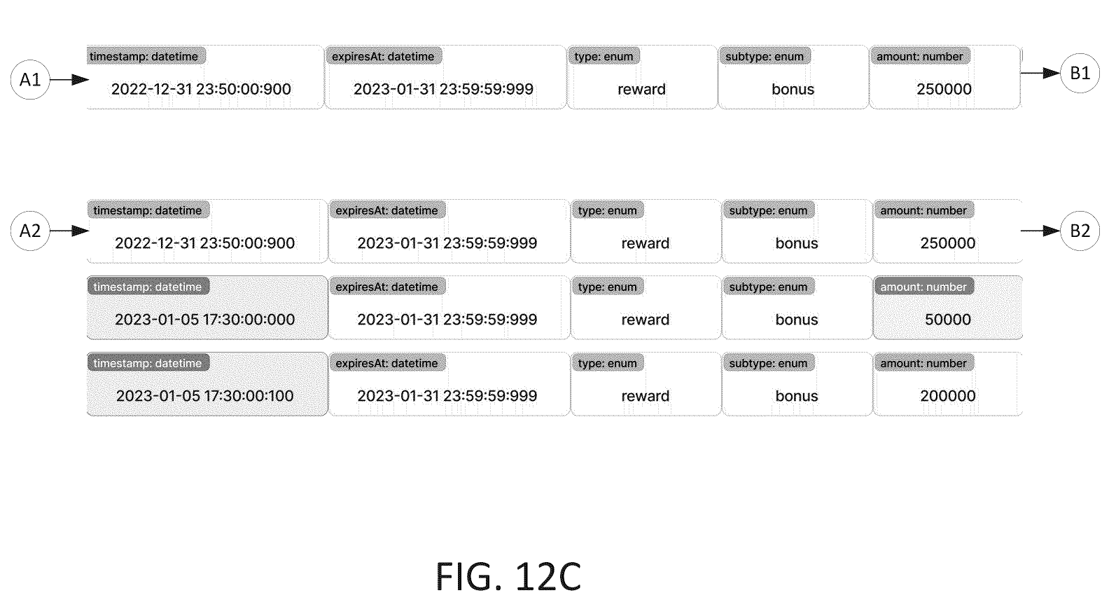

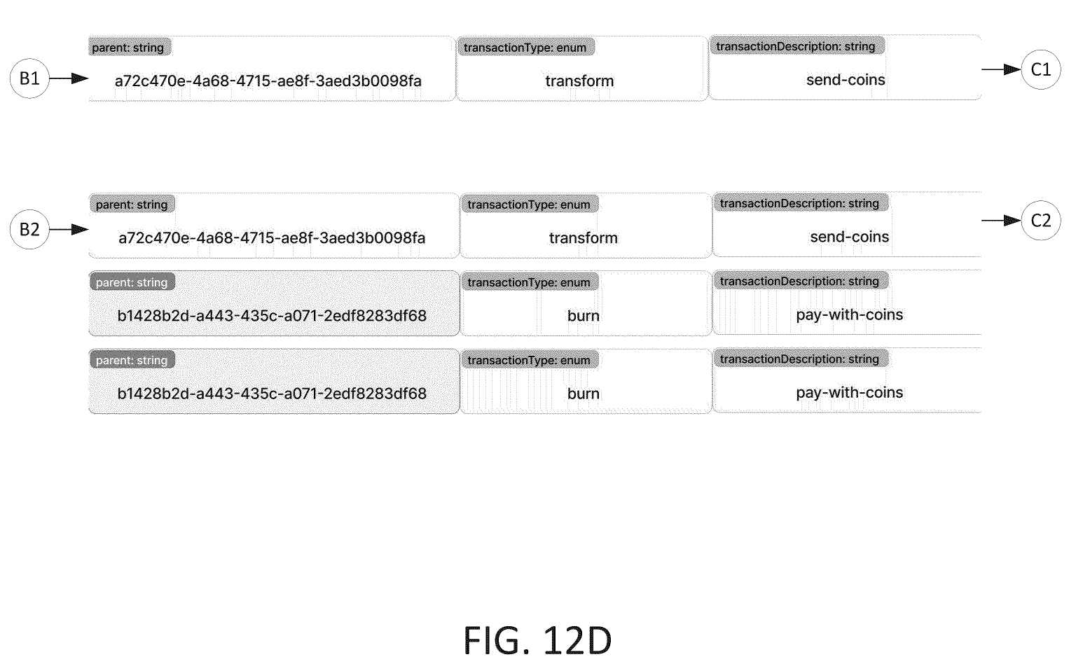

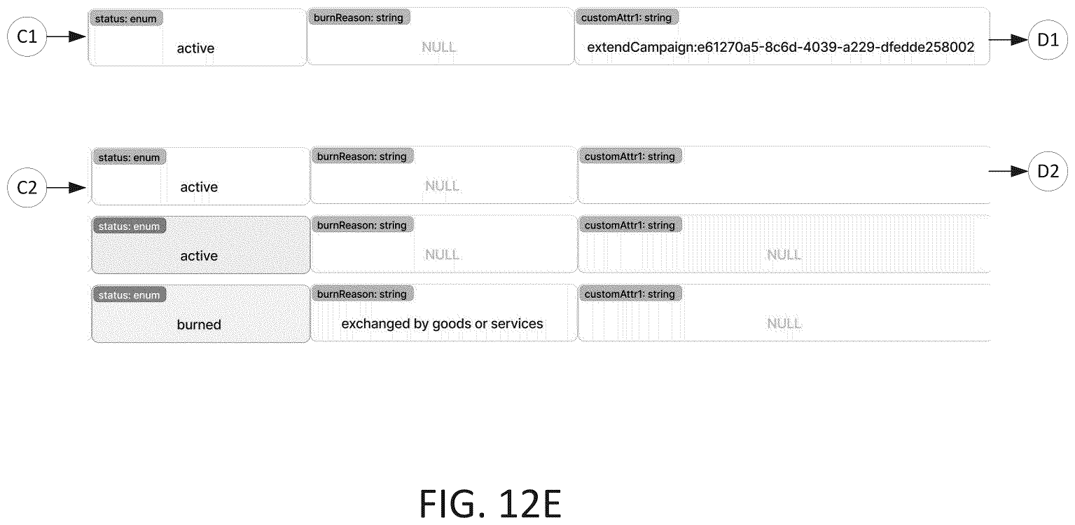

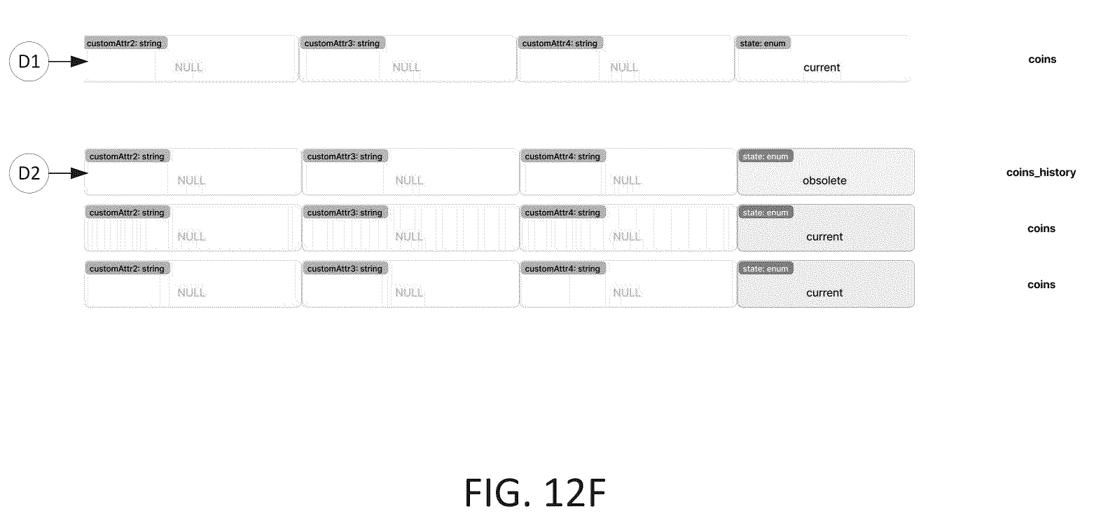

FIGS. 12A-12F illustrate an exemplary use case of burn operation. In this example, “Natasha C.” from the example in FIGS. 11A-11G (transfer+transform) is going to use or burn 20 “Reward Coins” on “Ultimate Coffee Shop” as indicated by the amount 200000 in 1206 of FIG. 12A (e.g., 20 coins in four decimal precision). The present ledger can burn coins, i.e., by removing the coins from the circulation supply full or partially, such that the coins cannot be reused. Every burn should have a reason.

FIG. 12A shows input parameters 1202 associated with a burn operation 1204. A burn operation 1204 within the ledger serves to permanently remove coins from circulation. It follows a similar structure to other ledger operations, requiring specific input data to execute effectively. In some embodiments, the input parameters include one or more attributes fromaddresses, amount, transactionDescription, reason, and customAttributes.

A fromAddresses attribute specifies an array of addresses to be burned, representing the entities whose coins will be permanently removed. An amount attribute indicates the total quantity of coins to be burned. A transactionDescription attribute provides a unique identifier for burn transaction 1204, aiding in tracking and audit purposes (e.g., “pay-with-coins”). A reason is a mandatory field that explains the purpose of burn operation 1204, ensuring transparency and accountability. Custom attributes are additional metadata that can be included for specific identification or tracking needs.

As to the operational significance, burn operation 1204 represents the conclusion of a coin's lifecycle within the ledger system. Similar to other operations (e.g., freeze, unfreeze), burn operation 1204 does not delete any existing information from the ledger. Instead, it generates new entries or addresses while maintaining references to the parent addresses of the coins being burned. This approach ensures a comprehensive audit trail and historical record within the ledger, allowing for accurate tracking of coin transactions over time.

It should be noted that once coins are burned, these coins cannot be reintroduced into circulation. This irreversible nature underscores the finality of burn operation 1204 and emphasizes the importance of careful consideration before initiating such actions. By permanently altering the state of coins within the ledger, burn operation 1204 contributes to the overall integrity and reliability of the ledger system, ensuring that transactions are recorded accurately and securely.

The state changes during the burn operation are shown in the state samples of FIGS. 12B-12F. For similar reasons shown in FIGS. 11A-11G, some attributes are also skipped herein. The present ledger allows restrictions at the coin transaction level or account/owner level. The ledger is designed not to delete or update an entry (e.g., to enable audit). In some embodiments, the present ledger may generate one or more new entries to reflect a coin operation result instead of updating or modifying existing entries. The ledger adopts optimizations for performance including sharding or partitioning. On state change, the ledger may remove obsolete entries from “coins” and add them to “coins_history.” As discussed above, in the case of Aurora with partitioning capability, this action may not be necessary. The ledger may also discriminate the actions performed to result in a new entry. For example, with a transform operation, if expiration was modified, the ledge will include an action discriminator like “extended-expiration.” The present ledger can keep all coin's attributes unchanged after any operation unless explicitly configured by a transform, for example, an expiration date will not change without an explicit setting.

For validation in a burn operation, the ledger may examine if there is a match on a “coins_blacklist.” A match may be based on mapping attributes/fields including the owner, issuer, type, subtype, etc. The precedence order is taken based on the specificity of a match. The more the fields are matched, the larger the probability there is a match. The ledger also determines if there is enough balance amount to make a transfer. For example, the ledger may check the sum amount of “fromAddresses” input. These addresses should not be in an “obsolete” state or a non-active state.

The ledger creates a new address for each address that will have the amount decremented. In some embodiments, the precedence order is based on the array order of “fromAddresses” input. For example, these attributes can be auto-generated cases, input setter cases, internal setter cases, default cases, and inherit cases. The ledger does not allow any actions on burned coins.

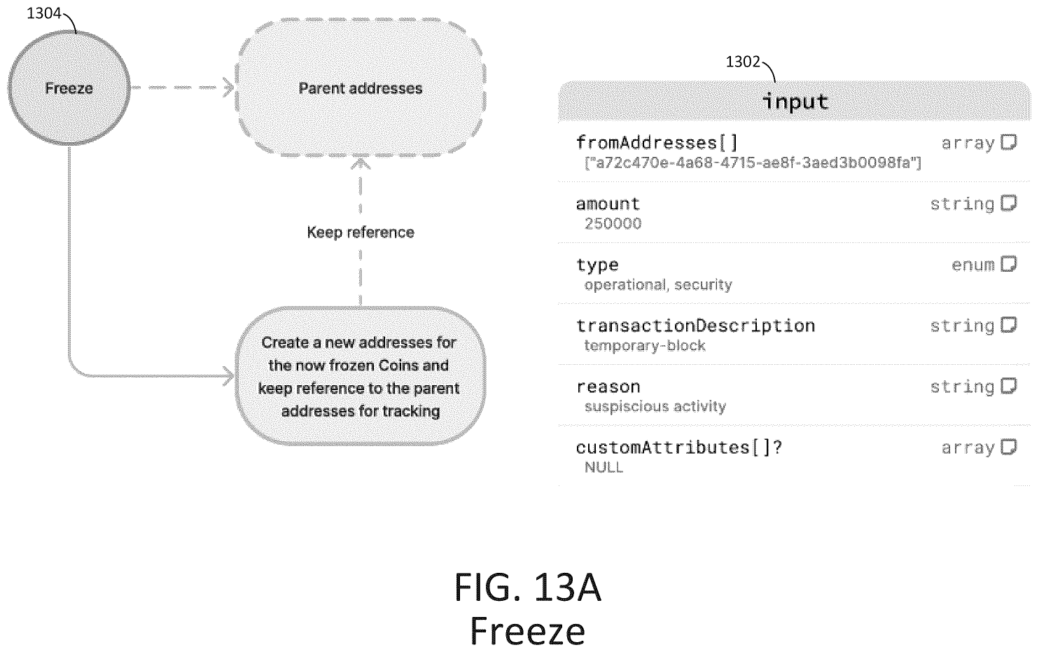

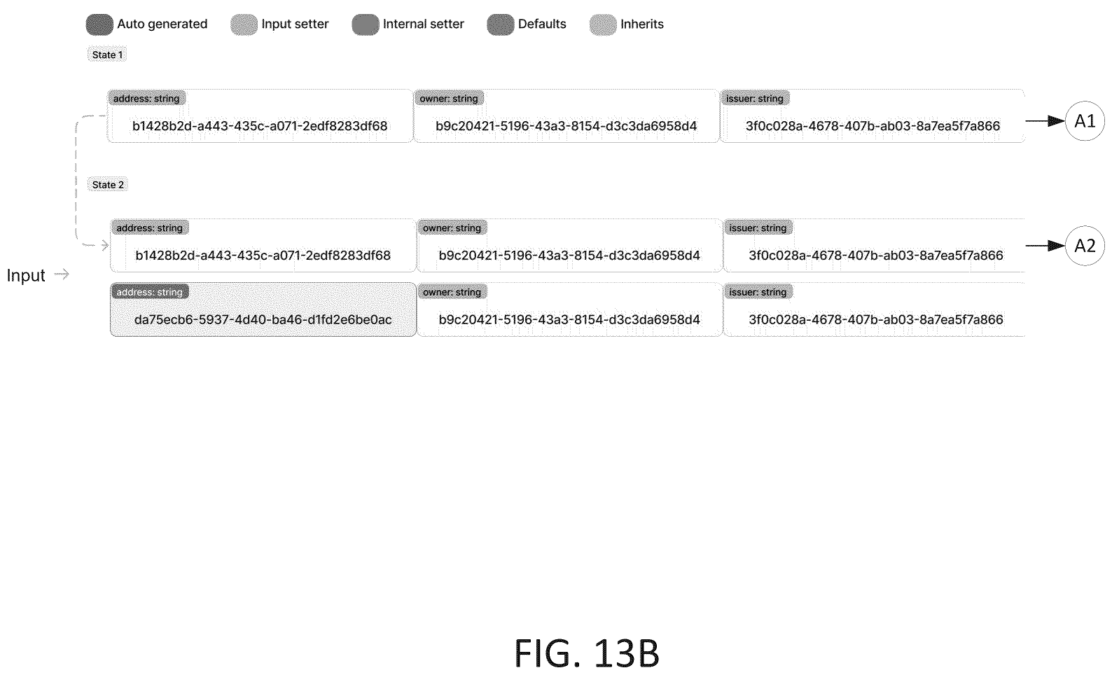

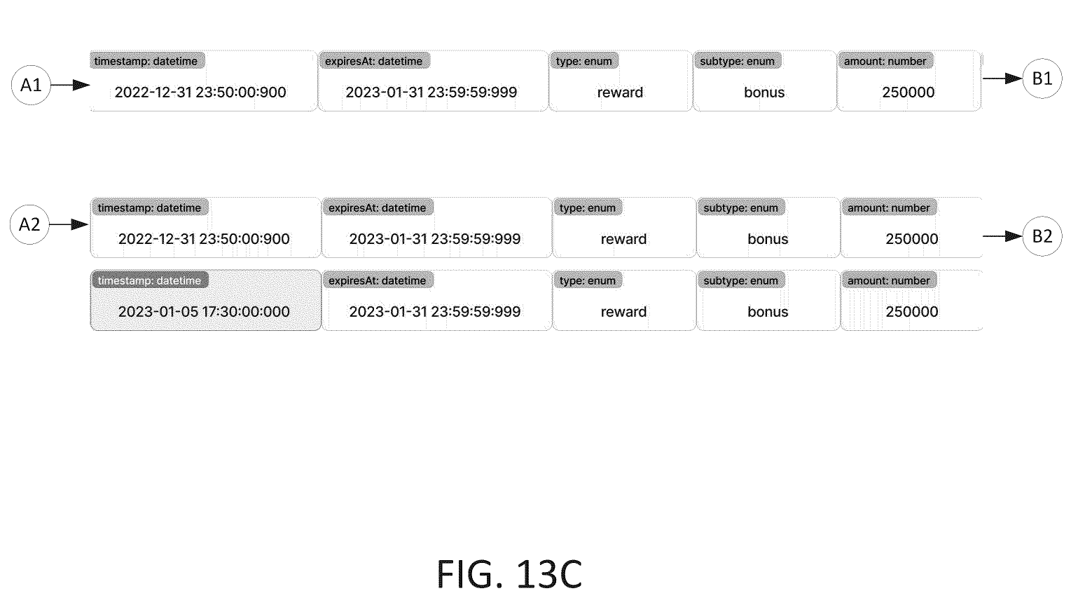

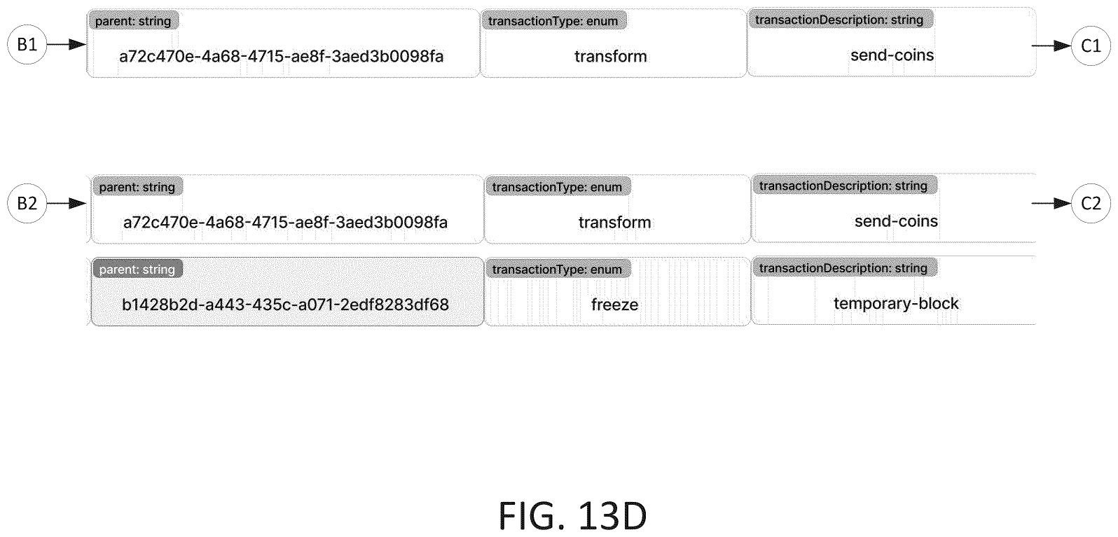

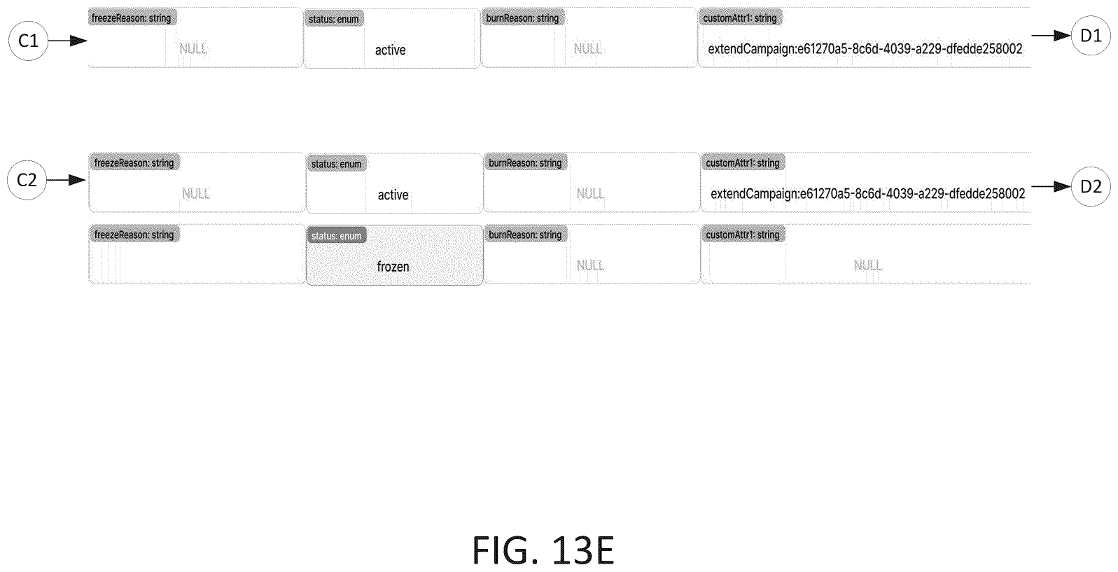

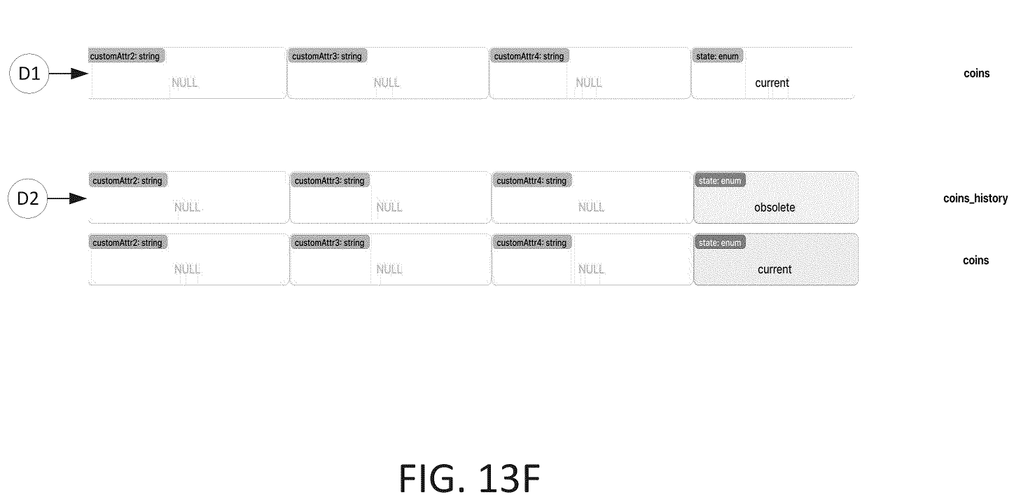

FIGS. 13A-13F illustrate an exemplary use case of freeze operation. In this example, “Natasha C.” from the example in FIGS. 11A-11G (transfer+transform) is going to have all her 25 “Reward Coins” on “Ultimate Coffee Shop” frozen due to suspicious activity.

FIG. 13A shows input parameters 1302 associated with a freeze operation 1304. Freeze operation 1304 within the present ledger serves dual purposes: operational and security. While operational freezes are common for fund reservation and transaction prevention, security freezes are reserved for specific activities (e.g., suspected fraud) with stricter criteria for thawing.

In some embodiments, freeze operation 1304 uses a set of input parameters 1302 including one or more of attributes fromAddresses, amount, type, transactionDescription, reason, and customAttributes. A fromAddresses attribute is an array representing the addresses from which coins will be frozen. Similar to previous operations (e.g., mint, transfer), each address corresponds to a unique entity within the ledger. An amount attribute specifies the quantity of coins to be unfrozen from the provided addresses. In some embodiments, the sum of coins across all addresses must equal or exceed the specified amount. Any surplus coins remain frozen. A transactionDescription attribute provides a unique descriptor for freeze operation 1304, aiding in tracking and auditability. A reason can be a mandatory attribute that explicates the rationale behind freeze operation 1304. Reasons could include fund reservation or suspicion of malicious activity, differentiating between operational and security freezes. Similar to previous operations, customAttributes allow for the insertion of unique identifiers relevant to freeze operation 1304.

In some embodiments, freeze operation 1304 can be performed in an operational and security context. Operational freezes primarily serve to reserve funds and manage transactions within the platform, ensuring smooth operation. Conversely, security freezes are triggered by specific events or suspicions, necessitating thorough justification and stringent criteria for unfreezing. Freeze operation 1304 does not delete any information but creates new addresses. Therefore, a reference to the previously unfrozen coins is maintained, ensuring a comprehensive audit trail and historical record within the present ledger system.

In an example scenario, where suspicious activity is detected, prompting a security freeze on certain addresses. The reason attribute can specify the nature of the suspicion, while custom attributes could include identifiers linking the freeze to the detected activity, facilitating subsequent investigation and resolution. Another example scenario is an operational freeze scenario, where funds may be reserved temporarily to facilitate upcoming transactions or ensure sufficient liquidity (e.g., sending coins to another user).

The state changes during a freeze operation are shown in the state samples of FIGS. 13B-13F. The present ledger can freeze coins for a reason. The freeze operation shares similar functionalities, related capabilities, and validations process as shown above in FIGS. 11A-11G and FIGS. 12A-12F. In addition, the present ledger can freeze and unfreeze coins, but cannot freeze the already frozen coins. The ledger does not allow actions on frozen coins, except by unfreeze or burn.

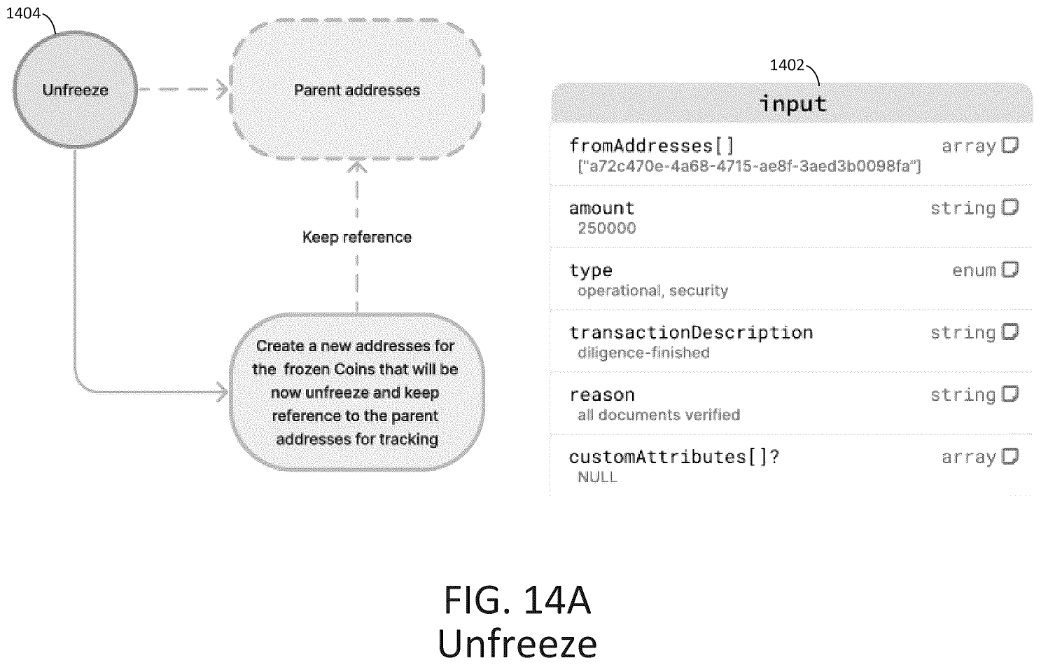

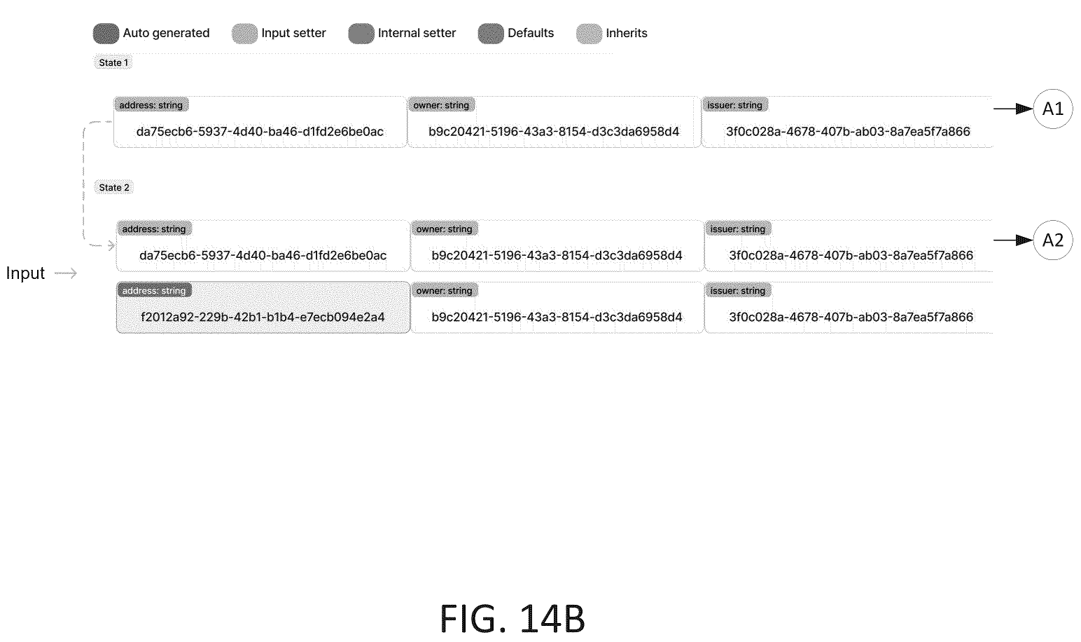

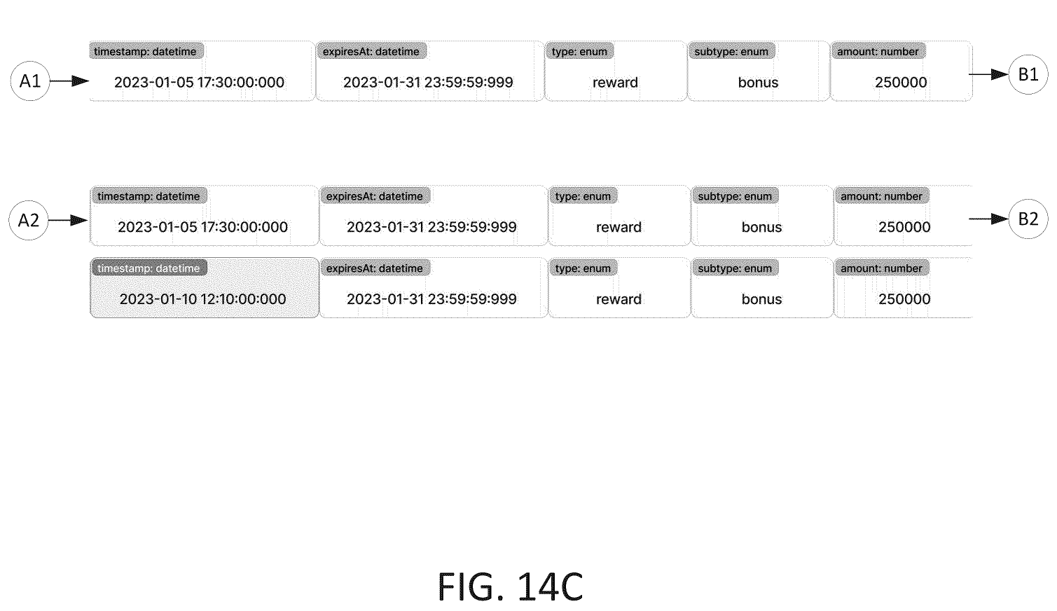

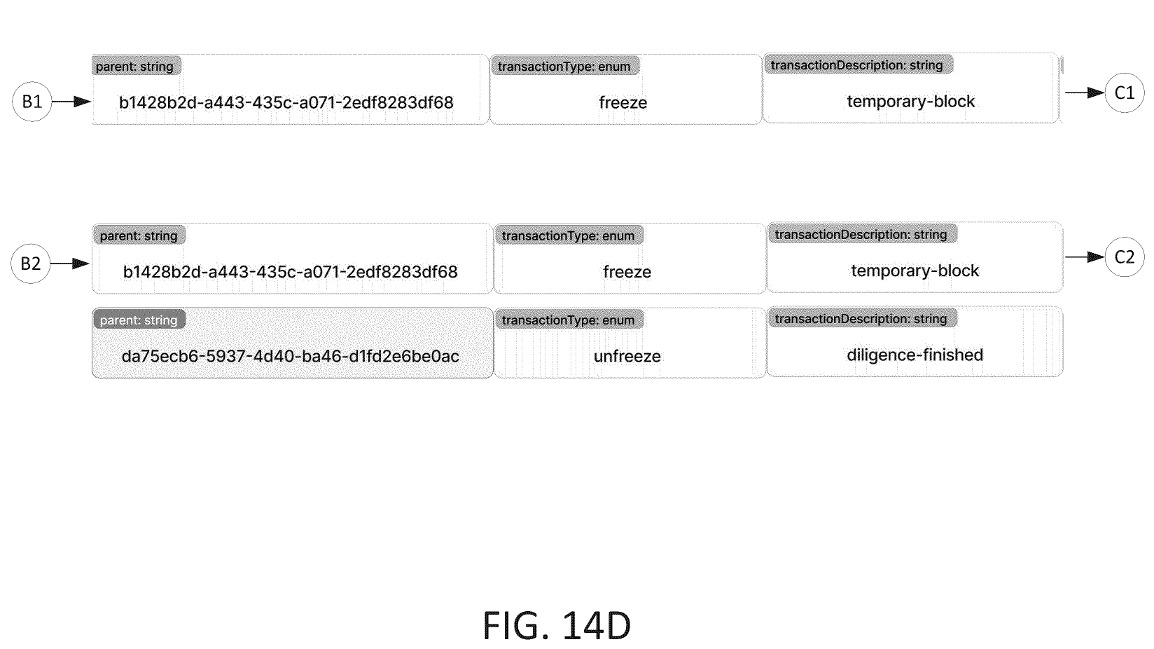

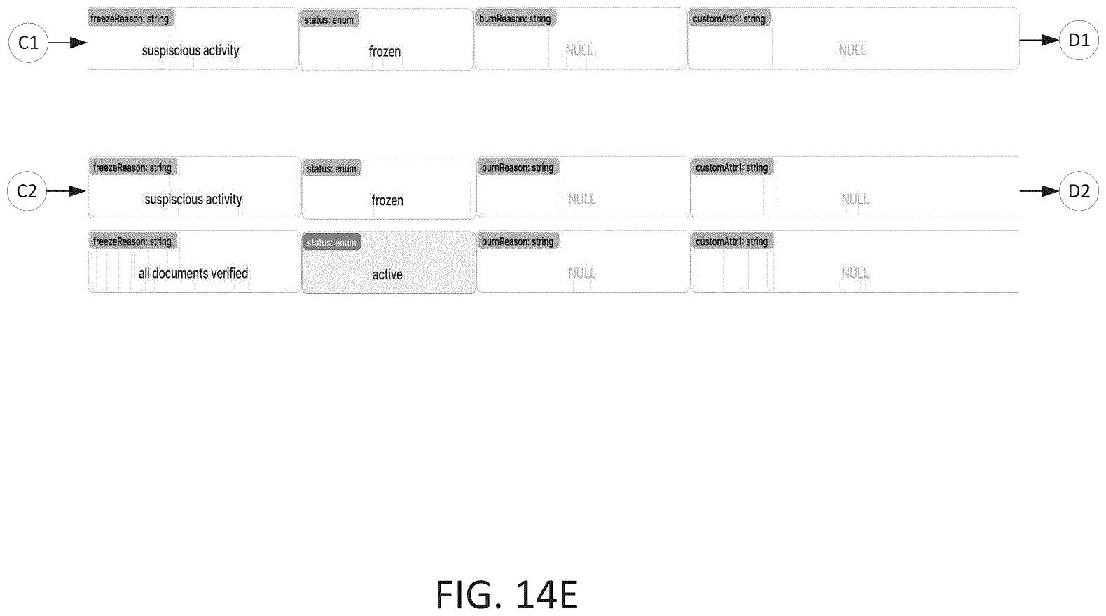

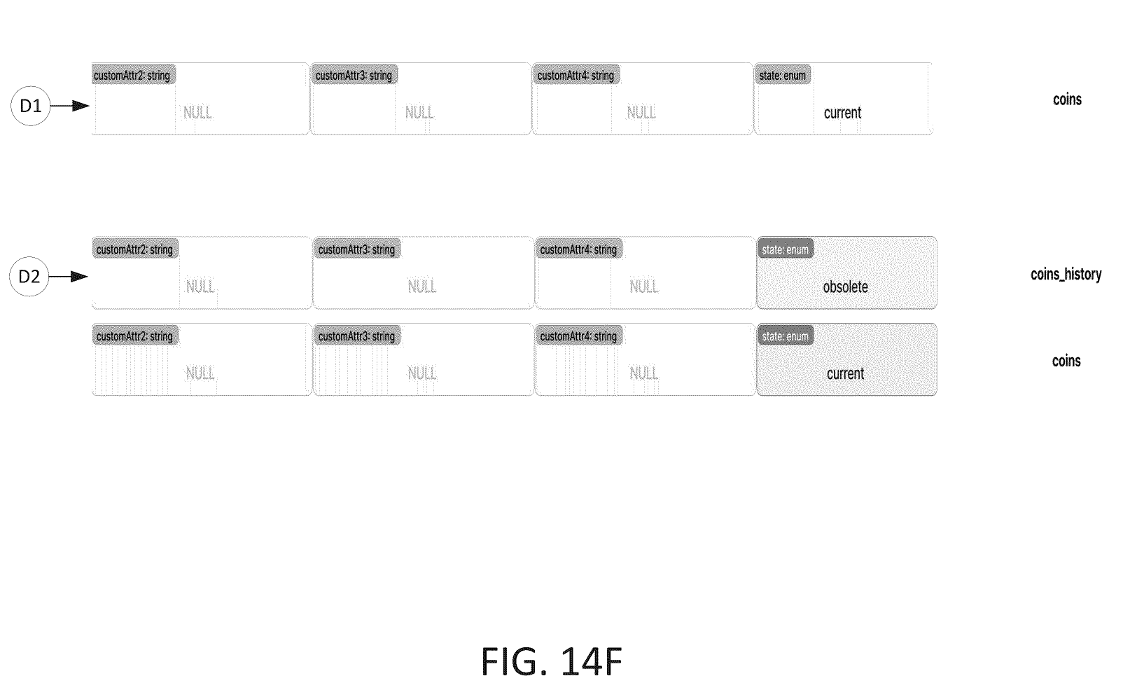

An example use case of an unfreeze operation is shown in FIGS. 14A-14F. The ledger cannot unfreeze the already active coins. FIG. 14A shows input parameters 1402 associated with an unfreeze operation 1404. Unfreeze operation 1404 within the present ledger serves to release previously frozen coins, allowing the coins to be utilized for transactions or other purposes. This operation is vital for managing the availability of funds and ensuring liquidity within the system. Similar to the freeze operation (e.g., 1304 in FIG. 13A), unfreezing can occur for both operational and security-related reasons.

In some embodiments, unfreeze operation 1404 uses a set of input parameters 1402 including one or more of attributes fromAddresses, amount, type, transactionDescription, reason, and customAttributes. A fromAddresses attribute specifies the addresses from which coins will be unfrozen. An amount attribute indicates the quantity of coins to be unfrozen. A transactionDescription attribute provides a unique descriptor for unfreeze operation 1404, aiding in tracking and auditing. A reason identifies the rationale behind the unfreeze action 1404, distinguishing between operational and security-related scenarios. A type attribute specifies the type of unfreeze operation 1404, which can be either operational or security-related. Custom attributes offer flexibility to include additional metadata relevant to unfreeze operation 1404, facilitating further tracking and analysis.

Unfreeze operation 1404 is operationally significant. Unfreeze operation 1404 does not delete any information from the ledger. Instead, unfreeze operation 1404 creates new entries, or addresses, referencing the parent addresses of the previously frozen coins. Even after coins are unfrozen, a reference to the previously frozen coins is maintained, ensuring a comprehensive audit trail and historical record within the present ledger system.

In an example scenario for a send-coins transaction, a portion of the sender's coins is operationally frozen to reserve funds for the transfer. This precaution ensures that the required coins remain available until the transaction is completed. Upon the recipient claiming the transaction, the operationally frozen coins are unfrozen, allowing for the seamless transfer of ownership to the new recipient. The transaction description might reflect this process, detailing the unfreezing event as part of an overall transaction flow. Additionally, custom attributes can be utilized to provide specific identifiers or contextual information associated with unfreeze operation 1404.

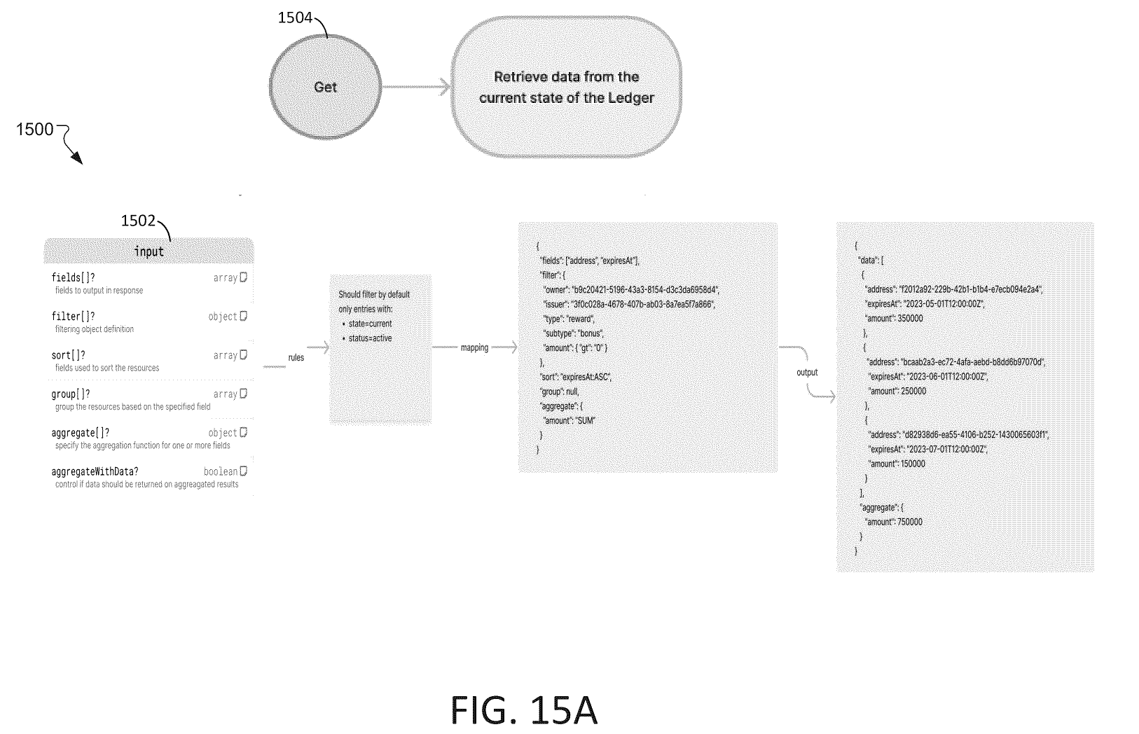

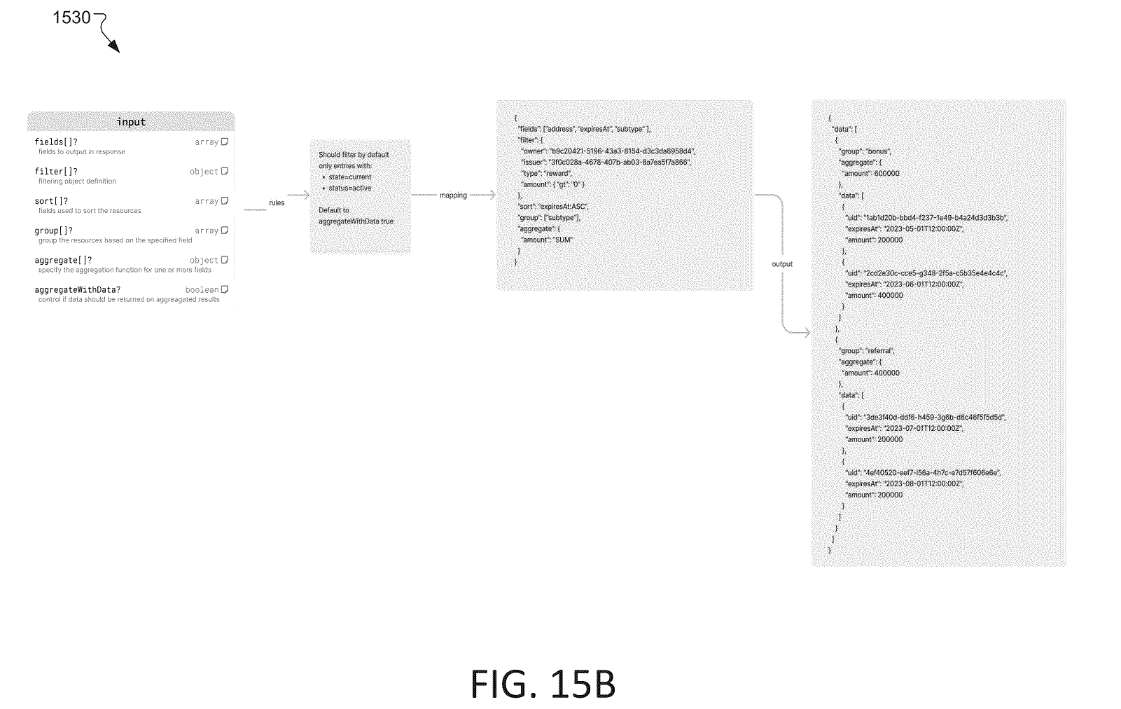

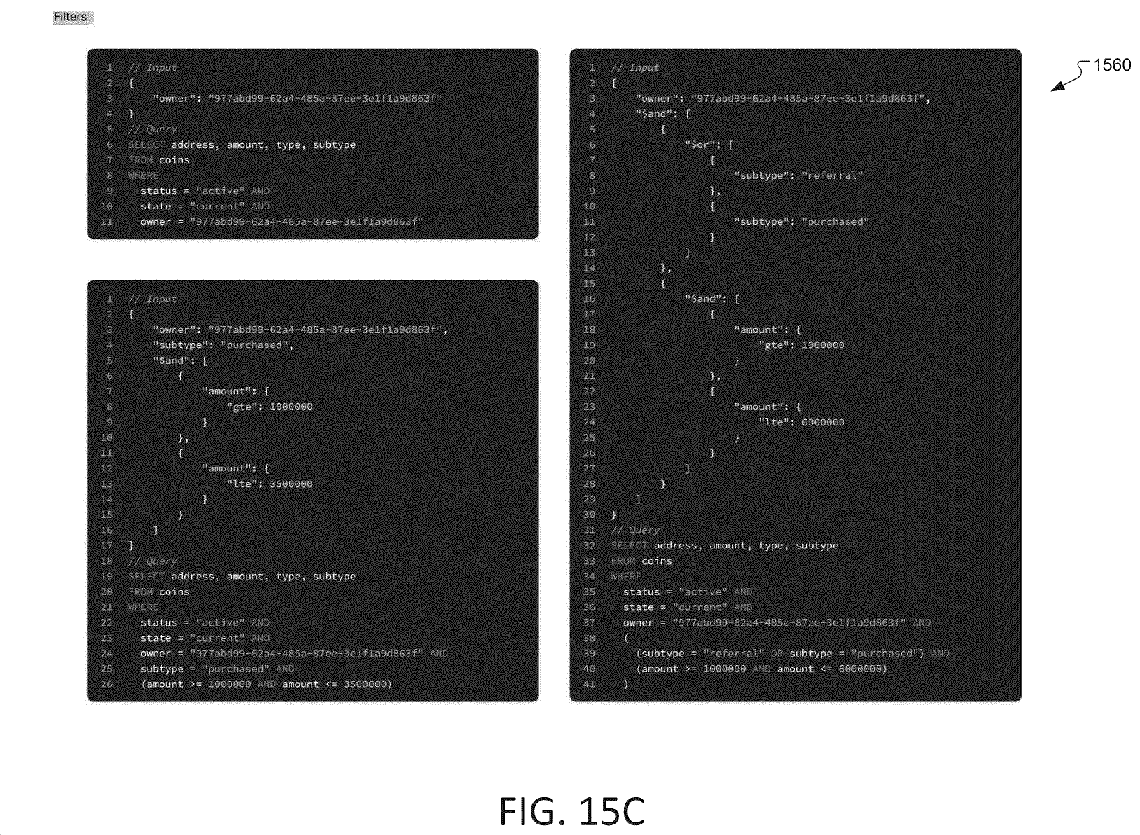

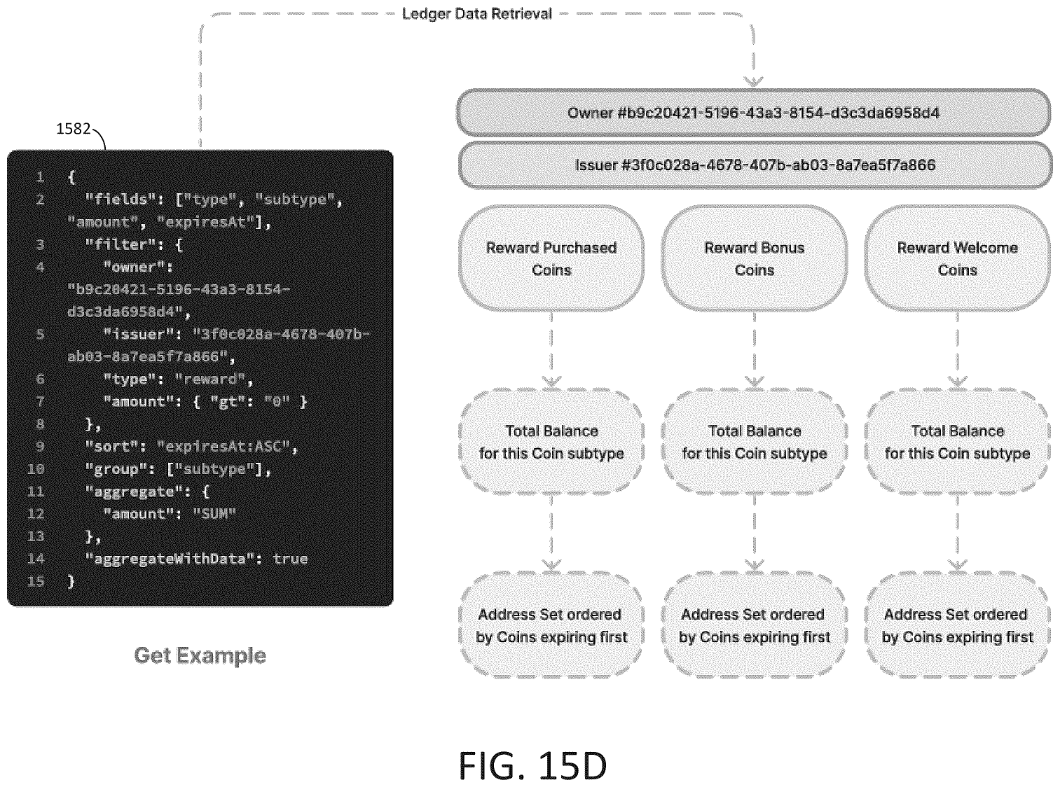

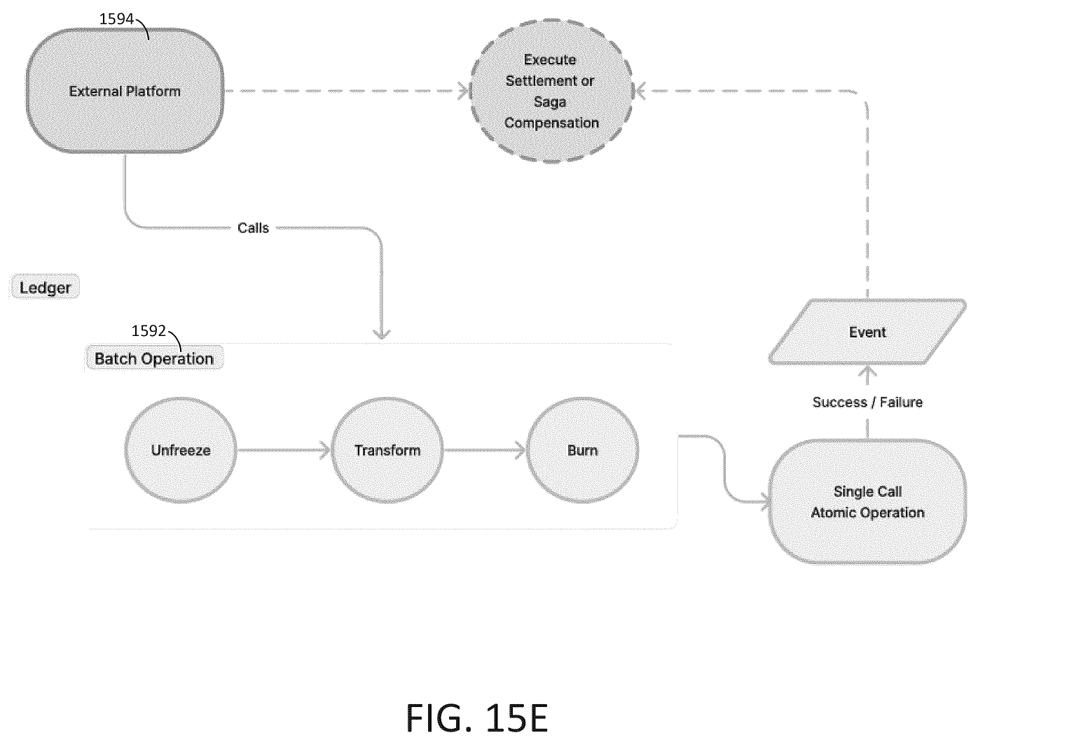

FIGS. 15A-15C illustrate exemplary diagrams of some other operations/functions including get, balance, supply, etc. The present ledger creates a generic getter that might have a different purpose according to input attributes. To achieve this, the present ledger can incorporate a custom search mechanism that combines aggregation and filtering capabilities. For example, a list method may be used to fetch relevant ledger entries based on defined criteria, such as transaction types, asset classes, timestamps, or user-specific identifiers. The output generated by the retrieval or get function may be combined with other ledger functions, enabling more advanced queries and processing. In some embodiments, the present ledger can create “wrappers” on top of these methods/APIs as “syntactic sugar” to users performing the integration task. By abstracting underlying complexities, these wrappers allow for more intuitive and efficient API calls, streamlining the process of querying and managing ledger data within various applications.

There are some functional and related capabilities. A get operation (e.g., 1504 in FIG. 15A) in the ledger serves as a fundamental tool for querying and retrieving information from the ledger system. While this operation does not alter any data, it provides access to detailed information about coins on addresses based on specific criteria. This operation is crucial to many platform integrations, allowing the retrieval of balances and comprehensive coin-related data, making the ledger the single source of truth. The present ledger allows users to get coins or get coins in batches, e.g., by owner, issuer, coin type, coin subtype, and/or by custom aggregator. The ledger allows users to get the current balance of each account, e.g., by owner, issuer, coin type, coin subtype, and/or custom aggregator. The ledger allows users to get the current circulating supply of each coin, e.g., by issuer, coin type, and coin subtype. A global circulating supply can also be obtained. The ledger allows users to get the current total supply (including every coin like burned coins), e.g., by issuer, coin type, and coin subtype, as well as a global total supply. The ledger can also adopt optimizations such as sharding or partitioning.

In the operations/functions of getters, balance, and supply, there are no validations. The present ledger merely enforces these functions to follow the search criteria parameters. Regarding security and performance, filters, sorting, or groups are not allowed (i.e., no indexing).

FIG. 15A shows input and output samples 1500 in a use case to get the balance of “Bonus Reward Coins” from “Natasha C.” at “Ultimate Coffee Shop,” assuming that Natasha possesses multiple addresses holding minted coins. FIG. 15B shows input and output samples 1530 in the use case to get the balance of “Bonus Reward Coins” from “Natasha C.” at “Ultimate Coffee Shop,” assuming that each coin subtype is separated and Natasha owns some more addresses for minted coins. This demonstrates how the system can aggregate balances across different addresses. FIG. 15C shows filtering pseudo-code 1560.

Referring to FIG. 15A, the input parameters 1502 for get operation 1504 include fields, filter, sort, group, aggregate, etc. A fields attribute is an array specifying the fields to be included in an output response. A filter attribute is an array that enables specific filtering based on values and conditions. A sort attribute is an array defining sorting criteria for the output. A group attribute is an array facilitating grouping based on specific fields. An aggregate attribute is an object mapping field that allows aggregation functions (e.g., sum).

In some embodiments, get operation 1504 exclusively targets entries with a ledger state of “current,” ensuring that only active data is retrieved. Obsolete states or data are not considered in the query, thereby maintaining data integrity and segregation within the database.

Get operation 1504 can be used in various query examples. Some of these examples are listed below:
1. Basic Retrieval: utilizing the “Fields” attribute to specify desired fields for retrieval, such as amount, type, and subtype.
2. Targeted Filtering: employing the “Filter” attribute to narrow down results based on specific criteria, such as owner, issuer, type, and subtype.
3. Sorting Criteria: utilizing the “Sort” attribute to define sorting criteria, such as expiration date in ascending order.
4. Aggregation Function: leveraging the “Aggregate” attribute to perform aggregation functions like SUM, providing insights into total coin balances for specific entities or initiatives.
5. Comprehensive Data Retrieval: enabling the “Aggregate with Data” parameter to retrieve both aggregated totals and individual address data, offering a complete picture of coin distributions and balances.

FIG. 15D illustrates a query example using a get operation. In the example of FIG. 15D, the query is used to retrieve comprehensive data for a specific merchant's reward coins, grouping the total balance for a particular customer by subtype. The input parameters are shown in 1582:
Fields: Type, Subtype, Amount, Expires At
Filter: Owner=[specific customer UID], Issuer=[specific merchant UID], Type=Reward, Amount=Greater than zero
Sort: Expires At (Ascending)
Aggregate: Amount (Sum)
Aggregate with Data: True
Group: Subtype

By specifying the fields to include (Type, Subtype, Amount, Expires At), the present ledger system can achieve comprehensive data retrieval for each coin address. The filter parameters narrow down the results to coins belonging to a specific user (e.g., customer) and issued by a particular issuer (e.g., merchant), focusing on reward coins. Sorting the results by expiration date in ascending order allows the present system to prioritize coins with closer expiration dates, aiding in prioritization or time-sensitive actions.

Additionally, leveraging the aggregation function to sum the amounts provides the ledger system with the total balance of reward coins for the specified user (e.g., customer) within the given issuer's ecosystem. Moreover, enabling the “Aggregate with Data” parameter ensures that, along with the aggregated total, the ledger system can also receive individual address data, offering a complete view of coin distributions and balances based on the specified criteria. Finally, by grouping the results by subtype, the present system can obtain the total balance for each subtype of reward coins, providing a comprehensive overview of the customer's holdings within the specified issuer's ecosystem.

FIG. 15E illustrates an exemplary diagram of batch operation and saga pattern. Efficiency and data consistency are vital in ledger operations, especially within complex integrations. A batch operation (e.g., 1592) may provide a streamlined approach to executing multiple ledger operations in a single call, ensuring transaction integrity and operational efficiency.

Generally, a batch operation may enable executing multiple ledger operations in a single call. A batch operation may include mint, transform, transfer, freeze, unfreeze, burn, and get operations. It is essential for maintaining atomicity across diverse transactions. Batch operation 1592 ensures that either all included operations are successfully executed or none are applied, thereby preserving ledger consistency. Further, it allows the capture of results from the previous operations to be reused in the same batch operation.

In some embodiments, there is event messaging for a saga pattern. The ledger messaging mechanisms provide real-time event notifications, indicating the success or failure of individual or batch operations. Integrating platforms can use this architecture combined with batch operations to maintain transaction integrity within sagas. This pattern allows the management of a sequence of related operations as part of a distributed system, orchestrating multiple operations across different services.

Batch operations can be compensational operations. In case of a failure at any point during the saga execution, the pattern provides mechanisms for compensating actions to undo or reverse the effects of previously completed transactions. This ensures that the ledger and the external platform (e.g., 1594) remain in a consistent state, even in the face of errors or unexpected events.

As discussed above, the custom private ledger system can be applied in a wide range of applications. The below described includes minting, transferring, transforming, freezing, and unfreezing assets used for granular control, auditability, and automation across multiple entities and multiple asset types in the context of a cybersecurity threat detection and mitigation system.

When a threat detection node (TDN) identifies a security event, such as a distributed denial-of-service (DDOS) attack, the TDN reports the event to the present ledger. The present system mints new threat score coins (TSC) based on the severity level (e.g., low, medium, high). For example, when a TDN detects a high-severity malware attack, the present ledger mints 100 TSC and assigns them to the event record. Once a security processing node (SPN) verifies the threat, the present system transfers a portion of the TSC to a security operator node (SON) as mitigation reward coins (MRC) for handling the incident. For example, if the SON successfully neutralizes the attack, the present ledger transfers 50 TSC (out of 100 TSC) to the SON as 50 MRC.

If the TDN is found to have falsely reported a security threat, its TSC may be converted into false positive penalty coins (FPC) as a penalty. For example, if the TDN reports an event that is determined to be a false positive, the present system transforms 30 TSC into 30 FPC, reducing the node's credibility. If a security alert is under review, the corresponding TSC can be frozen, preventing further transfers until validation is complete. For example, an SPN freezes 75 TSC while investigating a reported vulnerability, preventing premature use of the assets. If the security event is confirmed as legitimate, the SPN unfreezes the TSC, allowing the normal use of these TSEs. However, if invalidated, the coins may be revoked or transformed into another type. For example, the SPN completes verification and unfreezes 75 TSC, making them available for transfer or mitigation rewards.

This example illustrates how a multi-entity, multi-asset ledger system efficiently tracks and manages digital assets. The mint, transfer, transform, freeze, and unfreeze operations allow precise control over how assets are assigned, validated, and used. By integrating these functionalities, the present system can ensure real-time auditing, transparency, and security in decentralized digital asset management.

### Ledger Integration

Ledger integration refers to the process of connecting a ledger system with external applications, databases, or services to enable seamless data exchange, transaction processing, and automation. Specifically, the ledger integration described herein is used for managing the digital assets and applications installed on the present ledger platform. Ledger integration relates to various strategies, protocols, operations, etc.

### Issuing Strategy

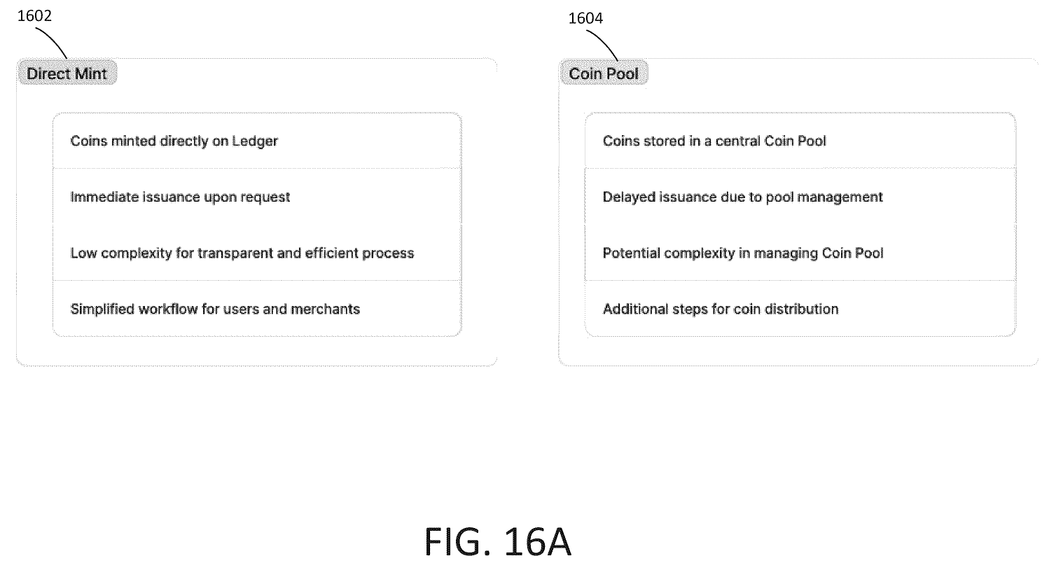

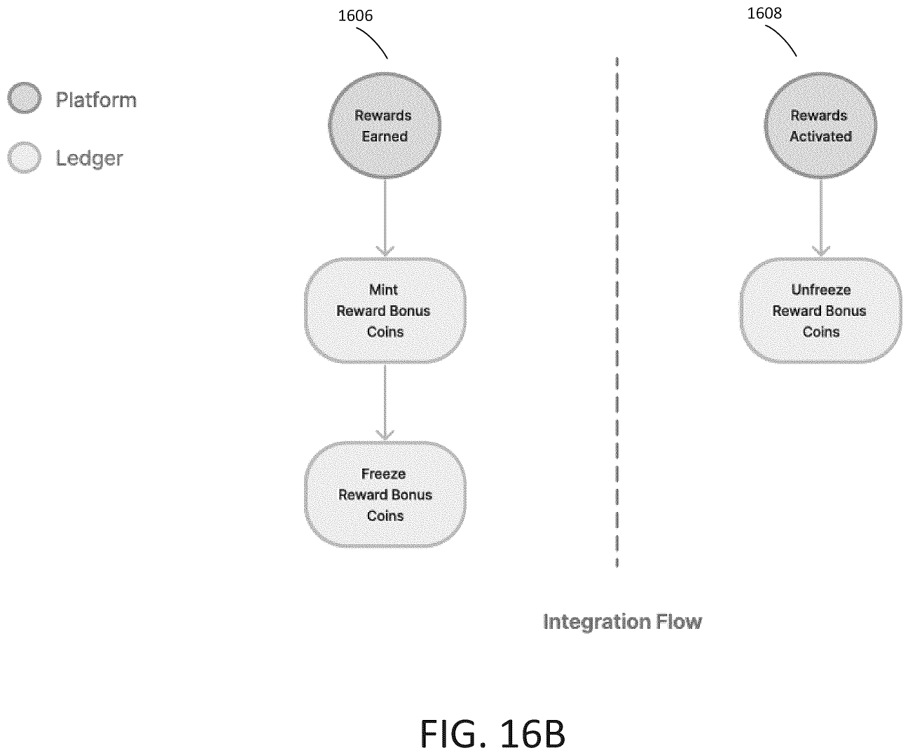

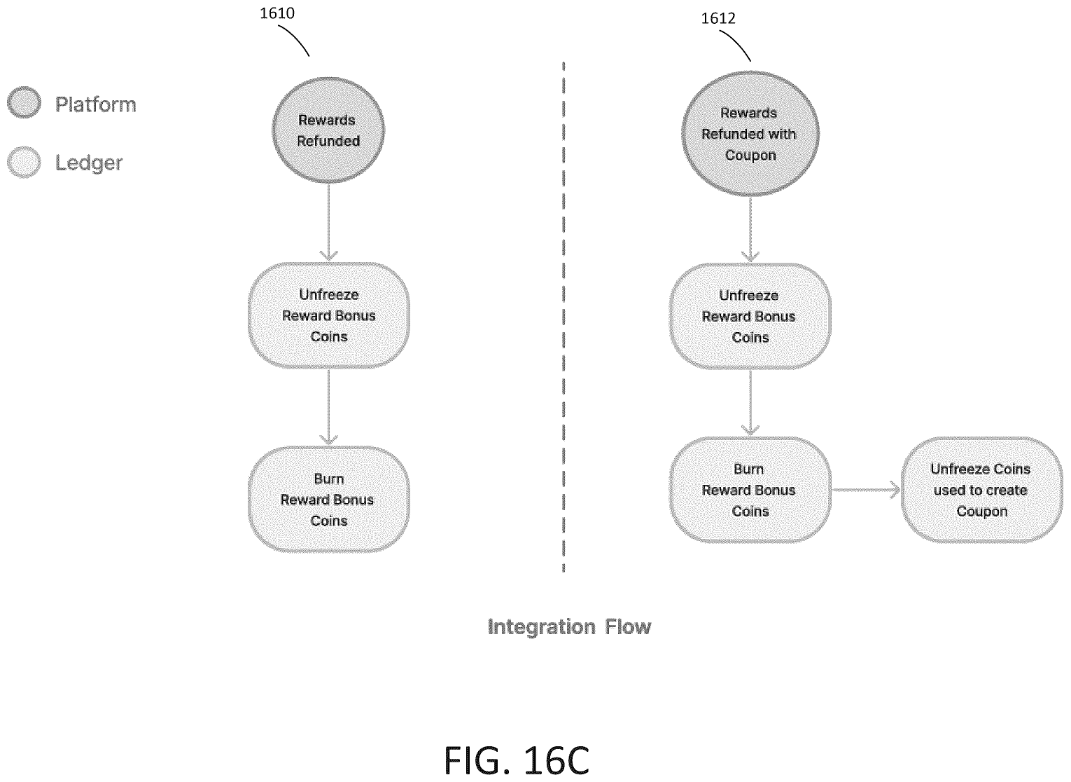

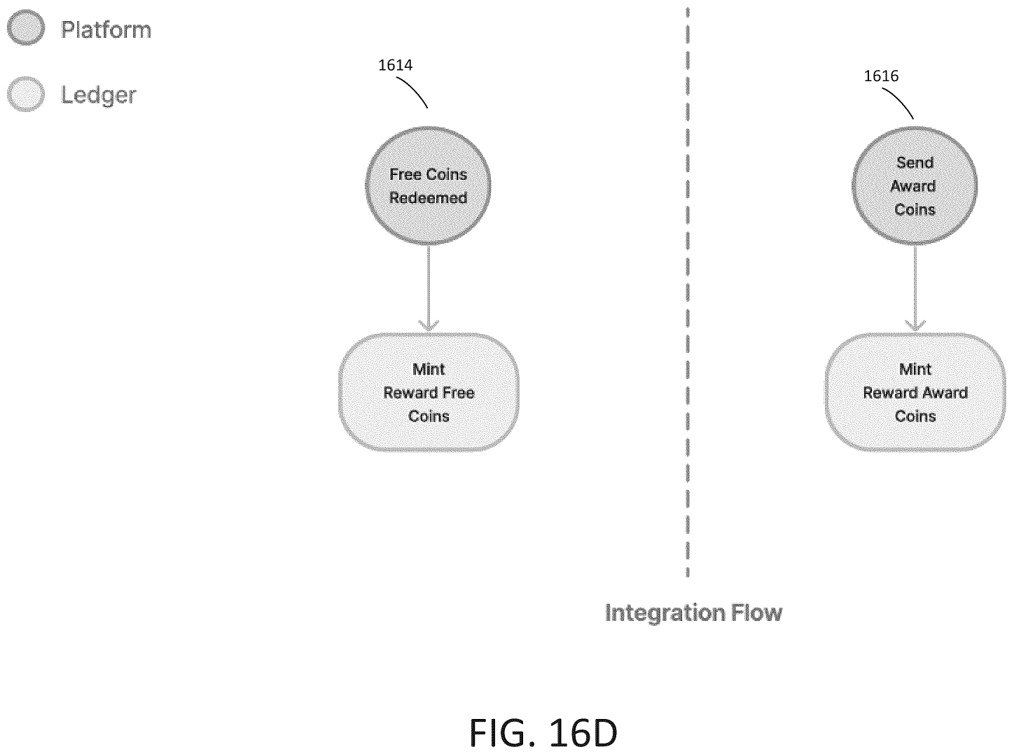

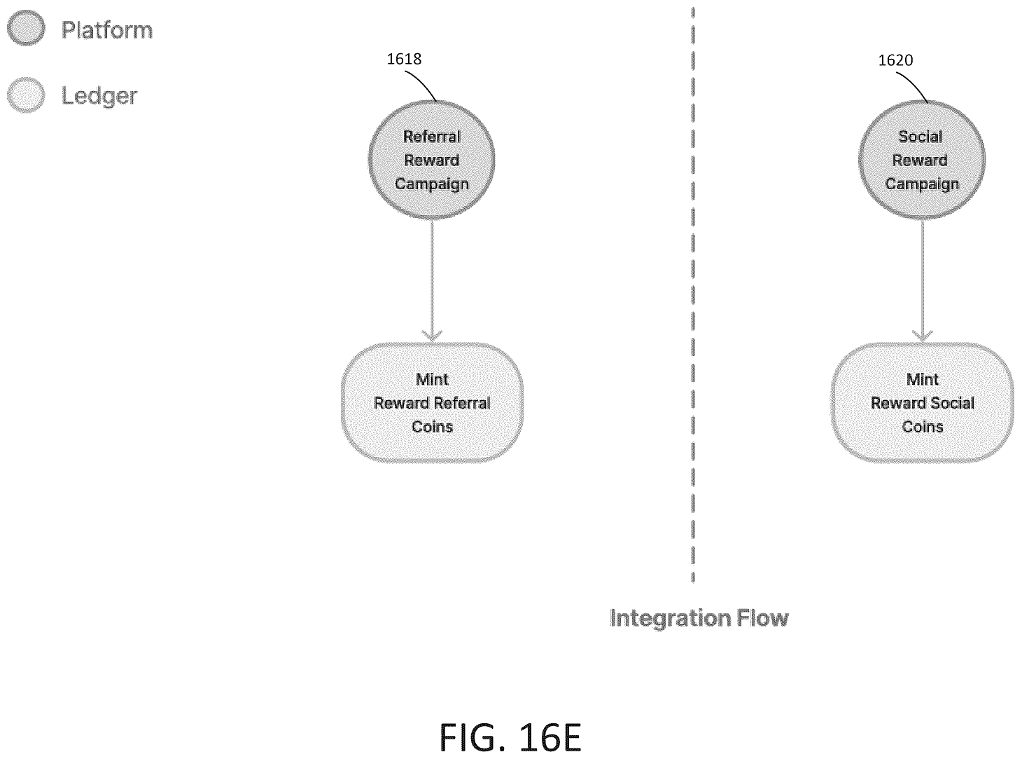

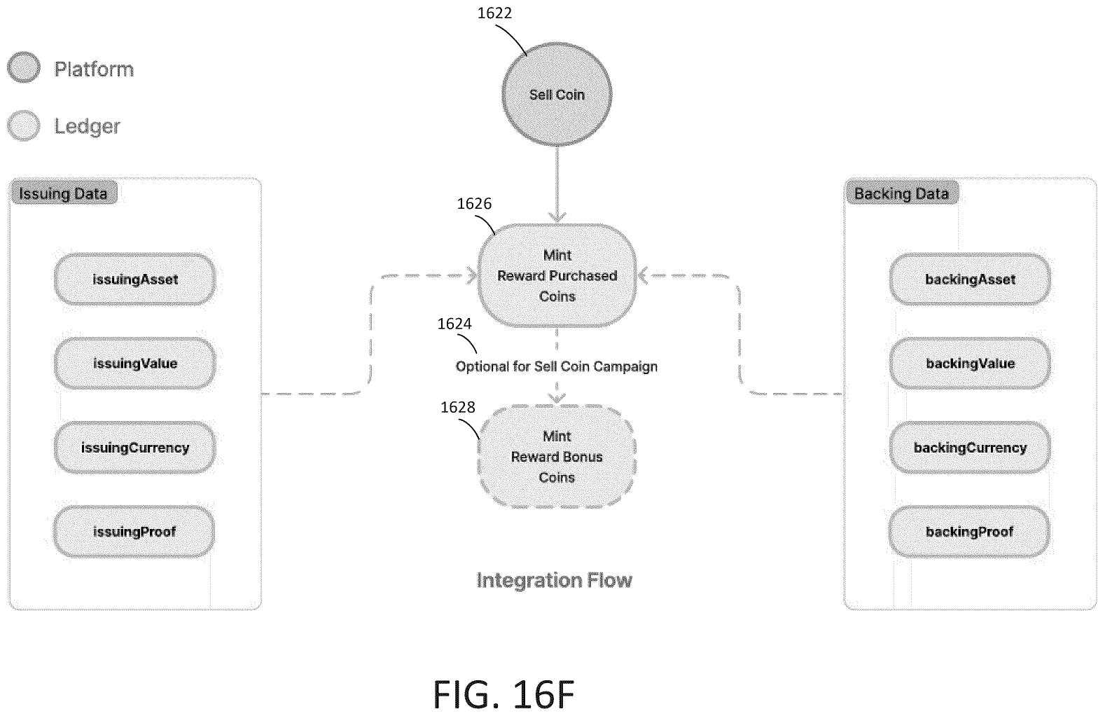

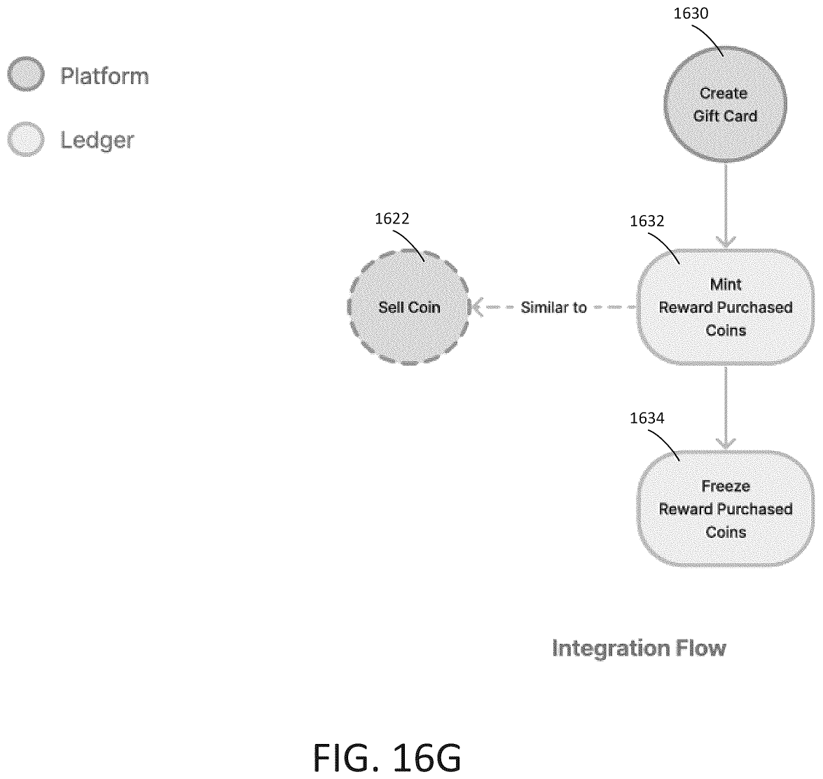

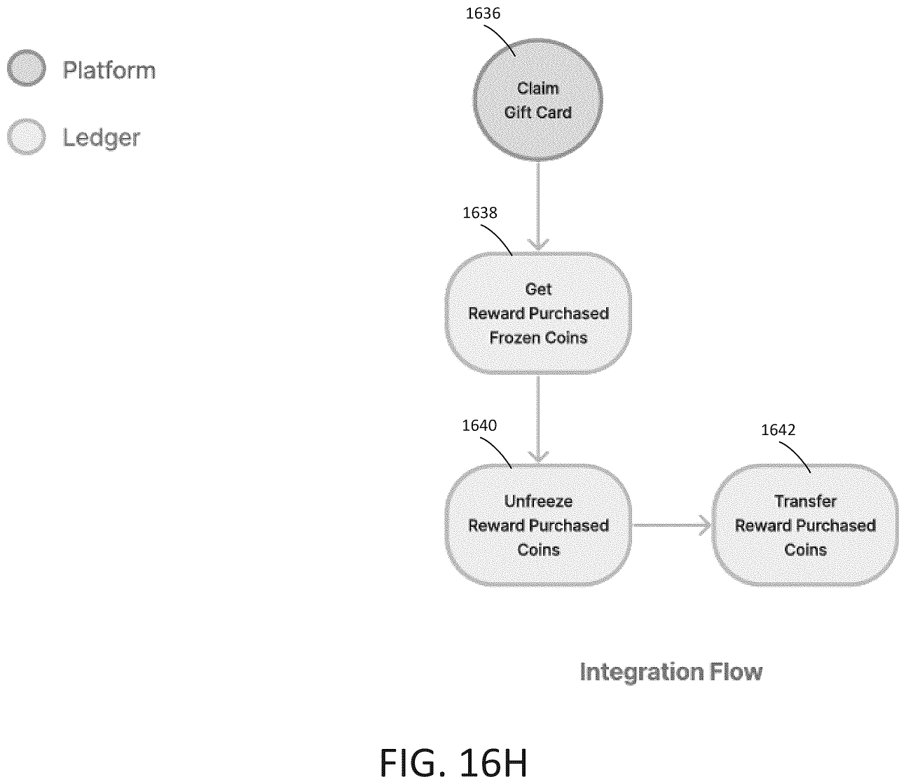

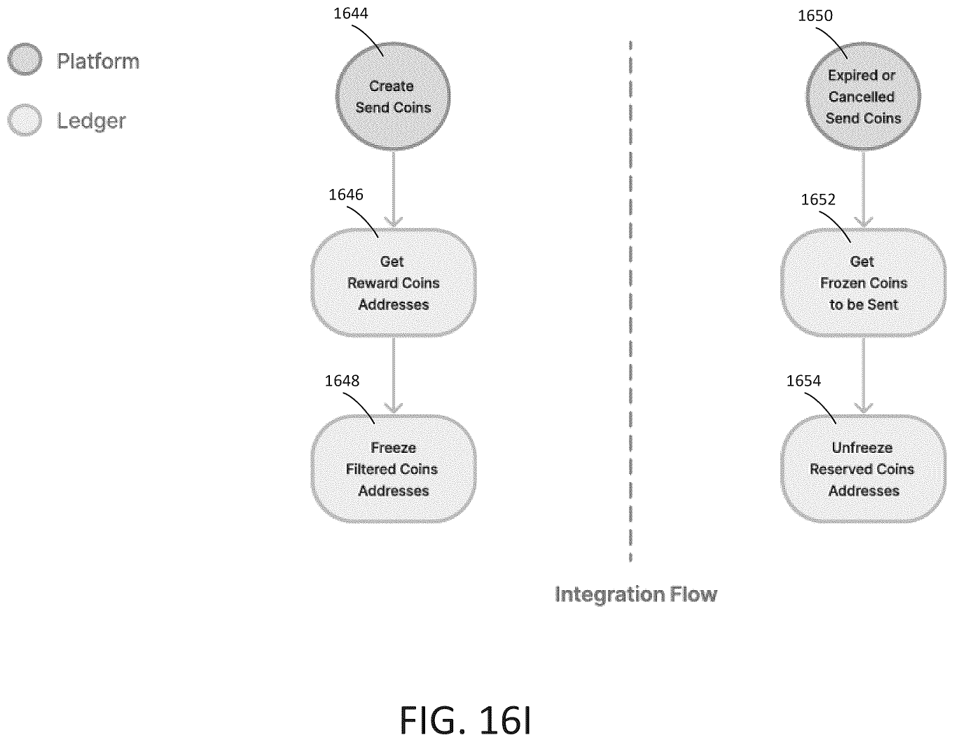

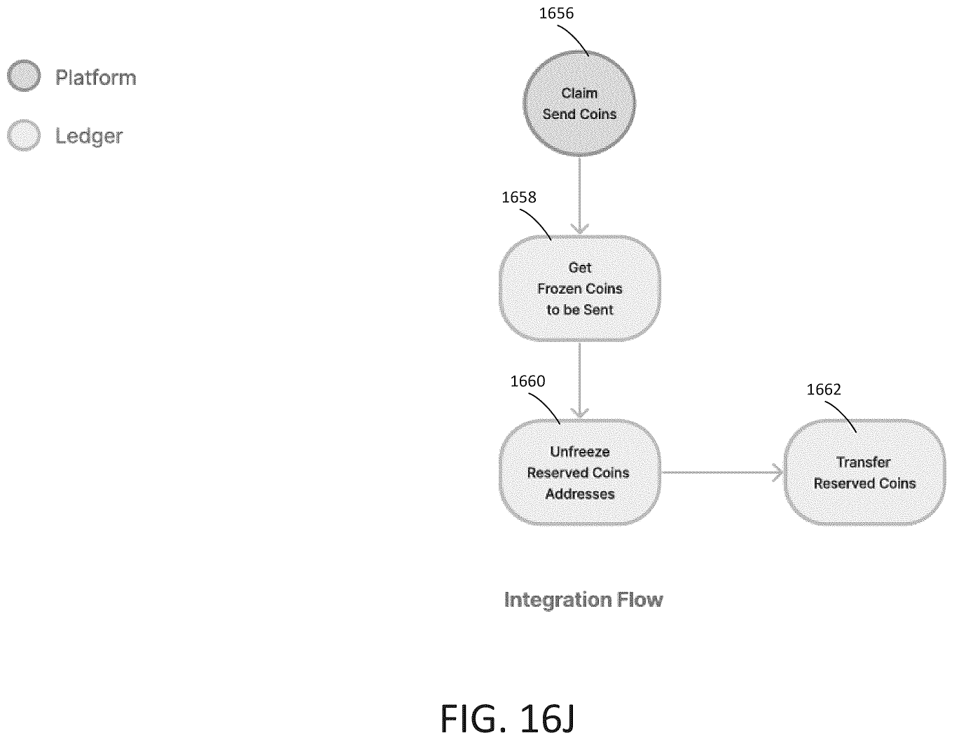

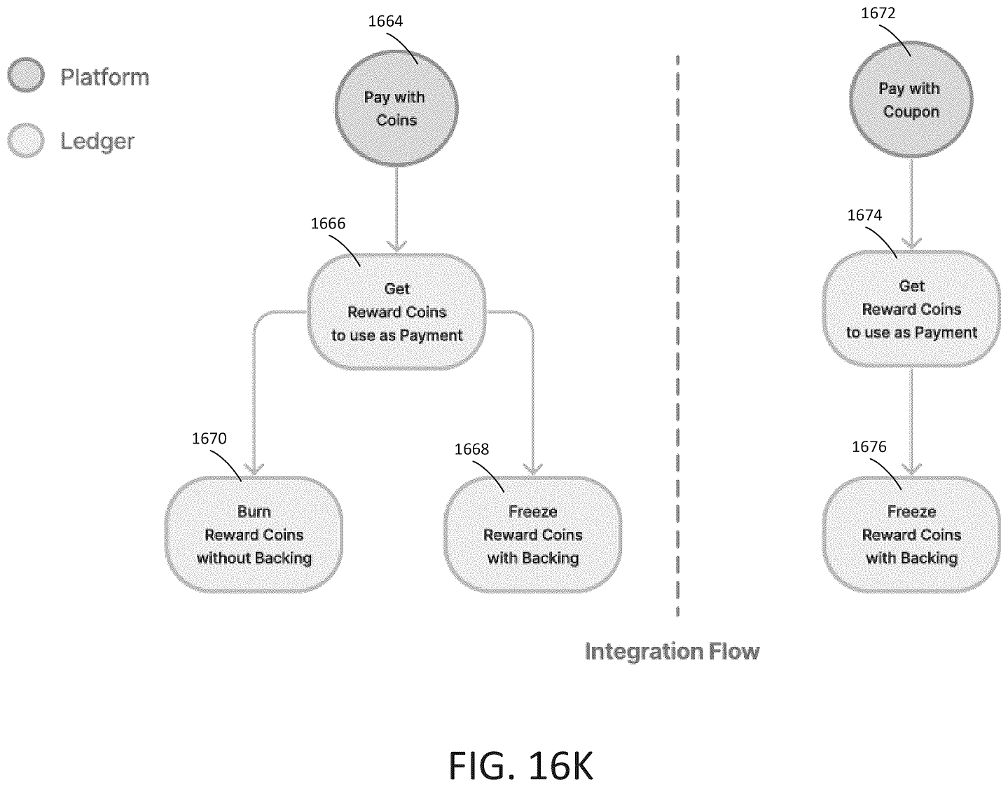

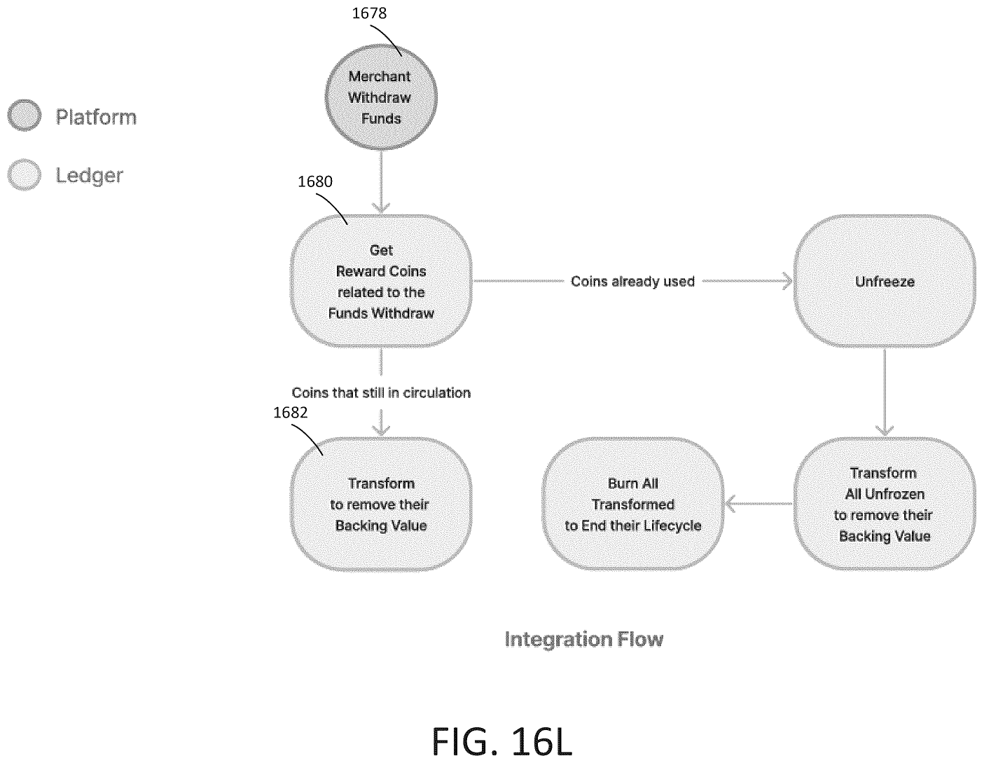

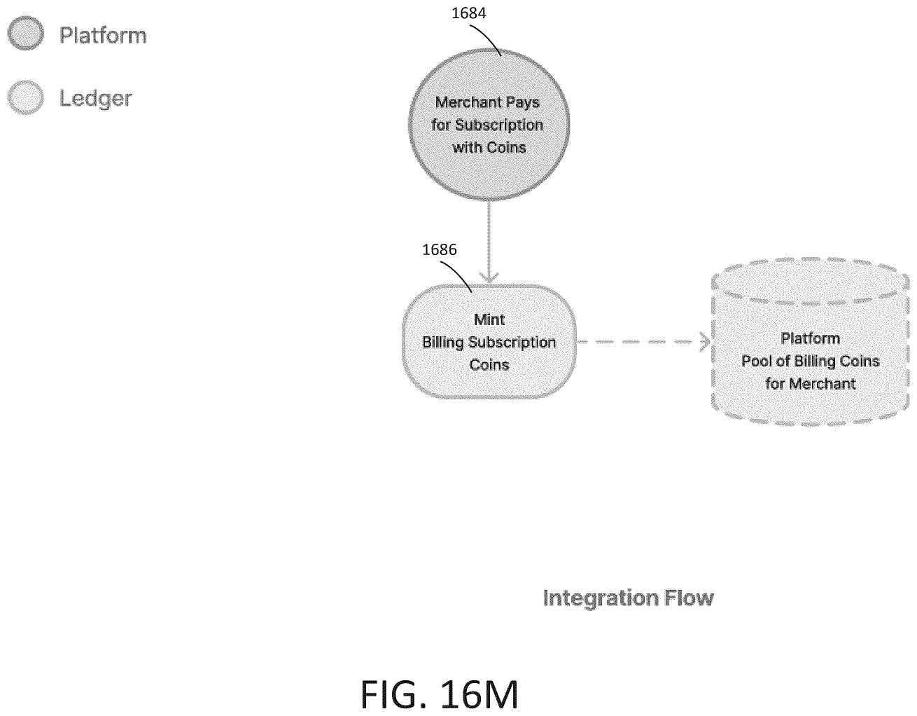

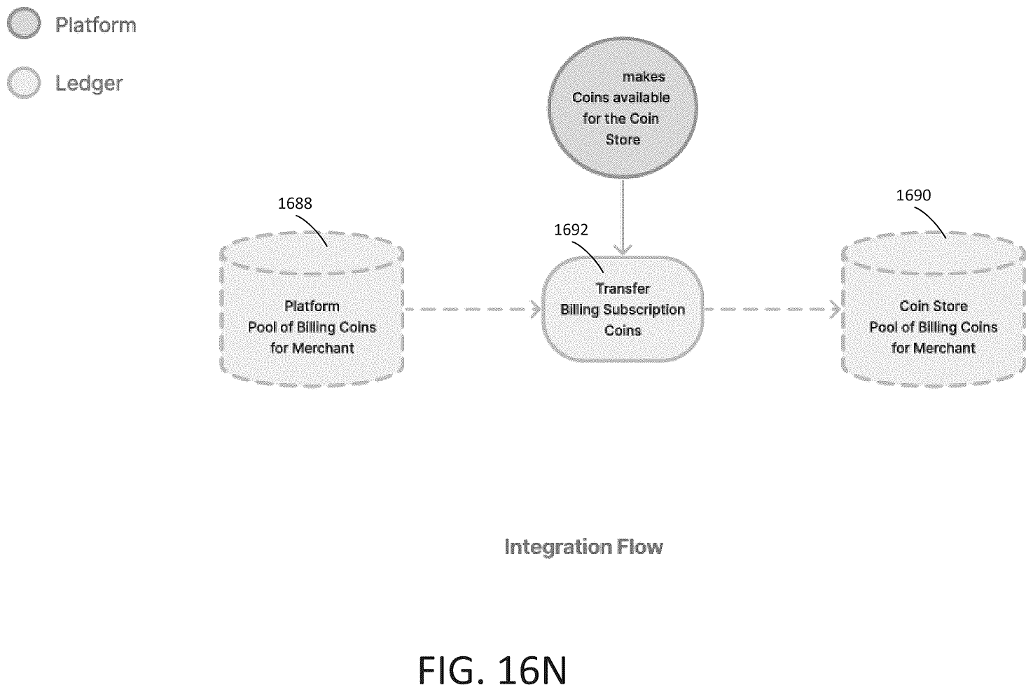

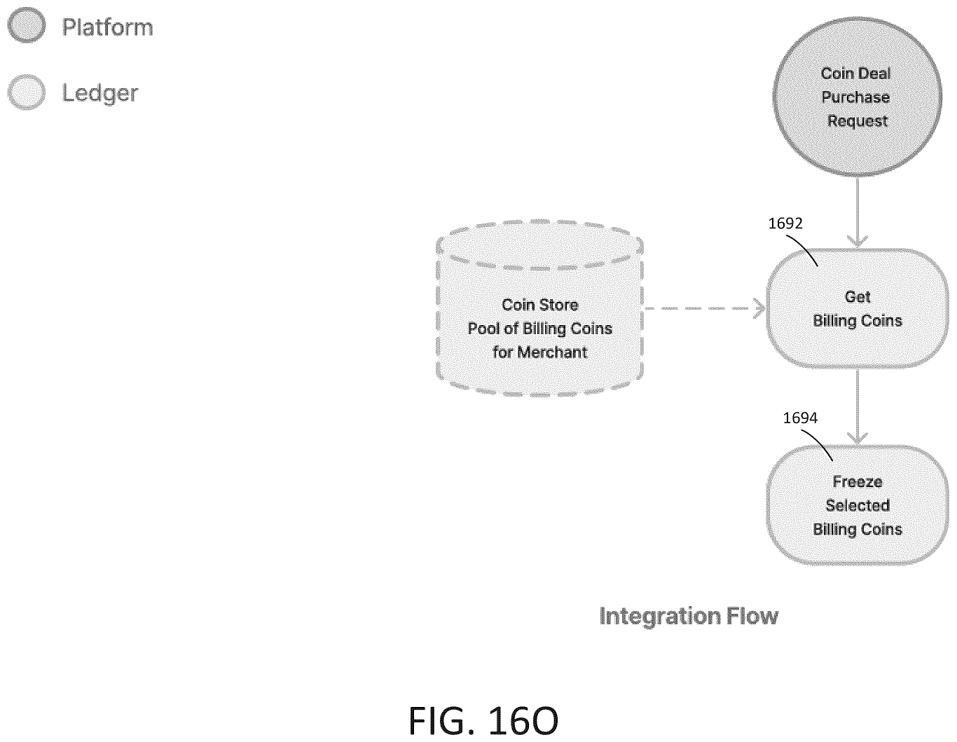

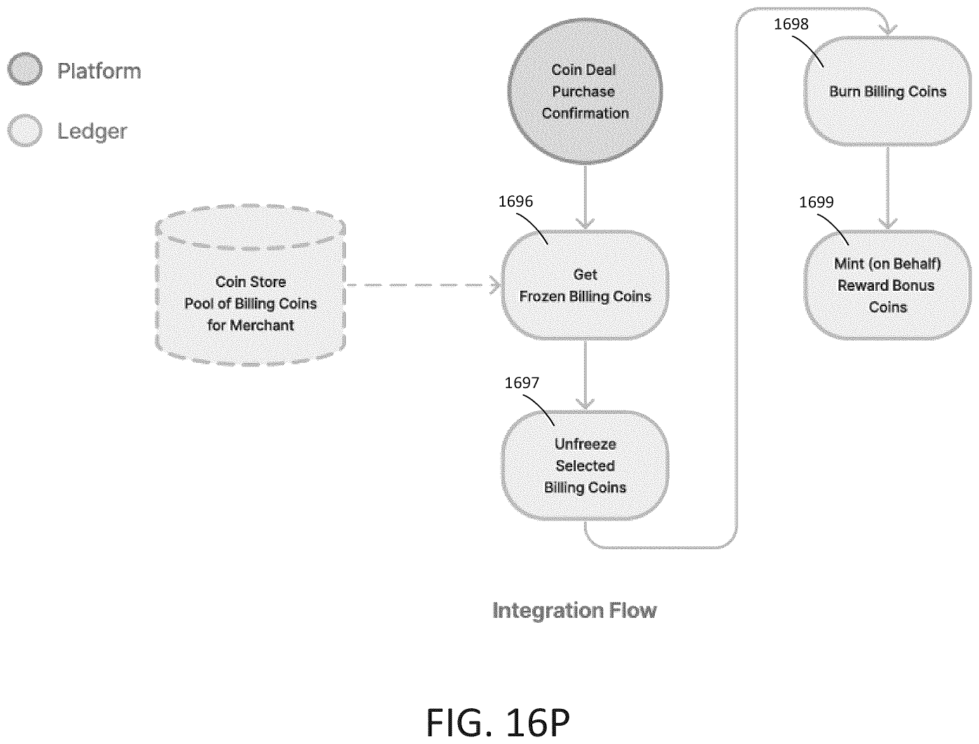

FIG. 16A illustrates an example issuing strategy applied in the present ledger system. In the integration with the present ledger, in some embodiments, there are two options for a mint operation: direct mint 1602 and coin pool 1604. A direct mint includes minting coins directly to a user's accounts as needed, while a coin pool requires maintaining a centralized pool of coins for distribution.

Consider a scenario in which a user earns rewards through purchases. A direct mint operation would mint coins directly to the user's account upon completion of the purchase. This operation allows immediate issuance of coins without relying on coin pools, simplifying the integration process. In contrast, a coin pool operation will transfer coins from a centralized coin pool to the user's account upon completion of the purchase. Managing and maintaining coin pools adds complexity and potential for failure to the integration process. Additionally, the creation of a coin pool requires an initial minting process, for example, when an entity (e.g., merchant) decides to implement a rewards program.

In the present ledger system, direct mint operations are applied for the majority of cases. This offers easier integration over the coin pool method. By minting coins directly when needed, the present system eliminates the complexities associated with managing coin pools and conducting additional transfer operations. This process may also reduce potential points of failure and not impose restrictions to transition to a coin pool integration if necessary.

### Rewards Core

Rewards can be earned, activated, and/or refunded. Rewards may be earned through purchases. FIG. 16B illustrates an exemplary integration flow related to rewards earning 1606 and activation 1608. In some embodiments, coins are generated via a mint operation, followed by a freeze to withhold coin usage until purchase confirmation and refund periods expire as shown in 1606. In some embodiments, coins may be minted upon the completion of a purchase, representing the rewards earned by a user. This operation may add the earned rewards to the user's designated address within the present ledger. The minted coins may initially be frozen to prevent their immediate use until the purchase confirmation and refund periods are finalized. Freezing safeguards the integrity of the rewards until the rewards are officially validated.

In some embodiments, a rewards activation process can activate rewards for usage upon confirmation. A subsequent unfreeze operation may grant coin holders full utilization rights. In some embodiments, once the purchase is confirmed and the refund period expires, the frozen coins are unfrozen, granting the user access to their rewards. An unfreeze operation enables a user to utilize the rewards for transactions or transfers within the ledger system.

FIG. 16C illustrates an exemplary integration flow related to rewards refunding, as shown in 1610 and 1612. In cases requiring rewards refunds in 1610, a sequence of unfreezing and burning coins may be executed, effectively terminating their lifecycle and revoking associated rewards. In some embodiments, if a refund is initiated, the frozen coins may be unfrozen to prepare for a refund process. Unfreezing allows the coins to be accessed for the subsequent steps in the refund process. After the refund is processed, the coins associated with the refunded rewards may be permanently removed from circulation using a burn operation. Burning ensures that the refunded rewards are effectively nullified within the ledger.

In some embodiments, rewards may be refunded with coupons as shown in 1612. This specific flow may include coupon redemption alongside refund operations. In addition to acting as a rewards refunded flow, here the coins initially frozen for coupon usage are subsequently unfrozen as part of the refund process. Similar to the rewards refunded scenario, the frozen coins may be unfrozen to facilitate the refund process. Once the refund with the coupon is completed, the coins related to the refunded rewards are burned to prevent their further utilization. In some embodiments, additional unfreeze occurs. That is, the present ledger system may also unfreeze the coins that were frozen when the utilized coupon was generated.

### Award and Free Coins

FIG. 16D illustrates an exemplary integration flow related to awards and free coins. This integration flow may include claiming free coin 1614 and sending award coin 1616. To claim free coins, the integration with the ledger relies on a straightforward mint coins operation. When users claim free coins, these coins are directly generated in the present ledger, ensuring efficient issuance of reward welcome coins to users. In some embodiments, coins may be generated in the ledger using a mint operation for the type “Reward” and subtype “Welcome” when users claim free coins. This operation ensures the timely issuance of coins without unnecessary complexity.

Similarly, in the context of award coins, when an entity (e.g., merchant) sends coins to another entity (e.g., customer), the integration with the present ledger follows the same pattern. In some embodiments, the present ledger may execute a mint operation at the moment the coins are sent to a specific user, to ensure efficient and timely issuance of reward award coins to recipients. For example, the mint operation for type “Reward” and subtype “Award” may be executed in the ledger when a merchant sends coins to a customer as part of an award, enhancing integration efficiency.

### Referral and Social Coins

FIG. 16E illustrates an exemplary integration flow related to referral and social coins. Entities (e.g., merchants) often initiate referral campaigns 1618, allowing users to invite others to join the platform. When new users accept invitations via referral links, the users receive reward referral coins. Upon completion of specific actions by a new user, a mint coins operation occurs in the present ledger, which creates reward referral coins directly associated with the new user as an owner. In some embodiments, coins may be minted in the ledger when new users join through referral links, which facilitates seamless reward issuance. This operation may utilize the type “Reward” and the subtype “Referral.”

As to social rewards, users may earn rewards by sharing platform content on their social media channels at 1620. When users engage in sharing activities, the ledger initiates a mint coins operation, creating reward social coins. This mechanism incentivizes users to promote the platform across various social networks. In some embodiments, coins may be generated in the present ledger when users share platform content or referral links on social media, simplifying the reward issuance process. This operation may also use the type “Reward,” but the subtype is “Social.”

FIG. 16F illustrates an exemplary integration flow related to selling coins 1622. When users purchase coins through the present ledger platform, a mint coins operation may be initiated in the ledger. An “owner” refers to the user who buys the coins, and an “issuer” is the entity issuing the coins. In this scenario, coins of type “reward” and subtype “purchased” are minted to represent the purchased coins. In some embodiments, if a sell coin campaign 1624 is active, an additional mint operation may be performed to create bonus coins of type “reward” and subtype “bonus,” distinguishing them from purchased coins.

As depicted, coins of type “reward” and subtype “purchased” are minted 1626 in the ledger. The coins are associated with the user purchasing the coins (e.g., owner) and the entity issuing the coins (e.g., issuer). This operation represents the coins that were effectively purchased by the user. If a sell coin campaign 1624 is active, additional coins of type “reward” and subtype “bonus” are minted 1628 in the ledger as bonus rewards. This operation distinguishes bonus coins from purchased coins and incentivizes users through bonus rewards.

In some embodiments, operation details of selling coins are included in the ledger through custom attributes/metadata (e.g., unique payment IDs, campaign IDs, etc.). These attributes provide comprehensive information about the origin and value of the minted coins.

In some embodiments, the ledger also requires information about backing & issuing assets, value, currency, and proof. The backing asset represents the fiat money used for issuing the coins, while the issuing proof serves as a unique identifier for the payment. This information is crucial for understanding the real fiat money backing associated with specific coins circulating within the present ledger.

### Gift Card Creation and Claim

FIGS. 16G and 16H illustrate an exemplary integration flow related to gift card creation and claiming. Gift card creation 1630 enables users to purchase and send coins as gifts to others through the present platform. When purchasing a gift card, coins are minted 1632 in the ledger. The coins are associated with the gift card and the buyer's address. Similar to the sell coins process 1622 of FIG. 16F, the mint operation 1632 in FIG. 16G creates coins of type “Reward” and subtype “Purchased,” representing the coins bought for the gift card. The purchased coins are then frozen 1634 to reserve for an intended recipient.

In some embodiments, coins of type “Reward” and subtype “Purchased” may be minted 1632 in the ledger when a user purchases coins to create a gift card. This operation initiates the gift card creation process. In the present ledger, mechanisms are in place to differentiate between directly purchased coins and the coins acquired through gift card initiatives. Attributes (e.g., TransactionDescription, CustomAttributes) are utilized for this purpose. For example, custom attributes may include a unique ID that represents the gift card, enabling identification and tracking within the present ledger. In some embodiments, backing and issuing rules may be used in the same way as applied in the selling coins process.

After minting 1632, the purchased coins associated with the gift card may be frozen 1634 to reserve for the intended recipient. Freezing ensures that the coins remain allocated for the gift card until it is claimed or used.

This gift card creation approach ensures proper tracking and management of gift card transactions within the ledger, thereby enabling seamless creation and distribution of gift cards on the present platform.

Referring to FIG. 16H, gift card claim 1636 occurs when a recipient accepts and claims the gift card received from another user. Upon claiming the gift card, the frozen coins associated with the gift card are unfrozen and fully transferred to new addresses, representing the Recipient's ownership of the claimed coins. This process completes the gifting creation and claiming process and ensures the seamless transfer of ownership.

In some embodiments, gift card claiming process 1636 includes operations such as get 1638, unfreeze 1640, and transfer 1642. The get operation 1638 retrieves specific coin sets associated with the claimed gift card, enabling targeted transfers for efficient gift card claims. This ensures that the correct coins are unfrozen and transferred based on the gift card details and the recipient's address. Get operation 1638 may utilize one or more custom attributes to identify the unique gift card and its associated coins.

In response to the gift card being claimed, the frozen coins associated with the gift card are unfrozen at 1640. This allows the coins to be accessed and fully transferred to new addresses that represent the recipient's ownership. Unfreezing 1640 ensures that the coins are available for the recipient's transactions and activities within the present platform.

The unfrozen coins associated with the claimed gift card are fully transferred 1642 to new addresses that represent the recipient's ownership. This transfer operation 1642 updates the ledger to reflect the complete transfer of ownership, allowing the recipient to utilize the gifted coins as desired while maintaining the integrity of the present ledger.

### Send Coins Integration

FIGS. 16I and 16J illustrate an exemplary integration flow related to send coins integration. In some embodiments, this integration may include creating send coins, dealing with expired or canceled send coins, and/or claiming send coins.

The send coins feature empowers users to transfer coins directly to others within the present platform. This facilitates seamless peer-to-peer transactions, whether for rewarding friends, settling debts, or other transactions. Send Coins provides a convenient way to transfer values. In some embodiments, when a send coins transaction is initiated, operations such as get, freeze, etc., are taken to ensure a smooth transfer process.

In creating send coins 1644 of FIG. 16I, a get operation 1646 can be the first step, which retrieves the necessary coin balance from the present ledger. This operation ensures that a sender has sufficient funds to complete the send coins transaction. Get operation 1646 may filter coins by type “Reward,” to ensure that only transferable coins are considered. The coins that will expire first are prioritized when the get operation is implemented.

Once the required coin balance is retrieved, the selected coins are reserved for transfer. A freeze operation 1648 effectively locks these coins, preventing the sender from using them for any other purpose until the send coins transaction is completed.

In cases where send coins transactions remain unclaimed or are canceled by the sender, i.e., expired or canceled send coins 1650, specific actions may be taken to manage these transactions effectively. In some embodiments, upon expiration or cancellation, any generated links associated with the unclaimed or canceled send coins transaction may be disabled. This action may ensure the link becomes inactive, preventing any unauthorized or unintended ledger operations.

Additionally, disabling the link serves to invalidate a pending transaction, thereby preventing further interactions with the ledger. Once the link is deactivated, any attempt to redeem the sent coins through the original transaction reference will be blocked. This mechanism enhances security and prevents discrepancies in ledger records by ensuring that unclaimed or canceled transactions are properly managed.

In some embodiments, the present ledger retrieves information on unclaimed send coins transactions using get operation 1652. This step identifies the coins associated with the send coins that require resolution. If a send coins transaction goes unclaimed or is canceled, the reserved coins are automatically released back to the sender through unfreeze operation 1654. This unfreeze operation 1654 ensures that the sender regains access to the reserved coins.

Referring to FIG. 16J, where claim send coins operation 1656 is illustrated. That means, in response to receiving send coins, a recipient must take specific actions to claim and access the transferred coins. In some embodiments, send coins may be claimed using operations such as get 1658, unfreeze 1660, and transfer 1662.

Get operation 1658 allows a recipient to filter specific coins associated with the send coins transaction using custom attributes and type “Reward,” in response to receiving a transfer notification. This operation ensures that only the intended coins are unfrozen and transferred. The reserved coins are then unfrozen 1660, e.g., the coins are released for transfer. This operation restores the coins to their liquid state, allowing them to be transferred to the recipient's new address. Once the reserved coins are unfrozen, the final step is to complete the send coins transaction. Transfer coins operation 1662 moves the coins from the sender's address to the recipient's new address, finalizing the transaction.

### Coin and Coupon Payment Integration

FIG. 16K illustrates an exemplary integration flow related to paying coins and coupons integration. Effective integration with the present ledger is crucial for enabling pay with coins transactions 1664, where one entity (e.g., customers) directly uses coins to make purchases from another entity (e.g., merchants). This transaction may include get, burn, and freeze steps.

Get operation 1666 verifies if an entity has sufficient coins in the associated account to complete a transaction. In some embodiments, any reward coin is allowed to be used as payment. Coins with active backing may be frozen 1668 after use in transactions, to ensure that no one can use these coins. This operation 1668 is required because addresses with backing data need to be transformed when backing funds are withdrawn (e.g., this may occur at a later moment). Coins without backing are burned 1670 after use. This operation removes the coins from circulation and ends the lifecycle of coins.

An accurate integration with the ledger is essential for facilitating the issuance of discount coupons through the pay with coupon feature 1672. This allows entities to convert coins into coupons for future use. In some embodiments, a get operation 1674 may verify if an entity has enough coins to convert into coupons. A reward coin is allowed to be used as payment. Additionally, coins intended for coupon issuance are frozen 1676 to prevent their use in other transactions until the coupons are redeemed or refunded. This ensures that the coins remain reserved for coupon purposes.

### Payout Integration

FIG. 16L illustrates an exemplary integration flow related to payout integration. The payout integration with a ledger, also known as merchant withdrawal 1678 in this example, facilitates merchants in withdrawing funds from the platform received through customer payments for coin purchases. As depicted, merchant withdrawal 1678 may include operations such as get 1680, transform 1682, etc.

In some embodiments, before a withdrawal is initiated, a get operation 1680 may be performed to check the status of addresses with coins intended for withdrawal. This ensures that the coins are in a suitable state for processing. If coins associated with a customer's payment are still in circulation, a transform operation 1682 may be executed to remove the backing data from these coins. This operation may set the backing value to zero while maintaining the fiat currency as the backing asset, indicating that the coins no longer have backing tied to them.

Other operations such as unfreeze, transform, and burn, may be applicable. If the coins have been frozen due to user transactions (e.g., pay with coins, or pay with coupon), an unfreeze operation is performed before a transform operation to release the coins from the frozen state. Afterward, the transform operation may remove the backing from the coins. Finally, a burn operation may be executed to conclude the lifecycle of the coins, which removes the coins from circulation. This integration ensures that entities (e.g., merchants) can efficiently withdraw funds from the platform while maintaining the integrity and transparency of coin transactions within the present ledger system.

### Subscriptions Integration

FIG. 16M illustrates an exemplary integration flow associated with subscription integration. The subscription integration, referred to as merchant subscriptions integration 1684 in this example, includes the establishment of a ledger structure where the present platform is identified as the owner. This setup creates a concept of a pool of coins linked to a specific issuer that will exclusively make payments to the present platform.

Within this ledger structure, a new coin type, i.e., “billing” coin, is introduced, extending the traditional reward type. In some embodiments, the subtype associated with billing coins is “subscription,” giving rise to billing subscription coins. These coins represent payments made by merchants to maintain an active subscription on the present platform. To use bill subscription coins, the present platform may issue/mint any reward coin on behalf of merchants after their billing coins have been burned.

To pay for subscriptions, the present platform facilitates the payment made by merchants using billing subscription coins, maintaining an active subscription. In some embodiments, a primary operation in the subscription integration is mint coins operation 1686. When merchants' subscription expires, they are required to issue new coins to continue their subscriptions. Therefore, the minting of billing subscription coins is performed on behalf of the merchants to maintain their active subscription.

The subscription integration ensures the seamless management of merchant subscriptions on the present platform, facilitating the issuance of new coins when required and maintaining the integrity of the ledger system.

### Coin Store Integration

FIGS. 16N-16P illustrate an exemplary integration flow associated with coin store integration. FIG. 16N shows the process of announcing deals in a coin store. In some embodiments, announcing coins, such as reward coins for sale at special prices directly within the coin store, requires an internal transfer between wallets owned by the present platform within the ledger. In the illustrated embodiment, this may include a platform pool of billing coins for merchant 1688 and a coin store pool of billing coins for merchant 1690, each representing a large wallet of the present platform.

In some embodiments, platform pool of billing coins for merchant 1688 is a wallet that contains all billing coins owned by the present platform, serving as a general repository. Coin store pool of billing coins for merchant 1690 is a specialized wallet that receives a transfer of billing coins from the platform pool 1688, making the received coins available within the coin store for direct sale to end users (e.g., customers).

In some embodiments, transfer operation 1692 includes changing the ownership of a specific quantity of billing coins from platform pool 1688 to coin store pool 1690. This operation is important for maintaining an adequate supply of coins within the coin store, ensuring that users (e.g., customers) have access to a variety of coins for purchase. It also enables efficient management of coin inventory.

The billing coins, acquired through the subscription mechanism, grant the present platform the right to issue new coins on behalf of other merchants when the system has a proportional amount of billing coins from that merchant to perform a burn operation. However, this integration primarily focuses on transferring funds of billing coins from one pool to another pool owned by the present platform.

FIG. 16O shows the operations for processing coin deal purchase requests. A coin deal purchase request represents the moment when a user (e.g., a customer) utilizes the coin store on the present platform to acquire reward coins from a business. This operation aims to generate revenue for the present platform by offering coins for sale on behalf of other merchants.

The process begins with a get operation 1694 in the ledger to retrieve the billing coins from a specific merchant's pool within the coin store pool of billing coins in the present system. This operation ensures that the billing coin pool has sufficient balance to proceed with a transaction and issue coins to a user (e.g., a customer). A freeze operation 1696 is performed on the selected billing subscription coins to indicate that the coins are reserved for the user's purchase, allowing the transaction to proceed smoothly. If the balance is successfully frozen, this signals that the user's purchase request can proceed. This concludes the coin deal purchase request cycle.

FIG. 16P shows the operations for coin deal purchase confirmation. A coin deal purchase confirmation signals that a user's payment for the requested coins has been approved. It should be noted that these payments go directly to the present platform and do not contribute to the concept of backing assets. They serve solely as a mechanism for revenue generation.

In some embodiments, the confirmation process may include operations of get 1686, unfreeze 1697, burn 1698, and mint 1699. Initially, a get operation 1696 may be performed to retrieve all the reserved billing subscription coins from a freeze operation of the coin deal purchase request. Once the payment is confirmed, an unfreeze operation 1697 may be conducted on the reserved coins retrieved through get operation 1696. The next step involves burning the billing subscription coins as in 1698, which ensures the right of issuance of reward coins on behalf of the merchant to the customer. Finally, a mint operation 1699 may be executed to issue the reward bonus coins to the customer. In some embodiments, these coins are minted on behalf of the merchant, using the billing subscription coins as the issuing asset.

This integration mechanism enables the sale of coins through the coin store, leveraging billing subscription coins and facilitating revenue generation for the platform while maintaining the integrity of the present ledger system.

### Computer-Based Implementations

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used and/or functional programming languages can be used. Electrical memory, such as flash-based memory, can be used.

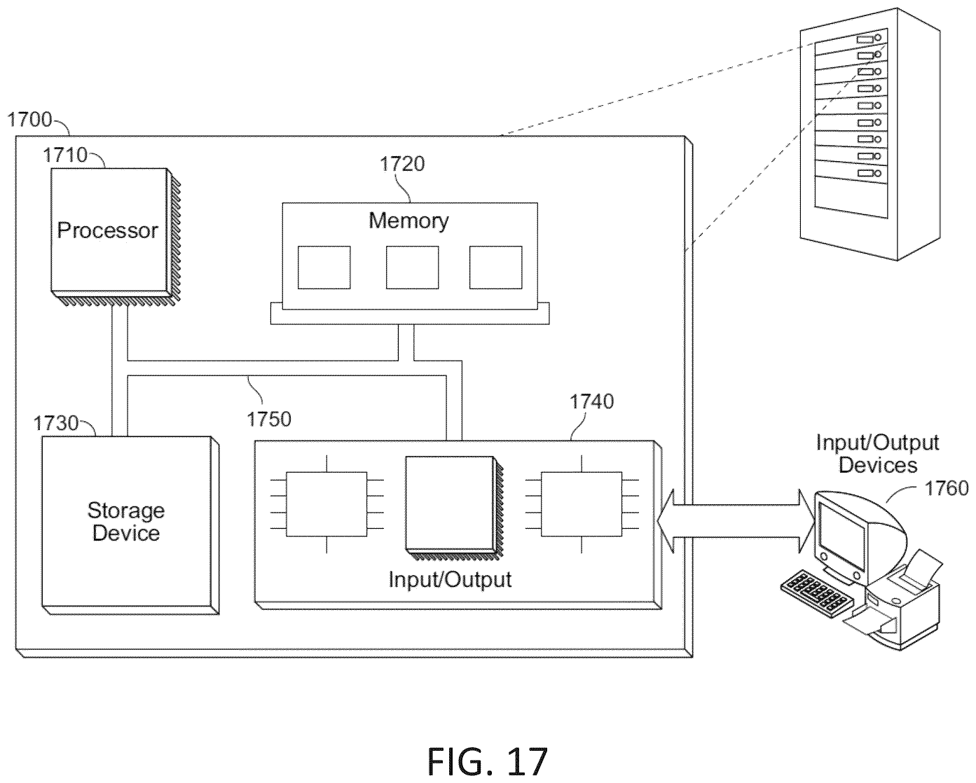

FIG. 17 is a block diagram of an example computer system 1700 that may be used in implementing the technology described herein. General-purpose computers, network appliances, mobile devices, or other electronic systems may also include at least portions of the system 1700. The system 1700 includes a processor 1710, a memory 1720, a storage device 1730, and an input/output device 1740. Each of the components 1710, 1720, 1730, and 1740 may be interconnected, for example, using a system bus 1750. The processor 1710 is capable of processing instructions for execution within the system 1700. In some implementations, the processor 1710 is a single-threaded processor. In some implementations, the processor 1710 is a multi-threaded processor. The processor 1710 is capable of processing instructions stored in the memory 1720 or on the storage device 1730.

The memory 1720 stores information within the system 1700. In some implementations, the memory 1720 is a non-transitory computer-readable medium. In some implementations, the memory 1720 is a volatile memory unit. In some implementations, the memory 1720 is a non-volatile memory unit.

The storage device 1730 is capable of providing mass storage for the system 1700. In some implementations, the storage device 1730 is a non-transitory computer-readable medium. In various different implementations, the storage device 1730 may include, for example, a hard disk device, an optical disk device, a solid-state drive, a flash drive, or some other large capacity storage device. For example, the storage device may store long-term data (e.g., database data, file system data, etc.). The input/output device 1740 provides input/output operations for the system 1700. In some implementations, the input/output device 1740 may include one or more network interface devices, e.g., an Ethernet card, a serial communication device, e.g., an RS-232 port, and/or a wireless interface device, e.g., an 1702.11 card, a 3G wireless modem, or a 4G wireless modem. In some implementations, the input/output device may include driver devices configured to receive input data and send output data to other input/output devices, e.g., keyboard, printer and display devices 1760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1730 may be implemented in a distributed way over a network, such as a server farm or a set of widely distributed servers, or may be implemented in a single computing device.

Although an example processing system has been described in FIG. 17, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A method comprising:
determining a plurality of addresses for a first user, each of the plurality of addresses associated with an amount of coins of a coin type and a coin subtype;
performing a transaction associated with the coins of a given coin type and one or more coin subtypes using one or more addresses of the plurality of addresses;
recording the transaction in a ledger by creating a new state for the transaction and obsoleting data originated the new state; and
creating a chain of transactions based on recording the transaction.

2. The method of claim 1, wherein the address includes a numeric identifier of the first user, and the first user is anonymized.

3. The method of claim 1, further comprising stopping generating a second new state in the ledge within a predefined period of time to avoid double spend attacks.

4. The method of claim 1, wherein the chain of transactions is created without deleting or updating a state in to keep an immutable record of the chain of transactions.

5. The method of claim 1, further comprising:
generating a salt signature for the transaction, the salt signature including at least a timestep and a secret key; and
creating a fingerprint chain by appending to the salt signature a fingerprint of a parent node from which the transaction is originated,
wherein the transaction is validated based on at least one of the salt signature and the fingerprint chain.

6. The method of claim 1, wherein performing the transaction comprises performing one or more ledger operations, and a ledger operation comprises at least one of mint, transfer, transform, freeze, unfreeze, burn, and get.

7. The method of claim 6, wherein the freeze operation includes an operational freeze operation or a security freeze operation, and the freeze operation is performed to freeze a cascade of transactions, the method further comprising:
creating a new address for the frozen coins; and
creating a reference to a parent addresses for tracking the frozen coins.

8. The method of claim 6, wherein an ownership of the coins is changed based on a full or partial transfer operation.

9. The method of claim 6, wherein the transform operation is performed by determining if there is a match with a blacklist based on mapping attributes, or determining if there is enough coin balance amount to make a transfer.

10. The method of claim 9, further comprising employing a whitelist to restrict modification to one or more fields of the address, including preventing the modification of one of the plurality of addresses to an obsolete state in response to the transform operation.

11. The method of claim 6, wherein the burn operation is performed to permanently remove the coins without deleting an existing state from the ledger.

12. The method of claim 1, wherein the coin type is at least one of reward or billing, and the subtype comprises at least one of bonus, welcome, social, purchased, referral, deal, award, invite, and subscription.

13. The method of claim 1, further comprising:
applying a zero initial supply rule; and
performing a transfer operation to create the coins and assign an ownership to the first user.

14. The method of claim 1, further comprising storing a reference to an entry that resulted in one or more new entries in the chain of transactions.

15. The method of claim 14, further comprising:
identifying a specific operation that resulted in a new entry of the one or more new entries in the chain of transactions based on the stored reference.

16. The method of claim 1, wherein the coins are created by at least one of a direct mint operation or and a transfer operation from a coin pool.

17. The method of claim 16, further comprising:
generating the coins through a first operation upon the transaction;
adding the coins to an address associated with an entity;
withholding the coins for use through a second operation until the transaction is validated; and
granting the first user access to the coins through a third operation.

18. The method of claim 1, further comprising:
receiving a request from the first user to obtain the coins for a second user;
creating a gift card by minting the coins with a first address of the first user, the coins having one or more attributes representing the coins associated with a gift card; and
maintaining the coins allocated for the gift card by freezing the coins for the second user.

19. The method of claim 18, further comprising:
receiving a retrieval request for gift card from the second user;
identifying the coins associated with the gift card based on the one or more attributes;
making the coins available by unfreezing the coins; and
transferring the coins to a second address of the second user;
updating the chain of transactions in the ledger to reflect a complete transfer of ownership.

20. The method of claim 1, further comprising:
identifying at least one type of coins associated with the first user that is available for a send transaction;
reserving one of the at least one type of coins for the send transaction; and
sending the reserved coins to a second user in response to a request from the first users.

21. The method of claim 20, further comprising:
determining that the send coin transaction is unclaimed or canceled;
disabling a link associated with the transaction; and
automatically releasing the reserved coins back to the sender through unfreeze operation.

22. A ledge system comprising:
a first component configured to provide transaction capabilities, including performing a plurality of operations.
a second component configured to communicate between the first component with other backend services; and
a third component configured to streamline interactions with the first component and the second component.

23. The system of claim 22, further comprising:
a fourth component configured to act as smart contracts to encapsulate transaction rules and logic, wherein the rules and logic include multi-stage approvals, material verification, and other functions.
